(19) United States
(12) Patent Application Publication
(10) Pub. No.: US 2026/0326412 A1
(43) Pub. Date: Oct. 22, 2026

(54) MULTI-PLY FIBROUS STRUCTURE AND PROCESS FOR MAKING SAME

(71) Applicant: The Procter & Gamble Company, Cincinnati, OH (US)

(72) Inventors: Matthew Gary McKee, Cincinnati, OH (US); Jeffrey Glen Sheehan, Symmes Township, OH (US); Ward William Ostendorf, West Chester, OH (US); Steven Lee Barnholtz, West Chester, OH (US); Timothy James Klawitter, North Bend, OH (US); Patricia Callanan Thomas, Wyoming, OH (US); Mark Charles Rueve, North Bend, OH (US); Robert Howard Scholle, Lawrenceburg, IN (US)

(21) Appl. No.: 19/324,185

(22) Filed: Sep. 10, 2025

Related U.S. Application Data
(60) Provisional application No. 63/693,245, filed on Sep. 11, 2024.

(51) Int. Cl. B32B 5/02; B32B 5/26

(52) U.S. Cl. CPC B32B 5/022; B32B 5/267; B32B 2250/20; B32B 2307/54; B32B 2307/718

(57) ABSTRACT

Multi-ply fibrous structures containing at least one laminate fibrous structure ply containing a base fibrous structure associated with a low basis weight nonwoven web containing hydroxyl polymer fibrous elements, convolutely wound rolls of such multi-ply fibrous structures and methods for making such multi-ply fibrous structures and rolls are provided.

### FIELD OF THE INVENTION

The present invention relates to multi-ply fibrous structures, more particularly to multi-ply fibrous structures comprising at least one fibrous structure ply comprising a low basis weight nonwoven web comprising hydroxyl polymer fibrous elements, for example a laminate fibrous structure ply comprising a base fibrous structure associated with a low basis weight nonwoven web comprising hydroxyl polymer fibrous elements, convolutely wound rolls of such multi-ply fibrous structures and methods for making such multi-ply fibrous structures and rolls.

### BACKGROUND OF THE INVENTION

Achieving bulky multi-ply fibrous structures with a soft surface has been a challenge for formulators in the past. Bulkiness and softness in multi-ply fibrous structures have traditionally been achievable to the detriment of the other property.

A common approach to achieving bulky multi-ply fibrous structures is to highly texturize one or more of the fibrous structure plies resulting in a rough, textured surface, such as is experienced with structured wet laid fibrous structure plies, for example textured, through-air-dried fibrous structure plies. To counteract the rough, textured surface of such highly texturized fibrous structures, formulators have applied a chemical surface softening agent to the highly texturized surface in an attempt to minimize the rough feel consumers experience when using the highly texturized fibrous structure, such as when the highly texturized fibrous structure is used as a sanitary tissue product, for example a toilet tissue. The application of a chemical surface softening agent has worked but there is still a need to further improve the surface softness of the highly texturized, bulky fibrous structures since the chemical surface softening agent simply gets deposited along the topography of the highly texturized surface, thus leaving the consumer to still experience the highly texturized surface, albeit softer highly texturized surface of the fibrous structure compared to no chemical surface softening agent being applied.

A common approach to achieving soft multi-ply fibrous structures is to create a smooth, non-textured or substantially non-textured surface on the multi-ply fibrous structure, for example as is experienced with conventional wet pressed wet laid fibrous structures. The problem with conventional wet pressed wet laid fibrous structures is the inability to create bulk in the multi-ply fibrous structure, especially wet bulk.

The problem that formulators have encountered to date is creating sufficient bulk in multi-ply fibrous structures, for example wet laid multi-ply fibrous structures, via texturizing the fibrous structure while minimizing the lack of softness and/or softness negative experienced by consumers as a result of feeling and experiencing the textured surface of the textured fibrous structures.

Accordingly, there is a need for multi-ply fibrous structures, for example multi-ply fibrous structures comprising at least one laminate fibrous structure ply comprising a base fibrous structure, for example a textured fibrous structure, such as a textured wet laid fibrous structure, for example a structured wet laid fibrous structure associated with a low basis weight nonwoven web, for example a low basis weight nonwoven web comprising hydroxyl polymer fibrous elements that provides novel bulky, surface soft multi-ply fibrous structures, convolutely wound rolls of such multi-ply fibrous structures and methods for making such multi-ply fibrous structures and rolls.

### SUMMARY OF THE INVENTION

The present invention fulfills the need described above by providing multi-ply fibrous structures comprising at least one fibrous structure ply comprising a low basis weight nonwoven web, for example a laminate fibrous structure ply comprising a base fibrous structure associated with a low basis weight nonwoven web exhibiting a basis weight of less than 5 gsm and processes for making same. In embodiments, the low basis weight nonwoven web of the fibrous structure ply, for example the laminate fibrous structure ply, comprises a plurality of hydroxyl polymer fibrous elements, for example a plurality of non-naturally occurring hydroxyl polymer fibrous elements, such as filaments and/or fibers.

The solution to the problem identified above is to provide a multi-ply fibrous structure comprising at least one fibrous structure ply comprising a low basis weight nonwoven web, for example at least one laminate fibrous structure ply comprising a base fibrous structure associated with a low basis weight nonwoven web.

In embodiments of the present invention, a multi-ply fibrous structure comprising at least one fibrous structure ply comprising a low basis weight nonwoven web, for example at least one laminate fibrous structure ply, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein is provided.

In another example of the present invention, a multi-ply fibrous structure comprising at least one fibrous structure ply comprising a low basis weight nonwoven web, for example at least one laminate fibrous structure ply, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, wherein the low basis weight nonwoven web comprises a plurality of hydroxyl polymer fibrous elements, for example a plurality of non-naturally occurring fibrous elements, for example a plurality of non-naturally occurring hydroxyl polymer filaments, for example a plurality of non-naturally occurring water-soluble hydroxyl polymer filaments, such as a plurality of polyvinyl alcohol filaments is provided.

In another example of the present invention, a multi-ply fibrous structure comprising at least one fibrous structure ply comprising a low basis weight nonwoven web, for example at least one laminate fibrous structure ply, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, wherein the low basis weight nonwoven web comprises a plurality of hydroxyl polymer fibrous elements, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers is provided.

In another example of the present invention, a multi-ply fibrous structure comprising at least one fibrous structure ply comprising a low basis weight nonwoven web, for example at least one laminate fibrous structure ply, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, wherein the low basis weight nonwoven web comprises a plurality of hydroxyl polymer fibrous elements, for example a plurality of non-naturally occurring fibrous elements, for example a plurality of non-naturally occurring hydroxyl polymer filaments, for example a plurality of non-naturally occurring water-soluble hydroxyl polymer filaments, such as a plurality of polyvinyl alcohol filaments that exhibit an average fiber diameter of less than 4.5 microns and/or less than 4.0 microns and/or less than 3.5 microns and/or less than 3.0 microns and/or to greater than 0.5 μm and/or to greater than 0.75 μm as measured according to the Average Fiber Diameter Test Method described herein is provided.

In another example of the present invention, a multi-ply fibrous structure comprising at least one fibrous structure ply comprising a low basis weight nonwoven web, for example at least one laminate fibrous structure ply, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, wherein the low basis weight nonwoven web comprises a plurality of hydroxyl polymer fibrous elements, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers that exhibit an average fiber diameter of less than 4.5 microns and/or less than 4.0 microns and/or less than 3.5 microns and/or less than 3.0 microns and/or to greater than 0.5 μm and/or to greater than 0.75 μm as measured according to the Average Fiber Diameter Test Method described herein is provided.

In another example of the present invention, a multi-ply fibrous structure comprising at least one fibrous structure ply comprising a low basis weight nonwoven web, for example at least one laminate fibrous structure ply, for example a single-ply laminate fibrous structure, comprising a base fibrous structure associated with a low basis weight nonwoven web, for example a single-ply low basis weight nonwoven web, exhibiting a basis weight of less than 5 gsm as measured according to the Basis Weight Test Method described herein and wherein the laminate fibrous structure ply exhibits a fail total energy absorption (TEA) of at least 12 g/in/gsm and/or at least 14 g/in/gsm and/or at least 16 g/in/gsm as measured according to the Tensile Test Method described herein is provided.

In another example of the present invention, a multi-ply fibrous structure comprising at least one fibrous structure ply comprising a low basis weight nonwoven web, for example at least one laminate fibrous structure ply, for example a single-ply laminate fibrous structure, comprising a base fibrous structure associated with a low basis weight nonwoven web, for example a single-ply low basis weight nonwoven web, exhibiting a basis weight of less than 5 gsm as measured according to the Basis Weight Test Method described herein and wherein the laminate fibrous structure ply exhibits a fail total energy absorption (TEA) of at least 12 g/in/gsm and/or at least 14 g/in/gsm and/or at least 16 g/in/gsm as measured according to the Tensile Test Method described herein, wherein the low basis weight nonwoven web comprises a plurality of hydroxyl polymer fibrous elements, for example a plurality of non-naturally occurring fibrous elements, for example a plurality of non-naturally occurring hydroxyl polymer filaments, for example a plurality of non-naturally occurring water-soluble hydroxyl polymer filaments, such as a plurality of polyvinyl alcohol filaments is provided.

In another example of the present invention, a multi-ply fibrous structure comprising at least one fibrous structure ply comprising a low basis weight nonwoven web, for example at least one laminate fibrous structure, for example a single-ply laminate fibrous structure, comprising a base fibrous structure associated with a low basis weight nonwoven web, for example a single-ply low basis weight nonwoven web, exhibiting a basis weight of less than 5 gsm as measured according to the Basis Weight Test Method described herein and wherein the laminate fibrous structure exhibits a fail total energy absorption (TEA) of at least 12 g/in/gsm and/or at least 14 g/in/gsm and/or at least 16 g/in/gsm as measured according to the Tensile Test Method described herein, wherein the low basis weight nonwoven web comprises a plurality of hydroxyl polymer fibrous elements, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers is provided.

In another example of the present invention, a multi-ply fibrous structure comprising at least one fibrous structure ply comprising a low basis weight nonwoven web, for example at least one laminate fibrous structure, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the multi-ply fibrous structure exhibits a total dry tensile of greater than 75 g/in and/or greater than 100 g/in and/or greater than 150 g/in and/or greater than 200 g/in and/or greater than 300 g/in and/or greater than 400 g/in and/or greater than 500 g/in to less than 2000 g/in and/or to less than 1500 g/in and/or to less than 1000 g/in as measured according to the Tensile Test Method described herein is provided.

In another example of the present invention, a multi-ply fibrous structure comprising at least one fibrous structure ply comprising a low basis weight nonwoven web, for example at least one laminate fibrous structure, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the multi-ply fibrous structure exhibits a total dry tensile of greater than 75 g/in and/or greater than 100 g/in and/or greater than 150 g/in and/or greater than 200 g/in and/or greater than 300 g/in and/or greater than 400 g/in and/or greater than 500 g/in to less than 2000 g/in and/or to less than 1500 g/in and/or to less than 1000 g/in as measured according to the Tensile Test Method described herein, wherein the low basis weight nonwoven web comprises a plurality of hydroxyl polymer fibrous elements, for example a plurality of non-naturally occurring fibrous elements, for example a plurality of non-naturally occurring hydroxyl polymer filaments, for example a plurality of non-naturally occurring water-soluble hydroxyl polymer filaments, such as a plurality of polyvinyl alcohol filaments is provided.

In another example of the present invention, a multi-ply fibrous structure comprising at least one fibrous structure ply comprising a low basis weight nonwoven web, for example at least one laminate fibrous structure, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the multi-ply fibrous structure exhibits a total dry tensile of greater than 75 g/in and/or greater than 100 g/in and/or greater than 150 g/in and/or greater than 200 g/in and/or greater than 300 g/in and/or greater than 400 g/in and/or greater than 500 g/in to less than 2000 g/in and/or to less than 1500 g/in and/or to less than 1000 g/in as measured according to the Tensile Test Method described herein, wherein the low basis weight nonwoven web comprises a plurality of hydroxyl polymer fibrous elements, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers is provided.

In another example of the present invention, a multi-ply fibrous structure comprising at least one fibrous structure ply comprising a low basis weight nonwoven web, for example at least one laminate fibrous structure, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the multi-ply fibrous structure exhibits a total dry tensile of less than 2000 g/in as measured according to the Tensile Test Method described herein is provided.

In another example of the present invention, a multi-ply fibrous structure comprising at least one fibrous structure ply comprising a low basis weight nonwoven web, for example at least one laminate fibrous structure, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the multi-ply fibrous structure exhibits a total dry tensile of less than 2000 g/in as measured according to the Tensile Test Method described herein, wherein the low basis weight nonwoven web comprises a plurality of hydroxyl polymer fibrous elements, for example a plurality non-naturally occurring fibrous elements, for example a plurality of non-naturally occurring hydroxyl polymer filaments, for example a plurality of non-naturally occurring water-soluble hydroxyl polymer filaments, such as a plurality of polyvinyl alcohol filaments is provided.

In another example of the present invention, a multi-ply fibrous structure comprising at least one fibrous structure ply comprising a low basis weight nonwoven web, for example at least one laminate fibrous structure, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the multi-ply fibrous structure exhibits a total dry tensile of less than 2000 g/in as measured according to the Tensile Test Method described herein, wherein the low basis weight nonwoven web comprises a plurality of hydroxyl polymer fibrous elements, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers is provided.

In another example of the present invention, a multi-ply fibrous structure comprising at least one fibrous structure ply comprising a low basis weight nonwoven web, for example at least one laminate fibrous structure, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the multi-ply fibrous structure exhibits a TS7 of less than 20 dB V² rms and/or less than 15 dB V² rms and/or less than 12 dB V² rms and/or less than 10 dB V² rms and/or less than 8 dB V² rms and/or less than 6 dB V² rms and/or less than 4 dB V² rms as measured according to the Emtec Test Method described herein is provided.

In another example of the present invention, a multi-ply fibrous structure comprising at least one fibrous structure ply comprising a low basis weight nonwoven web, for example at least one laminate fibrous structure, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the multi-ply fibrous structure exhibits a TS7 of less than 20 dB V² rms and/or less than 15 dB V² rms and/or less than 12 dB V² rms and/or less than 10 dB V² rms and/or less than 8 dB V² rms and/or less than 6 dB V² rms and/or less than 4 dB V² rms as measured according to the Emtec Test Method described herein, wherein the low basis weight nonwoven web comprises a plurality of hydroxyl polymer fibrous elements, for example a plurality of non-naturally occurring fibrous elements, for example a plurality of non-naturally occurring hydroxyl polymer filaments, for example a plurality of non-naturally occurring water-soluble hydroxyl polymer filaments, such as a plurality of polyvinyl alcohol filaments is provided.

In another example of the present invention, a multi-ply fibrous structure comprising at least one fibrous structure ply comprising a low basis weight nonwoven web, for example at least one laminate fibrous structure, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the multi-ply fibrous structure exhibits a TS7 of less than 20 dB V² rms and/or less than 15 dB V² rms and/or less than 12 dB V² rms and/or less than 10 dB V² rms and/or less than 8 dB V² rms and/or less than 6 dB V² rms and/or less than 4 dB V² rms as measured according to the Emtec Test Method described herein, wherein the low basis weight nonwoven web comprises a plurality of hydroxyl polymer fibrous elements, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers is provided.

In another example of the present invention, a multi-ply fibrous structure comprising at least one fibrous structure ply comprising a low basis weight nonwoven web, for example at least one laminate fibrous structure, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the multi-ply fibrous structure exhibits a Force Variability Value of less than 1.40 and/or less than 1.25 as measured according to the Glide on Skin Test Method described herein is provided.

In another example of the present invention, a multi-ply fibrous structure comprising at least one fibrous structure ply comprising a low basis weight nonwoven web, for example at least one laminate fibrous structure, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the multi-ply fibrous structure exhibits a Force Variability Value of less than 1.40 and/or less than 1.25 as measured according to the Glide on Skin Test Method described herein, wherein the low basis weight nonwoven web comprises a plurality of hydroxyl polymer fibrous elements, for example a plurality of non-naturally occurring fibrous elements, for example a plurality of non-naturally occurring hydroxyl polymer filaments, for example a plurality of non-naturally occurring water-soluble hydroxyl polymer filaments, such as a plurality of polyvinyl alcohol filaments is provided.

In another example of the present invention, a multi-ply fibrous structure comprising at least one fibrous structure ply comprising a low basis weight nonwoven web, for example at least one laminate fibrous structure, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the multi-ply fibrous structure exhibits a Force Variability Value of less than 1.40 and/or less than 1.25 as measured according to the Glide on Skin Test Method described herein, wherein the low basis weight nonwoven web comprises a plurality of hydroxyl polymer fibrous elements, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers is provided.

In another example of the present invention, a multi-ply fibrous structure comprising at least one fibrous structure ply comprising a low basis weight nonwoven web, for example at least one laminate fibrous structure, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the multi-ply fibrous structure exhibits a Force to Drag Value of less than 100 and/or less than 90 as measured according to the Glide on Skin Test Method described herein is provided.

In another example of the present invention, a multi-ply fibrous structure comprising at least one fibrous structure ply comprising a low basis weight nonwoven web, for example at least one laminate fibrous structure, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the multi-ply fibrous structure exhibits a Force to Drag Value of less than 100 and/or less than 90 as measured according to the Glide on Skin Test Method described herein, wherein the low basis weight nonwoven web comprises a plurality of hydroxyl polymer fibrous elements, for example a plurality of non-naturally occurring fibrous elements, for example a plurality of non-naturally occurring hydroxyl polymer filaments, for example a plurality of non-naturally occurring water-soluble hydroxyl polymer filaments, such as a plurality of polyvinyl alcohol filaments is provided.

In another example of the present invention, a multi-ply fibrous structure comprising at least one fibrous structure ply comprising a low basis weight nonwoven web, for example at least one laminate fibrous structure, for example a single-ply laminate fibrous structure, comprising a base fibrous structure associated with a low basis weight nonwoven web, for example a single-ply low basis weight nonwoven web, exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the multi-ply fibrous structure exhibits a Force to Drag Value of less than 100 and/or less than 90 as measured according to the Glide on Skin Test Method described herein, wherein the low basis weight nonwoven web comprises a plurality of hydroxyl polymer fibrous elements, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers is provided.

In another example of the present invention, a roll of multi-ply fibrous structure, for example a convolutely wound roll of multi-ply fibrous structure comprising a fibrous structure ply, for example a laminate fibrous structure ply, for example a single-ply laminate fibrous structure, according to the present invention is provided.

In still another example of the present invention, a method for making a multi-ply fibrous structure fibrous structure, the method comprising the steps of:
a. providing a base fibrous structure, for example a wet laid fibrous structure, for example a wet laid fibrous structure comprising pulp fibers, such as wood pulp fibers;
b. providing a low basis weight nonwoven web, for example a single-ply low basis weight nonwoven web, that exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, for example such a low basis weight nonwoven web comprising a plurality of fibrous elements comprising a hydroxyl polymer, for example a non-naturally occurring hydroxyl polymer, for example a water-soluble hydroxyl polymer, such as a polyvinyl alcohol;
c. associating the base fibrous structure with the low basis weight nonwoven web to form a laminate fibrous structure (which is a first fibrous structure ply within the multi-ply fibrous structure);
d. associating, for example plybonding, the laminate fibrous structure with a second fibrous structure (which forms a second fibrous structure ply within the multi-ply fibrous structure) to form the multi-ply fibrous structure, is provided.

In yet another example of the present invention, a method for making a multi-ply fibrous structure fibrous structure, the method comprising the steps of:
a. providing a base fibrous structure, for example a wet laid fibrous structure, for example a wet laid fibrous structure comprising pulp fibers, such as wood pulp fibers;
b. providing a low basis weight nonwoven web, for example a single-ply low basis weight nonwoven web, that exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, for example such a low basis weight nonwoven web comprising a plurality of fibrous elements comprising a hydroxyl polymer, for example a non-naturally occurring hydroxyl polymer, for example a water-soluble hydroxyl polymer, such as a polyvinyl alcohol;
c. associating the base fibrous structure with the low basis weight nonwoven web to form a laminate fibrous structure (which forms a fibrous structure ply within the multi-ply fibrous structure);
d. associating, for example plybonding, two or more plies of the laminate fibrous structure to form the multi-ply fibrous structure, is provided.

In still another example of the present invention, a method for making a multi-ply fibrous structure, the method comprising the steps of:
a. providing a base fibrous structure, for example a wet laid fibrous structure, for example a wet laid fibrous structure comprising pulp fibers, such as wood pulp fibers;
b. providing a low basis weight nonwoven web, for example a single-ply low basis weight nonwoven web, that exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, for example such a low basis weight nonwoven web comprising a plurality of fibrous elements comprising a hydroxyl polymer, for a non-naturally occurring hydroxyl polymer, example a non-water soluble hydroxyl polymer, such as cellulose, for example rayon and/or lyocell;
c. associating the base fibrous structure with the low basis weight nonwoven web to form a laminate fibrous structure (which forms a first fibrous structure ply within the multi-ply fibrous structure); and
d. associating, for example plybonding, the laminate fibrous structure with a second fibrous structure (which forms a second fibrous structure ply within the multi-ply fibrous structure) to form the multi-ply fibrous structure, is provided.

In still another example of the present invention, a method for making a roll of multi-ply fibrous structure, the method comprising the steps of:
a. providing a base fibrous structure, for example a wet laid fibrous structure, for example a wet laid fibrous structure comprising pulp fibers, such as wood pulp fibers;
b. providing a low basis weight nonwoven web, for example a single-ply low basis weight nonwoven web, that exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, for example such a low basis weight nonwoven web comprising a plurality of fibrous elements comprising a hydroxyl polymer, for example a non-naturally occurring hydroxyl polymer, for example a water-soluble hydroxyl polymer, such as a polyvinyl alcohol;
c. associating the base fibrous structure with the low basis weight nonwoven web to form a laminate fibrous structure (which forms a first fibrous structure ply within the multi-ply fibrous structure);
d. associating, for example plybonding, the laminate fibrous structure with a second fibrous structure (which forms a second fibrous structure ply within the multi-ply fibrous structure) to form the multi-ply fibrous structure; and
e. winding the multi-ply fibrous structure convolutely about itself to form a roll of the multi-ply fibrous structure, is provided.

In still another example of the present invention, a method for making a roll of multi-ply fibrous structure, the method comprising the steps of:
a. providing a base fibrous structure, for example a wet laid fibrous structure, for example a wet laid fibrous structure comprising pulp fibers, such as wood pulp fibers;
b. providing a low basis weight nonwoven web, for example a single-ply low basis weight nonwoven web, that exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, for example such a low basis weight nonwoven web comprising a plurality of fibrous elements comprising a hydroxyl polymer, for a non-naturally occurring hydroxyl polymer, example a non-water soluble hydroxyl polymer, such as cellulose, for example rayon and/or lyocell;
c. associating the base fibrous structure with the low basis weight nonwoven web to form a laminate fibrous structure (which forms a first fibrous structure ply within the multi-ply fibrous structure); and
d. associating the laminate fibrous structure with a second fibrous structure (which forms a second fibrous structure ply within the multi-ply fibrous structure) to form the multi-ply fibrous structure; and
e. winding the multi-ply fibrous structure convolutely about itself to form a roll of the multi-ply fibrous structure, is provided.

In still another example of the present invention, a method for making a multi-ply fibrous structure fibrous structure, the method comprising the steps of:
a. providing a low basis weight nonwoven web, for example a single-ply low basis weight nonwoven web, that exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, for example such a low basis weight nonwoven web comprising a plurality of fibrous elements comprising a hydroxyl polymer, for example a non-naturally occurring hydroxyl polymer, for example a water-soluble hydroxyl polymer, such as a polyvinyl alcohol; and
b. associating, for example plybonding, the low basis weight nonwoven web with a second fibrous structure (which forms a second fibrous structure ply within the multi-ply fibrous structure) to form the multi-ply fibrous structure, is provided.

In yet another example of the present invention, a method for making a multi-ply fibrous structure fibrous structure, the method comprising the steps of:
a. providing a low basis weight nonwoven web, for example a single-ply low basis weight nonwoven web, that exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, for example such a low basis weight nonwoven web comprising a plurality of fibrous elements comprising a hydroxyl polymer, for example a non-naturally occurring hydroxyl polymer, for example a water-soluble hydroxyl polymer, such as a polyvinyl alcohol; and
b. associating, for example plybonding, two or more plies of the low basis weight nonwoven web to form the multi-ply fibrous structure, is provided.

In still another example of the present invention, a method for making a multi-ply fibrous structure, the method comprising the steps of:
a. providing a low basis weight nonwoven web, for example a single-ply low basis weight nonwoven web, that exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, for example such a low basis weight nonwoven web comprising a plurality of fibrous elements comprising a hydroxyl polymer, for a non-naturally occurring hydroxyl polymer, example a non-water soluble hydroxyl polymer, such as cellulose, for example rayon and/or lyocell; and
b. associating, for example plybonding, the low basis weight nonwoven web with a second fibrous structure (which forms a second fibrous structure ply within the multi-ply fibrous structure) to form the multi-ply fibrous structure, is provided.

In still another example of the present invention, a method for making a roll of multi-ply fibrous structure, the method comprising the steps of:
a. providing a low basis weight nonwoven web, for example a single-ply low basis weight nonwoven web, that exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, for example such a low basis weight nonwoven web comprising a plurality of fibrous elements comprising a hydroxyl polymer, for example a non-naturally occurring hydroxyl polymer, for example a water-soluble hydroxyl polymer, such as a polyvinyl alcohol;
b. associating, for example plybonding, the low basis weight nonwoven web with a second fibrous structure (which forms a second fibrous structure ply within the multi-ply fibrous structure) to form the multi-ply fibrous structure; and
c. winding the multi-ply fibrous structure convolutely about itself to form a roll of the multi-ply fibrous structure, is provided.

In still another example of the present invention, a method for making a roll of multi-ply fibrous structure, the method comprising the steps of:
a. providing a low basis weight nonwoven web, for example a single-ply low basis weight nonwoven web, that exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, for example such a low basis weight nonwoven web comprising a plurality of fibrous elements comprising a hydroxyl polymer, for a non-naturally occurring hydroxyl polymer, example a non-water soluble hydroxyl polymer, such as cellulose, for example rayon and/or lyocell;
b. associating, for example plybonding, the low basis weight nonwoven web with a second fibrous structure (which forms a second fibrous structure ply within the multi-ply fibrous structure) to form the multi-ply fibrous structure; and
c. winding the multi-ply fibrous structure convolutely about itself to form a roll of the multi-ply fibrous structure, is provided.

The present invention provides novel multi-ply fibrous structures, rolls of such multi-ply fibrous structures, and methods for making same.

### BRIEF DESCRIPTION OF THE DRAWINGS

FIG. 1 is a side view representation of an example of a multi-ply fibrous structure according to the present invention;

FIG. 2 is a perspective view representation of an example of a multi-ply fibrous structure according to the present invention;

FIG. 3 is a schematic representation of an example of a method for making a multi-ply fibrous structure according to the present invention;

FIG. 4 is a schematic representation of an example of a method for making a laminate fibrous structure according to the present invention;

FIG. 5A is a side view representation of an example of a laminate fibrous structure according to the present invention;

FIG. 5B is a perspective view representation of an example of a laminate fibrous structure according to the present invention;

FIG. 6 is a schematic representation of an example of a method for making a low basis weight nonwoven web according to the present invention;

FIG. 7 is a schematic representation of another example of a method for making a low basis weight nonwoven web according to the present invention;

FIG. 8 is a schematic representation of yet another example of a method for making a low basis weight nonwoven web according to the present invention;

FIG. 9 is a side view representation of an example of a low basis weight nonwoven web according to the present invention;

FIG. 10 is a side view representation of another example of a low basis weight nonwoven web according to the present invention;

FIG. 11 is a top view representation of an example of a multi-row capillary meltblow die suitable for use in the methods of the present invention;

FIG. 12 is a schematic representation of the Roll Compressibility Test Method equipment and set-up.

### DETAILED DESCRIPTION OF THE INVENTION

Typically, melt blown nonwoven webs are not made at low basis weight, particularly less than 10 gsm, due to low tensile strength and/or low elongation at break. The low basis weight webs cannot support a load without falling apart or tearing, creating difficulties during web handling including sheet breaks, tears, and fold-overs. Thus, non-woven webs are typically confined to a minimum basis weight that can be used in consumer products. Moreover, low basis weight non-woven. Surprisingly, if a nonwoven web is created from a material with sufficient elongation and strength properties, and spun to very fine diameter filaments, less than 4.5 microns as measured by the average fiber diameter method, a very low basis weight product can be formed that can support a load and not fall apart upon web handling. Particularly, a hydroxyl polymer such as PVOH web of around 1.0 to 2.0 gsm, can be spun into a parent roll, unwound, and then combined with other substrates without web breaks. It is important that very fine filaments, less than 4.5 microns in diameter are formed which increases the number of fiber-to-fiber contacts for a given basis weight. This will also increase the tensile strength, fail stretch, and fail total energy absorbed (TEA) per unit basis weight of the web which is critical to winding and unwinding a nonwoven layer at 1-2 gsm basis weight. Particularly, a MD fail TEA greater than 12 g/in per gsm is generated in the low basis weight web. There are commercially available PVOH nonwovens, however the fiber diameters are considerably larger, roughly 20 microns which means fewer fiber-to-fiber contacts for a given basis weight, and consequently the resulting tensile properties and fail TEA per unit basis weight are not sufficient to withstand the forces of the winding and unwinding steps.

The low basis weight non-woven PVOH with 4.5 micron fiber diameter filaments and sufficient tensile and elongation properties can be unwound and laminated and/or embossed with a cellulose wetlaid paper to create a laminated structure. The wet laid structure can be a continuous knuckle, continuous pillow, or any semi-continuous pattern. In a wire side out orientation the void structures will be formed between the low-density regions and the nonwoven layer. Alternatively, when the PVOH layer is combined with a wetlaid substrate in a fabric side out orientation, the void structures will be formed between the high-density regions and the nonwoven layer.

The nonwoven and wet laid laminated parent roll is combined and embossed with a bottom ply that is either another nonwoven and wet laid laminated structure or a pure cellulosic substrate. Combining two nonwoven/wet laid substrate would create a dual-sided nonwoven tissue product and combining one nonwoven wet laid structure with a wetlaid cellulosic substrate would create a single-sided tissue. A quat softening chemistry and/or lotion may also be applied to the nonwoven layer surface after embossing.

### DEFINITIONS

“Multi-ply fibrous structure” as used herein means a fibrous structure comprising at least a first fibrous structure ply comprising a laminate fibrous structure according to the present invention, and a second fibrous structure ply, which may be the same as or different from the laminate fibrous structure ply. The multi-ply fibrous structure may comprise two or more and/or three or more and/or four or more fibrous structure plies, which may be the same and/or different from one another. In embodiments, the multi-ply fibrous structure comprising a first ply comprising a laminate fibrous structure and a second ply comprising a wet laid fibrous structure, for example a structured wet laid fibrous structure. In one example, two or more of the fibrous structure plies of the multi-ply fibrous structure may be associated together, for example by knurling, embossing, microselfing, bonding via chemical, such as an adhesive, for example plybonding glue, mechanical, and/or thermal bonding.

“Laminate fibrous structure” as used herein means a fibrous structure, for example an individual, integral fibrous structure, such as a single-ply fibrous structure, comprising a pre-formed (at the time of associating) base fibrous structure having at least one surface which is associated with, for example laminated to and/or bonded to and/or entangled with, a pre-formed (at the time of associating) low basis weight nonwoven web of the present invention. A laminate fibrous structure does not encompass a fibrous structure comprising a pre-formed base fibrous structure having no surfaces upon which a pre-formed low basis weight nonwoven web is associated or wherein the pre-formed base fibrous structure's surface is only associated with a low basis weight nonwoven web (not a pre-formed low basis weight nonwoven web) that is formed directly on the pre-formed base fibrous structure's surface rather than the low basis weight nonwoven web being pre-formed prior to association with a surface of a base fibrous structure. As discussed above, the laminate fibrous structure may be considered a ply, which may be combined with one or more other plies or used simply as a single-ply laminate fibrous structure.

Alternatively, in embodiments, if desired, a laminate structure may comprise a pre-formed base film having at least one surface which is associated with, for example laminated to and/or bonded to a pre-formed (at the time of associating) low basis weight nonwoven web of the present invention. Such an alternative laminate structure does not encompass a structure comprising a pre-formed base film having no surfaces upon which a pre-formed low basis weight nonwoven web is associated or wherein the pre-formed base film's surface is only associated with a low basis weight nonwoven web (not a pre-formed low basis weight nonwoven web) that is formed directly on the pre-formed base film's surface rather than the low basis weight nonwoven web being pre-formed prior to association with a surface of a base film.

“Base fibrous structure” as used herein means a fibrous structure that exhibits a basis weight of at least 10 gsm and/or at least 15 gsm and/or at least 20 gsm and/or at least 25 gsm and/or at least 30 gsm and/or at least 35 gsm and/or at least 40 gsm and/or at least 45 gsm and/or at least 50 gsm and/or to less than 120 gsm and/or to less than 100 gsm and/or to less than 80 gsm and/or to less than 70 gsm as measured according to the Basis Weight Test Method described herein and comprises a plurality of fibrous elements, for example a plurality of fibers, such as a plurality of pulp fibers, such as wood pulp fibers and/or non-wood pulp fibers, for example plant fibers, synthetic staple fibers, and mixtures thereof. In addition to pulp fibers, the base fibrous structure may comprise a plurality of filaments, such as polymeric filaments, for example thermoplastic filaments such as polyolefin filaments (i.e., polypropylene filaments), polyester filament, polyethylene terephthalate (PET) filaments and/or hydroxyl polymer filaments, for example polyvinyl alcohol filaments and/or polysaccharide filaments such as starch filaments, such as in the form of a coform base fibrous structure where the fibers and filaments are commingled together and/or are present as discrete or substantially discrete layers within the base fibrous structure.

Non-limiting examples of processes for making the base fibrous structures of the present invention include known wet laid papermaking processes, for example structured paper-making processes, for example through-air-dried (TAD), both creped TAD and uncreped TAD, papermaking processes, fabric-creped papermaking processes, belt-creped papermaking processes, ATMOS papermaking processes, NTT papermaking processes, and air laid papermaking processes. Such processes typically include steps of preparing a fiber composition in the form of a fiber suspension in a medium, either wet, more specifically aqueous medium, or dry, more specifically gaseous, i.e. with air as medium. The aqueous medium used for wet laid processes is oftentimes referred to as a fiber slurry. The fiber slurry is then used to deposit a plurality of the fibers onto a forming wire, fabric, or belt such that an embryonic fibrous structure is formed, after which drying and/or bonding the fibers together results in a base fibrous structure. Further processing of the base fibrous structure may be carried out, for example, in typical papermaking processes, the base fibrous structure can then be wound on a reel at the end of papermaking to form a roll, often referred to as a parent roll, which may subsequently be unwound and associated with a low basis weight nonwoven web to form a laminate fibrous structure of the present invention, for example a single-ply laminate fibrous structure comprising the base fibrous structure associated with the low basis weight nonwoven web.

“Nonwoven web” as used herein means an orderly arrangement of a plurality of non-naturally occurring fibrous elements, for example non-naturally occurring filaments and/or non-naturally occurring fibers, in a fibrous assembly, typically in sheet and/or fibrous structure form. In embodiments, the fibrous elements are inter-entangled. In embodiments, the fibrous elements are bonded together, for example chemically bonded, thermally bonded, mechanically bonded and/or ultrasonically bonded together to provide the nonwoven web with sufficient integrity for its intended uses. In embodiments, the non-naturally occurring fibrous elements comprise a plurality of spun filaments, for example a plurality of spun hydroxyl polymer filaments such as spun polyvinyl alcohol filaments and/or spun cellulose filaments, for example spun regenerated cellulose filaments such as lyocell filaments and/or rayon filaments, and/or a plurality of fibers, which include, but are not limited to, fibers cut from spun filaments, for example staple fibers, such as polyvinyl alcohol fibers and/or regenerated cellulose fibers, such as lyocell fibers and/or rayon fibers.

“Low basis weight nonwoven web” as used herein means a nonwoven web that exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein.

“Non-naturally occurring” as used herein, for example, with respect to a “non-naturally occurring fibrous element(s)” means that the fibrous element, for example filament and/or fiber is not found in nature in that form. In other words, some chemical processing of materials occurred in order to obtain the non-naturally occurring fibrous element, for example filament and/or fiber. For example, a wood pulp fiber is a naturally occurring fiber, however, if the wood pulp fiber is chemically processed, such as via a lyocell-type process, a solution of cellulose is formed. The solution of cellulose may then be spun into a fiber. Accordingly, this spun fibrous element, for example filament and/or fiber, for example lyocell filament and/or fiber and/or rayon filament and/or fiber, would be considered a non-naturally occurring fiber since such a fibrous element is not directly obtainable from nature, rather it was made by a human process.

“Fibrous element” as used herein means an elongate particulate having a length greatly exceeding its average fiber diameter, i.e. a length to average fiber diameter ratio of at least about least about 10 and/or at least about 100 and/or at least about 1000 and/or up to 5000. A fibrous element may be a filament or a fiber. In embodiments, the fibrous element is a single fibrous element rather than a yarn comprising a plurality of fibrous elements.

The fibrous elements of the present invention may be spun from polymer compositions via suitable spinning operations, such as meltblowing and/or spunbonding.

The fibrous elements, for example filaments and/or fibers, of the present invention may be monocomponent and/or multicomponent. For example, the fibrous elements may comprise bicomponent fibers and/or bicomponent filaments. The bicomponent fibers and/or filaments may be in any form, such as side-by-side, core and sheath, islands-in-the-sea and the like. In embodiments, the fibrous elements may comprise monocomponent fibers and/or monocomponent filaments.

“Filament” as used herein means an elongate particulate as described above that exhibits a length of greater than or equal to 5.08 cm (2 in.) and/or greater than or equal to 7.62 cm (3 in.) and/or greater than or equal to 10.16 cm (4 in.) and/or greater than or equal to 15.24 cm (6 in.). The filament may exhibit a length to average fiber diameter ratio of at least about 100 and/or at least about 1000 and/or up to 5000.

Filaments are typically considered continuous or substantially continuous in nature. Filaments are relatively longer than fibers. Non-limiting examples of filaments include meltblown and/or spunbond filaments. Non-limiting examples of polymers that can be spun into filaments include hydroxyl polymers such as natural polymers, such as starch, starch derivatives, cellulose, such as rayon and/or lyocell, and cellulose derivatives, hemicellulose, hemicellulose derivatives, and synthetic hydroxyl polymers including, but not limited to polyvinyl alcohol and/or polyvinyl alcohol derivatives, and other synthetic polymers, such as biodegradable polymers and/or compostable polymers such as polylactic acid, polyhydroxyalkanoate, polyesteramide, and polycaprolactone.

“Fiber” as used herein means an elongate particulate as described above that exhibits a length of less than 5.08 cm (2 in.) and/or less than 3.81 cm (1.5 in.) and/or less than 2.54 cm (1 in.). The fiber may exhibit a length to average fiber diameter ratio of less than 100 and/or less than about 50 and/or less than about 25 and/or about 10.

Fibers are typically considered discontinuous in nature. Non-limiting examples of fibers include pulp fibers, such as wood pulp fibers, and synthetic staple fibers such as polyvinyl alcohol fibers and regenerated cellulose fibers, for example rayon fibers and lyocell fibers.

Synthetic staple fibers may be produced by spinning a filament tow and then cutting the filament tow into segments (fibers) of less than 5.08 cm (2 in.) thus producing synthetic staple fibers.

In embodiments of the present invention, a fiber may be a naturally occurring fiber, which means it is obtained from a naturally occurring source, such as a vegetative source, for example a tree and/or plant, such as trichomes. Such fibers are typically used in papermaking and are oftentimes referred to as papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to fibrous structures made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. Also applicable to the present invention are fibers derived from recycled paper, which may contain any or all of the above categories of fibers as well as other non-fibrous polymers such as fillers, softening agents, wet and dry strength agents, and adhesives used to facilitate the original papermaking.

In embodiments, the wood pulp fibers are selected from the group consisting of hardwood pulp fibers, softwood pulp fibers, and mixtures thereof. The hardwood pulp fibers may be selected from the group consisting of: tropical hardwood pulp fibers, northern hardwood pulp fibers, and mixtures thereof. The tropical hardwood pulp fibers may be selected from the group consisting of: Eucalyptus fibers, acacia fibers, and mixtures thereof. The northern hardwood pulp fibers may be selected from the group consisting of: cedar fibers, maple fibers, and mixtures thereof.

In addition to the various wood pulp fibers, other cellulosic fibers such as cotton linters, rayon, lyocell, trichomes, seed hairs, and bagasse fibers can be used in this invention. Other sources of cellulose in the form of fibers or capable of being spun into fibers include grasses and grain sources.

“Trichome” or “trichome fiber” as used herein means an epidermal attachment of a varying shape, structure and/or function of a non-seed portion of a plant. In embodiments, a trichome is an outgrowth of the epidermis of a non-seed portion of a plant. The outgrowth may extend from an epidermal cell. In one embodiment, the outgrowth is a trichome fiber. The outgrowth may be a hairlike or bristlelike outgrowth from the epidermis of a plant.

Trichome fibers are different from seed hair fibers in that they are not attached to seed portions of a plant. For example, trichome fibers, unlike seed hair fibers, are not attached to a seed or a seed pod epidermis. Cotton, kapok, milkweed, and coconut coir are non-limiting examples of seed hair fibers.

Further, trichome fibers are different from nonwood bast and/or core fibers in that they are not attached to the bast, also known as phloem, or the core, also known as xylem portions of a nonwood dicotyledonous plant stem. Non-limiting examples of plants which have been used to yield nonwood bast fibers and/or nonwood core fibers include kenaf, jute, flax, ramie and hemp.

Further trichome fibers are different from monocotyledonous plant derived fibers such as those derived from cereal straws (wheat, rye, barley, oat, etc), stalks (corn, cotton, sorghum, Hesperaloe funufera, etc.), canes (bamboo, bagasse, etc.), grasses (esparto, lemon, sabai, switchgrass, etc), since such monocotyledonous plant derived fibers are not attached to an epidermis of a plant.

Further, trichome fibers are different from leaf fibers in that they do not originate from within the leaf structure. Sisal and abaca are sometimes liberated as leaf fibers.

Finally, trichome fibers are different from wood pulp fibers since wood pulp fibers are not outgrowths from the epidermis of a plant; namely, a tree. Wood pulp fibers rather originate from the secondary xylem portion of the tree stem.

As used herein the term “non-wood fiber(s)” or “non-wood content” means naturally-occurring fibers derived from non-wood plants, including animal fibers, mineral fibers, plant fibers and mixtures thereof, and specifically excluding non-naturally-occurring fibers (e.g., synthetic fibers). Animal fibers may, for example, be selected from the group consisting of: wool, silk and other naturally-occurring protein fibers and mixtures thereof. The plant fibers may, for example, be obtained directly from a plant. Nonlimiting examples of suitable plants include cotton, cotton linters, flax, sisal, abaca, hemp, hesperaloe, jute, bamboo, bagasse, kudzu, corn, sorghum, gourd, agave, loofah, trichomes, seed-hairs, wheat, and mixtures thereof.

Non-wood fibers of the present disclosure may be derived from one or more non-wood plants of the family Asparagaceae. Suitable non-wood plants may include, but are limited to, one or more plants of the genus Agave such as A. tequilana, A. sisalana and A. fourcroyde, and one or more plants of the genus Hesperaloe such as H. funifera, H. parviflora, H. nocturna, H. changi, H. tenuifolia, H. engelmannii, and H. malacophylla. Further, the non-wood fibers of the present disclosure may be prepared from one or more plants of the of the genus Hesperaloe such as H. funifera, H. parviflora, H. nocturna, H. chiangii, H. tenuifolia, H. engelmannii, and H. malacophylla.

As used herein the term “wood fiber(s)” or “wood content” means fibers derived from both deciduous trees (hereinafter, also referred to as “hardwood”) and coniferous trees (hereinafter, also referred to as “softwood”) may be utilized. Wood fibers may be short (typical of hardwood fibers) or long (typical of softwood fibers). Nonlimiting examples of short fibers include fibers derived from a fiber source selected from the group consisting of Acacia, Eucalyptus, Maple, Oak, Aspen, Birch, Cottonwood, Alder, Ash, Cherry, Elm, Hickory, Poplar, Gum, Walnut, Locust, Sycamore, Beech, Catalpa, Sassafras, Gmelina, Albizia, Anthocephalus, and Magnolia. Nonlimiting examples of long fibers include fibers derived from Pine, Spruce, Fir, Tamarack, Hemlock, Cypress, and Cedar.

As used herein the term “synthetic fiber(s)” or “synthetic content” means fibers human-made fibers, and specifically excludes “wood fibers” and “non-wood fibers.” Synthetic fibers can be used, in combination with non-wood fibers (e.g., bamboo) in the fibrous structures of the present disclosure. Synthetic fibers may be polymeric fibers. Synthetic fibers may comprise elastomeric polymers, polypropylene, polyethylene, polyester, polyolefin, polyvinyl alcohol and nylon, which are obtained from petroleum sources. Additionally, synthetic fibers may be polymeric fibers comprising natural polymers, which are obtained from natural sources, such as starch sources, protein sources and/or cellulose sources may be used in the fibrous structures of the present disclosure. The synthetic fibers may be produced by any suitable methods known in the art.

Fibrous structure(s), web(s) that form the fibrous structure(s), layer(s) of a fibrous structure(s) (including at least one of or each of a first and a second layer of a ply), and/or sheet(s) of a fibrous structure may comprise at least about 5%, about 10%, about 15%, about 20%, about 30%, about 35% about 40%, about 50%, about 75%, about 80%, or about 100% non-wood content, or from about 5% to about 15%, from about 10% to about 30%, from about 20% to about 40%, from about 30% to about 50%, from about 40% to about 60%, from about 50% to about 70%, from about 55% to about 95%, from about 65% to about 85%, from about 60% to about 80%, from about 70% to about 90%, from about 80% to about 100%, from about 90% to about 100%, from about 95% to about 100%, or from about 97.5% to about 100% non-wood content (e.g., bamboo, abaca, hemp, etc.), specifically reciting all 0.1% increments within the above-recited ranges of this paragraph and all ranges formed therein or thereby.

“Basis Weight” as used herein is the weight per unit area of a sample reported in lbs/3000 ft² or g/m² (gsm) and is measured according to the Basis Weight Test Method described herein.

“Machine Direction” or “MD” as used herein means the direction parallel to the flow of the base fibrous structure and/or low basis weight nonwoven web through the fibrous structure and/or nonwoven web making machine.

“Cross Machine Direction” or “CD” as used herein means the direction parallel to the width of the fibrous structure and/or nonwoven web making machine and perpendicular to the MD.

“Ply” as used herein means an individual, integral fibrous structure.

“Plies” as used herein means two or more individual, integral fibrous structures disposed in a substantially contiguous, face-to-face relationship with one another, forming a multi-ply fibrous structure and/or multi-ply toilet tissue. It is also contemplated that an individual, integral fibrous structure can effectively form a multi-ply fibrous structure, for example, by being folded on itself.

“Embossed” as used herein with respect to a web material, a fibrous structure, and/or a toilet tissue means that a web material, a fibrous structure, and/or a toilet tissue has been subjected to a process which converts a smooth surfaced web material, fibrous structure, and/or toilet tissue to a decorative surface by replicating a design on one or more emboss rolls, which form a nip through which the web material, fibrous structure, and/or toilet tissue passes. Embossed does not include creping, microcreping, printing or other processes that may also impart a texture and/or decorative pattern to a web material, a fibrous structure, and/or a toilet tissue.

“Differential density”, as used herein, means a web material that comprises one or more regions of relatively low fiber density, which are referred to as pillow regions, and one or more regions of relatively high fiber density, which are referred to as knuckle regions.

“Densified”, as used herein means a portion of a fibrous structure and/or toilet tissue that is characterized by regions of relatively high fiber density (knuckle regions).

“Non-densified”, as used herein, means a portion of a fibrous structure and/or toilet tissue that exhibits a lesser density (one or more regions of relatively lower fiber density) (pillow regions) than another portion (for example a knuckle region) of the fibrous structure and/or toilet tissue.

“Non-rolled” as used herein with respect to a fibrous structure and/or toilet tissue of the present invention means that the fibrous structure and/or toilet tissue is an individual sheet (for example not connected to adjacent sheets by perforation lines. However, two or more individual sheets may be interleaved with one another) that is not convolutedly wound about a core or itself.

“Creped” as used herein means creped off of a Yankee dryer or other similar roll and/or fabric creped and/or belt creped. Rush transfer of a fibrous structure alone does not result in a “creped” fibrous structure or “creped” toilet tissue for purposes of the present invention.

“Toilet tissue” as used herein means a soft, relatively low density fibrous structure, for example a multi-ply two or more or three or more fibrous structure plies useful as a wiping implement for post-urinary and post-bowel movement cleaning. The toilet tissue may be convolutedly wound upon itself about a core or without a core to form a toilet tissue roll (roll of toilet tissue) or may be in the form of discrete sheets. When in the form of a roll of toilet tissue, the roll of toilet tissue may exhibit a roll compressibility (% Compressibility) as measured according to the Roll Compressibility Test Method described herein of from about 4% to about 8% and/or from about 4% to about 7% and/or from about 4% to about 6%.

In embodiments, the toilet tissue of the present invention comprises one or more fibrous structures according to the present invention.

The toilet tissue and/or fibrous structures of the present invention making up the toilet tissue may exhibit a basis weight between about 1 g/m² to about 5000 g/m² and/or from about 10 g/m² to about 500 g/m² and/or from about 10 g/m² to about 300 g/m² and/or from about 10 g/m² to about 120 g/m² and/or from about 15 g/m² to about 110 g/m² and/or from about 20 g/m² to about 100 g/m² and/or from about 30 to 90 g/m² as determined by the Basis Weight Test Method described herein. In addition, the toilet tissue of the present invention may exhibit a basis weight between about 10 g/m² to about 120 g/m² and/or from about 10 g/m² to about 80 g/m² and/or from about 10 to about 60 g/m² and/or from about 10 g/m² to about 55 g/m² and/or from about 20 g/m² to about 55 g/m² as determined by the Basis Weight Test Method described herein.

The toilet tissue of the present invention may exhibit a total dry tensile strength of greater than about 59 g/cm (greater than about 150 g/in) and/or greater than about 78 g/cm (greater than about 200 g/in) and/or greater than about 98 g/cm (greater than about 250 g/in) and/or greater than about 138 g/cm (greater than about 350 g/in) and/or from about 78 g/cm (about 200 g/in) to about 394 g/cm (about 1000 g/in) and/or from about 98 g/cm (about 250 g/in) to about 335 g/cm (about 850 g/in). In addition, the toilet tissue of the present invention may exhibit a total dry tensile strength of greater than about 196 g/cm (greater than about 500 g/in) and/or from about 196 g/cm (about 500 g/in) to about 394 g/cm (about 1000 g/in) and/or from about 216 g/cm (about 550 g/in) to about 335 g/cm (about 850 g/in) and/or from about 236 g/cm (about 600 g/in) to about 315 g/cm (about 800 g/in). In embodiments, the toilet tissue exhibits a total dry tensile strength of less than about 394 g/cm (less than about 1000 g/in) and/or less than about 335 g/cm (less than about 850 g/in).

The toilet tissue of the present invention may exhibit a density of less than 0.60 g/cm³ and/or less than 0.30 g/cm³ and/or less than 0.20 g/cm³ and/or less than 0.15 g/cm³ and/or less than 0.10 g/cm³ and/or less than 0.07 g/cm³ and/or less than 0.05 g/cm³ and/or from about 0.01 g/cm³ to about 0.20 g/cm³ and/or from about 0.02 g/cm³ to about 0.15 g/cm³ and/or from about 0.02 g/cm³ to about 0.10 g/cm³.

The toilet tissue of the present invention may be in the form of toilet tissue rolls. Such toilet tissue rolls may comprise a plurality of connected, but perforated sheets of fibrous structure, that are separably dispensable from adjacent sheets.

The toilet tissue and/or fibrous structures making up the toilet tissue of the present invention may comprise additives such as softening agents, temporary wet strength agents, permanent wet strength agents, bulk softening agents, lotions, silicones, wetting agents, latexes, patterned latexes and other types of additives suitable for inclusion in and/or on toilet tissue.

“Layered” as used herein means that a fibrous structure comprises in embodiments at least two visually discernible z-direction portions, for example a first layer and a second layer wherein the two visually discernible z-direction portions within the fibrous structure are formed at the same time, such as in a layered wet laid fibrous structure making process, or one is formed on top of the other, such as in a layered nonwoven fibrous structure wherein one layer is formed, for example spun and laid directly on top of a surface of a pre-formed nonwoven fibrous structure. The visually discernible layers may be different compositions, different textures, different colors, different properties, etc.

“Associate,” “Associated,” “Association,” and/or “Associating” as used herein with respect to fibrous elements and/or with respect to a base fibrous structure of the present invention being associated with a low basis weight nonwoven web of the present invention means combining and/or laminating and/or bonding, for example adhesively (adhesive bonds), chemically (chemical bonds), thermally (thermal bonds) and/or mechanically (mechanical bonds), such that a laminate fibrous structure according to the present invention is formed.

“3D pattern” with respect to a fibrous structure and/or toilet tissue's surface in accordance with the present invention means herein a pattern that is present on at least one surface of the fibrous structure and/or toilet tissue. The 3D pattern texturizes the surface of the fibrous structure and/or toilet tissue, for example by providing the surface with protrusions and/or depressions. The 3D pattern on the surface of the fibrous structure and/or toilet tissue is made by making the toilet tissue or at least one fibrous structure ply employed in the toilet tissue on a patterned molding member that imparts the 3D pattern to the toilet tissue and/or fibrous structure plies made thereon.

“Water-resistant” as it refers to a surface pattern or part thereof means that a 3D pattern retains its structure and/or integrity after being saturated by water and the 3D pattern is still visible to a consumer. In embodiments, the 3D pattern may be water-resistant.

“Wet textured” as used herein means that a 3D patterned fibrous structure comprises texture (for example a three-dimensional topography) imparted to the fibrous structure and/or fibrous structure's surface during a fibrous structure making process. In embodiments, in a wet laid fibrous structure making process, wet texture can be imparted to a fibrous structure upon fibers and/or filaments being collected on a collection device that has a three-dimensional (3D) surface which imparts a 3D surface to the fibrous structure being formed thereon and/or being transferred to a fabric and/or belt, such as a through-air-drying fabric and/or a patterned drying belt, comprising a 3D surface that imparts a 3D surface to a fibrous structure being formed thereon. In embodiments, the collection device with a 3D surface comprises a patterned, such as a patterned formed by a polymer or resin being deposited onto a base substrate, such as a fabric, in a patterned configuration. The wet texture imparted to a wet laid fibrous structure is formed in the fibrous structure prior to and/or during drying of the fibrous structure. Non-limiting examples of collection devices and/or fabric and/or belts suitable for imparting wet texture to a fibrous structure include those fabrics and/or belts used in fabric creping and/or belt creping processes, for example as disclosed in U.S. Pat. Nos. 7,820,008 and 7,789,995, coarse through-air-drying fabrics as used in uncreped through-air-drying processes, and photo-curable resin patterned through-air-drying belts, for example as disclosed in U.S. Pat. No. 4,637,859. Wet texture is different from non-wet texture that is imparted to a fibrous structure after the fibrous structure has been dried, for example after the moisture level of the fibrous structure is less than 15% and/or less than 10% and/or less than 5%. An example of non-wet texture includes embossments imparted to a fibrous structure by embossing rolls during converting of the fibrous structure.

“Hydroxyl polymer” as used herein includes any hydroxyl-containing polymer that can be incorporated into a fibrous element of the present invention. In embodiments, the hydroxyl polymer of the present invention includes greater than 10% and/or greater than 20% and/or greater than 25% by weight hydroxyl moieties. In another example, the hydroxyl within the hydroxyl-containing polymer is not part of a larger functional group such as a carboxylic acid group.

“Chemically different” as used herein with respect to two hydroxyl polymers means that the hydroxyl polymers are at least different structurally, and/or at least different in properties and/or at least different in classes of chemicals, for example polysaccharides, such as starch, versus non-polysaccharides, such as polyvinyl alcohol, and/or at least different in their respective solubility parameters.

“Non-thermoplastic” as used herein means, with respect to a material, such as a fibrous element as a whole and/or a polymer within a fibrous element, that the fibrous element and/or polymer exhibits no melting point and/or softening point, which allows it to flow under pressure, in the absence of a plasticizer, such as water, glycerin, sorbitol, urea and the like.

“Non-cellulose-containing” as used herein means that less than 5% and/or less than 3% and/or less than 1% and/or less than 0.1% and/or 0% by weight of cellulose polymer, cellulose derivative polymer and/or cellulose copolymer is present in fibrous element. In embodiments, “non-cellulose-containing” means that less than 5% and/or less than 3% and/or less than 1% and/or less than 0.1% and/or 0% by weight of cellulose polymer is present in fibrous element.

“Polymer composition” as used herein means a composition comprising a solvent, for example water and/or a non-water solvent such as those used in regenerated cellulose processing, and a hydroxyl polymer, for example polyvinyl alcohol and/or a polysaccharide, for example starch and/or starch derivative and/or cellulose and/or cellulose derivative.

“Average Fiber Diameter” as used herein, with respect to one or more fibrous elements, for example one or more filaments and/or one or more fibers, is measured according to the Average Fiber Diameter Test Method described herein. In embodiments, one or more fibrous elements, for example one or more filaments and/or fibers, of the present invention exhibit an average fiber diameter of less than 50 m and/or less than 25 m and/or less than 20 m and/or less than 15 m and/or less than 10 m and/or less than 6 m and/or greater than 1 m and/or greater than 3 m as measured according to the Average Fiber Diameter Test Method described herein.

As used herein, the articles “a” and “an” when used herein, for example, “an anionic surfactant” or “a fiber” is understood to mean one or more of the material that is claimed and/or described.

As used herein, the term “embodiments” is understood to include one or more embodiments, such as a single embodiment or multiple embodiments.

All percentages and ratios are calculated by weight unless otherwise indicated. All percentages and ratios are calculated based on the total composition unless otherwise indicated.

Unless otherwise noted, all component or composition levels are in reference to the active level of that component or composition, and are exclusive of impurities, for example, residual solvents or by-products, which may be present in commercially available sources.

### Multi-Ply Fibrous Structures

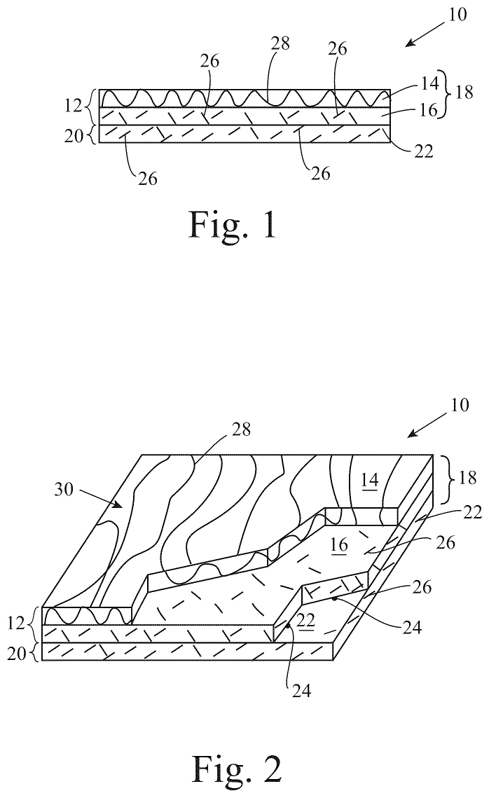

As shown in FIGS. 1 and 2, in embodiments, a multi-ply fibrous structure 10 of the present invention comprises at least a first fibrous structure ply 12 comprising a low basis weight nonwoven web 14 according to the present invention associated with a base fibrous structure 16 according to the present invention, which together form a laminate fibrous structure 18 according to the present invention. The low basis weight nonwoven web 14 is pre-formed, in other words, pre-existing in physical form at the time of association with the base fibrous structure 16 (rather than formed concurrently and/or after the time of association with the base fibrous structure 16). In addition to the laminate fibrous structure 18, the multi-ply fibrous structure 10 further comprises a second fibrous structure ply 20 according to the present invention, which may be the same as or different from the first fibrous structure ply 12.

In embodiments, the multi-ply fibrous structure 10 of the present invention may exhibit a caliper of greater than 20.0 mils as measured according to the Caliper Test Method described herein and/or a CRT Capacity of greater than 15 g/g as measured according to the CRT Test Method described herein and/or a Plate Stiffness of less than 8.00 N*mm as measured according to the Plate Stiffness Test Method described herein.

In embodiments as shown in FIGS. 1 and 2, the multi-ply fibrous structure 10 of the present invention comprises two or more fibrous structure plies, for example a first fibrous structure ply 12 and a second fibrous structure ply 20, wherein at least one of the two or more fibrous structure plies comprises a low basis weight nonwoven web 14 of the present invention, for example a laminate fibrous structure 18 of the present invention comprising a low basis weight nonwoven web 14 associated with a base fibrous structure 16, and at least one of the two or more fibrous structure plies comprises a fibrous structure 22, for example an air laid fibrous structure and/or carded fibrous structure and/or hydroentangled fibrous structure and/or a spun, such as meltblown and/or spunbond fibrous structure and/or a wet laid fibrous structure, for example a wet laid structured fibrous structure ply, for example a structured pulp fiber-containing fibrous structure ply, such as a structured (through-air-dried, fabric-creped, belt-creped, ATMOS, or NTT, in particular through-air-dried, fabric-creped, or belt-creped, especially through-air-dried) wood pulp fiber-containing fibrous structure ply. In embodiments, the fibrous structure 22 and the base fibrous structure 16 may be the same or different. They may exhibit similar properties or exhibit different properties. They may be made by the same process or by different processes. They may exhibit the same pattern or different patterns or one may be patterned and the other may not or one may be embossed and the other may not.

As shown in FIGS. 1 and 2, the multi-ply fibrous structure of the present invention comprises two or more fibrous structure plies 12, 20. In embodiments, at least two of the fibrous structure plies 12, 20 are different from one another, for example in texture, caliper, basis weight, fibrous element (fibers and/or filaments) composition and/or chemical composition. In embodiments, at least two of the fibrous structure plies 12, 20 may be associated, for example laminated and/or bonded together, for example adhesively bonded together, for example by adhesive 24, such as by a plybond glue (for example a hot melt glue and/or a cold glue). In embodiments, at least two of the fibrous structure plies 12, 20 may be bonded together, for example adhesively bonded together in a pattern, for example a non-random repeating pattern and/or a stripe. The multi-ply fibrous structure of the present invention may comprise a first fibrous structure ply 12 comprising and/or in the form of a laminate fibrous structure 18 of the present invention, and a second fibrous structure ply 20 that are bonded together, for example adhesively bonded together in a first pattern, and the laminate fibrous structure 18 comprises a low basis weight nonwoven web 14 associated, for example laminated and/or bonded together, for example for example adhesively (adhesive bonds), chemically (chemical bonds), thermally (thermal bonds) and/or mechanically (mechanical bonds) bonded together in a second pattern, which may be the same or different from the first pattern.

In embodiments, multi-ply fibrous structure 10 of the present invention may comprises a first fibrous structure ply 12 comprising a low basis weight nonwoven web 14, for example alone or as part of a laminate fibrous structure 18 where the low basis weight nonwoven web 14 is associated with a base fibrous structure 18, and/or a second fibrous structure ply 20 comprising a layered fibrous structure comprising one or more layers of fibers, for example pulp fibers, such as wood pulp fibers, for example a layered wet-laid fibrous structure ply, such as a structured layered wet-laid fibrous structure ply. When present, the fibers present in the layers of the layered fibrous structure may be different, for example one layer may comprise hardwood pulp fibers, such as Eucalyptus fibers and the other layer may comprise softwood pulp fibers, such as NSK fibers. The layers of fibers may be associated with one another to form a fibrous structure, for example a layered wet-laid fibrous structure ply, such as a structured, layered wet-laid fibrous structure ply.

In embodiments, at least one and/or at least two of the fibrous structure plies 12, 20 of the multi-ply fibrous structure 10 of the present invention may comprise one or more fibrous structures at least one of which may be a low basis weight nonwoven web 14 and/or a laminate fibrous structure 18 comprising the low basis weight nonwoven web 14 associated with a base fibrous structure 16, which may be the same and/or different to one or more other fibrous structure plies within the multi-ply fibrous structure 10. The multi-ply fibrous structure 10 of the present invention may comprise a first fibrous structure ply 12, for example a laminate fibrous structure 18, that exhibits a first caliper and a second fibrous structure ply 20, for example a fibrous structure 22, such as a wet-laid fibrous structure ply, such as a structured wet laid fibrous structure ply that exhibits a second caliper, wherein the first caliper and second caliper may be the same or different from each other. The second fibrous structure ply 20 may exhibit the highest caliper within the multi-ply fibrous structure 10. In embodiments, at least one of the first and second fibrous structure plies 12, 20, for example the base fibrous structure 16 of a laminate fibrous structure 18 of the present invention and/or a fibrous structure 22 may comprise a layered fibrous structure, for example a layered wet-laid fibrous structures, such as a structured, layered wet-laid fibrous structures. In embodiments, at least one of the fibrous structure plies 12, 20, for example the base fibrous structure 16 of a laminate fibrous structure 18 of the present invention and/or a fibrous structure 22 may comprise a non-layered fibrous structure, for example non-layered wet-laid fibrous structures, such as structured, non-layered wet-laid fibrous structures. In embodiments, one of the fibrous structure plies 12, 20, for example the base fibrous structure 16 of a laminate fibrous structure 18 of the present invention and/or a fibrous structure 22 may comprise a layered fibrous structure and the other fibrous structure ply may comprise a non-layered fibrous structure.

The fibrous structure plies 12, 20 and/or the multi-ply fibrous structures 10 of the present invention may be embossed and/or tufted that creates a three-dimensional surface pattern, for example on an exterior surface of the fibrous structure ply 12, 20 and/or multi-ply fibrous structure 10 that provides aesthetics and/or improved cleaning properties. In embodiments, the emboss area may be greater than 10% and/or greater than 12% and/or greater than 15% and/or greater than 20% of the surface area of at least one surface of the fibrous structure ply 12, 20 and/or the multi-ply fibrous structure 10.

It has unexpectedly been found that the multi-ply fibrous structure 10 of the present invention may exhibit a caliper of greater than 20.0 mils and/or at least about 22.0 mils and/or at least about 24.0 mils and/or at least about 26.0 mils and/or at least about 27.0 mils as measured according to the Caliper Test Method. In embodiments, the multi-ply fibrous structure 10 of the present invention may exhibit a caliper of from about 27.0 mils to about 32.0 mils and/or from about 27.0 mils to about 30.0 mils as measured according to the Caliper Test Method.

It has unexpectedly been found that the multi-ply fibrous structure 10 of the present invention may exhibit a CRT Capacity of greater than 15 g/g and/or at least about 17 g/g and/or at least about 19 g/g and/or at least about 20 g/g as measured according to the CRT Test Method. In embodiments, the multi-ply fibrous structure 10 of the present invention may exhibit a CRT Capacity of from about 20 g/g to about 28 g/g and/or of from about 20 g/g to about 25 g/g as measured according to the CRT Test Method.

It has unexpectedly been found that the multi-ply fibrous structure 10 of the present invention may exhibit exhibits a Plate Stiffness of less than about 10 N*mm and/or less than about 8 N*mm and/or less than about 7.70 N*m and/or less than about 6 N*mm as measured according to the Plate Stiffness Test Method. In embodiments, the multi-ply fibrous structure 10 may exhibit a Plate Stiffness of from about 1 N*m to less than 8 N*m and/or from about 4 to about 6 N*mm and/or from about 5 to about 6 N*mm as measured according to the Plate Stiffness Test Method.

The multi-ply fibrous structure 10 of the present invention may exhibit a CRT Rate of less than about 1.0 and/or less than about 0.7 and/or less than about 0.5 less than about 0.3 g/sec as measured according to the CRT Test Method.

The multi-ply fibrous structure 10 of the present invention may exhibit a Basis Weight of at least about 20 gsm and/or at least about 25 gsm and/or at least about 30 gsm and/or at least about 35 gsm and/or at least about 40 gsm and/or at least about 45 gsm and/or at least about 50 gsm and/or at least about 55 gsm as measured according to the Basis Weight Test Method. In embodiments, the multi-ply fibrous structure 10 of the present invention may exhibit a Basis Weight of at least about 10 gsm to about 120 gsm and/or at least about 20 gsm to about 80 gsm as measured according to the Basis Weight Test Method. The multi-ply fibrous structure may exhibit a Basis Weight of at least about 10 gsm to about 60 gsm and/or at least 10 gsm to about 55 gsm and/or at least about 20 gsm to about 55 gsm and/or at least about 25 gsm to about 55 gsm as measured according to the Basis Weight Test Method.

The multi-ply fibrous structure 10 of the present invention may be flushable and/or dispersible and/or suitable for disposal in municipal wastewater and sewer systems and/or septic systems.

The multi-ply fibrous structure 10 of the present invention may exhibit a Total Wet Decay of greater than 30% and/or greater than 40% and/or greater than 50% and/or greater than 60% as measured according to the Wet Decay Test Method.

The multi-ply fibrous structure 10 of the present invention may exhibit an Initial Total Wet Tensile of greater than 30 g/in and/or greater than 40 g/in and/or greater than 50 g/in and/or greater than 60 g/in as measured according to the Wet Tensile Test Method.

The multi-ply fibrous structure 10 of the present invention may exhibit a Total Dry Tensile of greater than 150 g/in and/or greater than about 200 g/in and/or greater than about 250 g/in and/or greater than about 350 g/in greater than about 500 g/in as measured according to the Dry Tensile Test Method. In embodiments, the multi-ply fibrous structure 10 of the present invention may exhibit a Total Dry Tensile of from about 150 g/in to about 1000 g/in and/or from about 200 g/in to about 1000 g/in and/or from about 250 g/in to about 850 g/in and/or from about 350 g/in to about 850 g/in and/or from about 500 g/in to about 850 g/in as measured according to the Dry Tensile Test Method.

The multi-ply fibrous structure 10 of the present invention may exhibit a Flexural Rigidity of less than about 700 mg-cm and/or less than about 500 mg-cm and/or less than about 450 mg-cm and/or less than about 400 mg-cm as measured according to the Flexural Rigidity Test Method. In embodiments, the multi-ply fibrous structure 10 of the present invention may exhibit a Flexural Rigidity of from about 500 mg-cm to about 100 mg-cm and/or from about 450 mg-cm to about 200 mg-cm and/or from about 400 mg-cm to about 300 mg-cm as measured according to the Flexural Rigidity Test Method.

The multi-ply fibrous structure 10 of the present invention may exhibit any combination of the properties described herein.

The multi-ply fibrous structure 10 of the present invention may comprise at least one fibrous structure ply comprising a fibrous structure 22, for example a structured fibrous structure, including structured fibrous structures formed on NTT and/or ATMOS papermaking lines, and through-air-dried fibrous structures, such as a creped through-air-dried fibrous structures or uncreped through-air-dried fibrous structures.

The multi-ply fibrous structure 10 of the present invention may comprise at least one fibrous structure ply comprising a belt creped fibrous structure.

The multi-ply fibrous structure 10 of the present invention may comprise at least one fibrous structure ply comprising a fabric creped fibrous structure.

The multi-ply fibrous structure 10 of the present invention may comprise at least one fibrous structure ply comprising a conventional wet-pressed fibrous structure.

The multi-ply fibrous structure 10 of the present invention may comprise at least one fibrous structure ply comprising an embossed fibrous structure.

The multi-ply fibrous structure 10 of the present invention and/or at least one fibrous structure 22 and/or base fibrous structure 16 of the multi-ply fibrous structure 10 of the present invention may comprise at least one fibrous element, for example a fiber, such as a pulp fiber, which may be a wood pulp fiber.

The multi-ply fibrous structure 10 of the present invention and/or at least one fibrous structure 22 and/or base fibrous structure 16 of the multi-ply fibrous structure 10 of the present invention may comprise at least one fibrous element, for example a filament, such as a filament comprising a hydroxyl polymer, which may be a polysaccharide, such as a polysaccharide is selected from the group consisting of: starch, starch derivatives, cellulose derivatives, hemicellulose, hemicellulose derivatives, and mixtures thereof, more specifically starch. In embodiments, the hydroxyl polymer may comprise polyvinyl alcohol.

In embodiments, the first fibrous structure ply 12, for example a laminate fibrous structure 18, is adhesively bonded, for example by adhesive 24, such as plybond glue (for example hot melt glue and/or cold glue), to the fibrous structure 22 of the second fibrous structure ply 20. The fibrous structure 22 of the second fibrous structure ply 20 of the multi-ply fibrous structure 10 described immediately above may be in the form of a fibrous structure 22 comprising a plurality of fibers 26, for example pulp fibers, such as wood pulp fibers. In embodiments, the fibrous structure 22 of the second fibrous structure ply 20 may be a wet-laid fibrous structure according to the present invention.

In embodiments, the base fibrous structure 16 of the laminate fibrous structure 18, when present in the multi-ply fibrous structure 10 of the present invention, may be in the form of a fibrous structure comprising a plurality of fibers 26, for example pulp fibers, such as wood pulp fibers. In embodiments, the base fibrous structure 16 of the laminate fibrous structure 18, when present in the multi-ply fibrous structure 10 of the present invention may be a wet-laid fibrous structure according to the present invention.

In embodiments, the low basis weight nonwoven web 14 of the multi-ply fibrous structure 10 of the present invention and/or the laminate fibrous structure 18 when associated with a base fibrous structure 16 of the present invention may be in the form of a fibrous structure comprising a plurality of filaments 28, for example spun filaments, such as meltblown filaments and/or spunbond filaments, for example polyvinyl alcohol filaments. In another example (not shown), the low basis weight nonwoven web 14 of the multi-ply fibrous structure 10 of the present invention and/or the laminate fibrous structure 18 when associated with a base fibrous structure 16 of the present invention may be in the form of a fibrous structure comprising a plurality of filaments 28, for example spun filaments, such as meltblown filaments and/or spunbond filaments, for example polyvinyl alcohol filaments and a plurality of fibers, for example natural fibers, such as pulp fibers, for example wood pulp fibers, and/or synthetic fibers, such as polymeric staple fibers, for example polyvinyl alcohol fibers and/or spun cellulose fibers, such as lyocell and/or rayon fibers. In even another example (not shown), the low basis weight nonwoven web 14 of the multi-ply fibrous structure 10 of the present invention and/or the laminate fibrous structure 18 when associated with a base fibrous structure 16 of the present invention may be in the form of a fibrous structure comprising a plurality of fibers 26, for example natural fibers, such as pulp fibers, for example wood pulp fibers, and/or synthetic fibers, such as polymeric staple fibers, for example polyvinyl alcohol fibers and/or spun cellulose fibers, such as lyocell and/or rayon fibers. In embodiments (not shown), the low basis weight nonwoven web 14 of the multi-ply fibrous structure 10 of the present invention and/or the laminate fibrous structure 18 when associated with a base fibrous structure 16 of the present invention may be in the form of a fibrous structure comprising a plurality of fibers 26, for example synthetic fibers, such as polymeric staple fibers, for example polyvinyl alcohol fibers and/or spun cellulose fibers, such as lyocell and/or rayon fibers. In still another example (not shown), the low basis weight nonwoven web 14 of the multi-ply fibrous structure 10 of the present invention and/or the laminate fibrous structure 18 when associated with a base fibrous structure 16 of the present invention may be in the form of a fibrous structure comprising a plurality of fibers 26, for example synthetic fibers, such as spun cellulose fibers, such as lyocell and/or rayon fibers.

The multi-ply fibrous structure 10 comprises a least one exterior surface 30, for example a consumer-contacting surface, that comes into contact with a consumer during use, such as during wiping. The exterior surface 30 of the multi-ply fibrous structure 10 may comprise and/or be defined by at least a portion of the first fibrous structure ply 12, for example the low basis weight nonwoven web 14, which in embodiments is part of the laminate fibrous structure 18.

In addition, the multi-ply fibrous structure of the present invention and/or fibrous structure plies of the multi-ply fibrous structure may be non-lotioned and/or may not contain a post-applied surface chemistry. The multi-ply fibrous structure of the present invention and/or fibrous structure plies of the multi-ply fibrous structure may be creped or uncreped. The multi-ply fibrous structure of the present invention and/or fibrous structure plies of the multi-ply fibrous structure may be uncreped fibrous structure plies. An exterior surface of the multi-ply fibrous structure of the present invention and/or fibrous structure plies of the multi-ply fibrous structure may not be creped (uncreped and/or non-undulating and/or not creped off a surface, such as a Yankee), however the any of the fibrous structures making up the fibrous structure plies may be creped (undulating and/or creped off a surface, such as a Yankee).

In embodiments, a package of the present invention may comprise one or more rolls of multi-ply fibrous structure, for example a multi-ply (two or more or three or more fibrous structure plies) multi-ply fibrous structure of the present invention.

In embodiments, the fibrous structure ply and/or plies of the multi-ply fibrous structure including the base fibrous structure of the laminate fibrous structure (laminate fibrous structure ply) may be the same or different from one another. For example, they may comprise the same or different fibers as described more fully below in the base fibrous structure description. They may individually be homogeneous or layered. They may individually be structured or conventional wet pressed. They may individually be embossed or unembossed. They may individually be creped or uncreped. They may individually be printed or non-printed. They may individually contain different surface compositions, for example surface softening compositions and/or lotions. For example, a surface softening composition and/or lotion may be applied to one or more surfaces of the low basis weight nonwoven web, the base fibrous structure, the laminate fibrous structure and/or the multi-ply fibrous structure. In embodiments, the fibrous elements, for example filaments and/or fibers, of the low basis weight nonwoven web may span texture present on the surface of a base fibrous structure, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure, for example one or more low density regions (for example pillow regions) and one or more high density regions (for example knuckle regions) of the surface of the base fibrous structure, providing a smooth canvass for surface composition application. The resulting multi-ply fibrous structure of the present invention may exhibit a unique combination of texture and softness, for example TS7 softness as measured according to the Emtec Test Method described herein

The low basis weight nonwoven web, the base fibrous structure, the laminate fibrous structure and/or the multi-ply fibrous structure may individually contain wet strength agents, such as temporary wet strength agents or be void of temporary wet strength agents. Also, the low basis weight nonwoven web, the base fibrous structure, the laminate fibrous structure and/or the multi-ply fibrous structure may individually exhibit the same or different wet tensile strengths and/or wet decay rates.

### Methods for Making Multi-Ply Fibrous Structures

The multi-ply fibrous structures 10 of the present invention may be made by any suitable process so long as at least one fibrous structure ply comprises at least a low basis weight nonwoven web 14, alone and/or associated with a base fibrous structure 16 to form a laminate fibrous structure 18 according to the present invention.

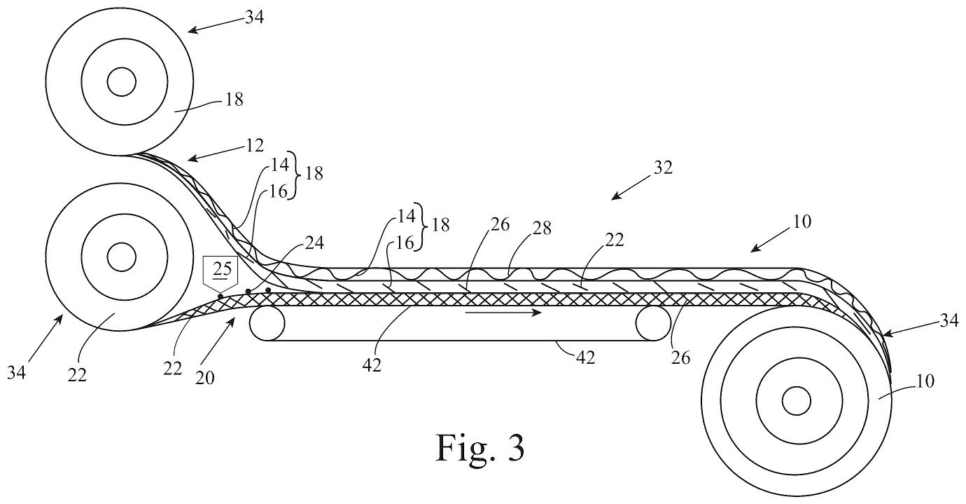

In embodiments of the present invention, as shown in FIG. 3, a method 32 for making a multi-ply fibrous structure 10 of the present invention, an example of which is illustrated in FIGS. 1 and 2, comprises the steps of:
a. providing a first fibrous structure ply 12, which may be in the form of a roll 34, comprising a laminate fibrous structure 18, for example a roll 34 of the laminate fibrous structure 18, wherein the laminate fibrous structure 18 comprises a base fibrous structure 16, for example a wet laid fibrous structure, for example a wet laid fibrous structure comprising fibers 26, for example pulp fibers, such as wood pulp fibers, associated with a low basis weight nonwoven web 14, for example a single-ply low basis weight nonwoven web, that exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, wherein the low basis weight nonwoven web 14 comprises a plurality of fibrous elements, for example filaments 28 and/or fibers 26, comprising a hydroxyl polymer, for example a non-naturally occurring hydroxyl polymer, for example a water-soluble hydroxyl polymer, such as a polyvinyl alcohol filaments 28 and/or fibers 26;
b. providing a second fibrous structure ply 20 comprising a fibrous structure 22 comprising a plurality of fibrous elements, for example filaments 28 and/or fibers 26, in this example fibers 26; and
c. associating, for example adhesively bonding, such as with an adhesive 24 from an adhesive source 25, for example plybonding, the first fibrous structure ply 12 with the second fibrous structure ply 20, wherein this step of associating my comprise unwinding a roll 34 of the first fibrous structure ply 12 and unwinding a roll 34 of the second fibrous structure ply 20 prior to associating the first and second fibrous structure plies 12, 20 to form the multi-ply fibrous structure 10.

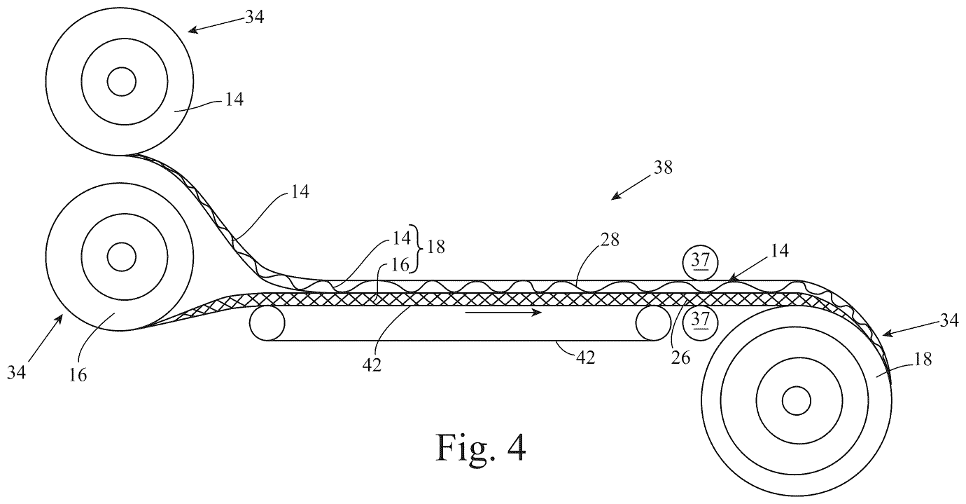

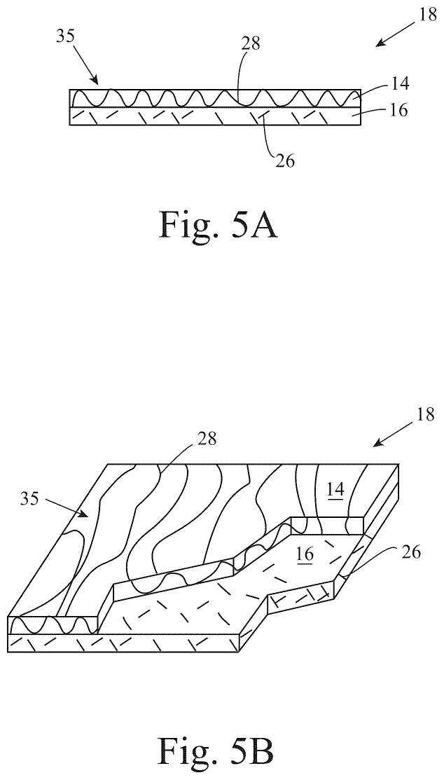

In embodiments of the present invention, as shown in FIGS. 3, a method 32 for making a multi-ply fibrous structure 10 of the present invention, an example of which is illustrated in FIGS. 1 and 2, comprises the steps of:
a. making a first fibrous structure ply 12 comprising a laminate fibrous structure 18 as shown in FIGS. 4, 5A and 5B by associating a base fibrous structure 16, for example a wet laid fibrous structure, for example a wet laid fibrous structure comprising fibers 26, for example pulp fibers, such as wood pulp fibers, for example by winding a roll 34 of the base fibrous structure 16, with a low basis weight nonwoven web 14, for example a single-ply low basis weight nonwoven web, for example by unwinding a roll 34 of the low basis weight nonwoven web 14, wherein the low basis weight nonwoven web exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, and wherein the low basis weight nonwoven web 14 comprises a plurality of fibrous elements, for example filaments 28 and/or fibers 26, comprising a hydroxyl polymer, for example a non-naturally occurring hydroxyl polymer, for example a water-soluble hydroxyl polymer, such as a polyvinyl alcohol filaments 28 and/or fibers 26;
b. providing a second fibrous structure ply 20 comprising a fibrous structure 22 of the present invention; and
c. associating, for example adhesively bonding, such as with an adhesive 24 from an adhesive source 25, for example plybonding, the first fibrous structure ply 12 with the second fibrous structure ply 20, wherein this step of associating my comprise unwinding a roll 34 of the first fibrous structure ply 12 and unwinding a roll 34 of the second fibrous structure ply 20 prior to associating the first and second fibrous structure plies 12, 20 to form the multi-ply fibrous structure 10.

In embodiments of the present invention, as shown in FIG. 3, a method 32 for making a multi-ply fibrous structure 10 of the present invention, an example of which is illustrated in FIGS. 1 and 2, comprises the steps of:
a. providing a first fibrous structure ply 12, which may be in the form of a roll 34, comprising a laminate fibrous structure 18, for example a roll 34 of the laminate fibrous structure 18, wherein the laminate fibrous structure 18 comprises a base fibrous structure 16, for example a wet laid fibrous structure, for example a wet laid fibrous structure comprising fibers 26, for example pulp fibers, such as wood pulp fibers, associated with a low basis weight nonwoven web 14, for example a single-ply low basis weight nonwoven web, that exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, wherein the low basis weight nonwoven web 14 comprises a plurality of fibrous elements, for example, filaments 28 and/or fibers 26, comprising a hydroxyl polymer, for example a non-naturally occurring hydroxyl polymer, such as a non-water soluble hydroxyl polymer, for example spun cellulose filaments 28 and/or fibers 26, for example regenerated cellulose filaments 28 and/or fibers 26, such as lyocell filaments 28 and/or fibers 26 and/or rayon filaments 28 and/or fibers 26;
b. providing a second fibrous structure ply 20 comprising a fibrous structure 22 comprising a plurality of fibrous elements, for example filaments 28 and/or fibers 26, in this example fibers 26; and
c. associating, for example adhesively bonding, such as with an adhesive 24 from an adhesive source 25, for example plybonding, the first fibrous structure ply 12 with the second fibrous structure ply 20, wherein this step of associating my comprise unwinding a roll 34 of the first fibrous structure ply 12 and unwinding a roll 34 of the second fibrous structure ply 20 prior to associating the first and second fibrous structure plies 12, 20 to form the multi-ply fibrous structure 10.

In embodiments of the present invention, as shown in FIGS. 3, a method 32 for making a multi-ply fibrous structure 10 of the present invention, an example of which is illustrated in FIGS. 1 and 2, comprises the steps of:
a. making a first fibrous structure ply 12 comprising a laminate fibrous structure 18 as shown in FIGS. 4, 5A and 5B by associating a base fibrous structure 16, for example a wet laid fibrous structure, for example a wet laid fibrous structure comprising fibers 26, for example pulp fibers, such as wood pulp fibers, for example by winding a roll 34 of the base fibrous structure 16, with a low basis weight nonwoven web 14, for example a single-ply low basis weight nonwoven web, for example by unwinding a roll 34 of the low basis weight nonwoven web 14, wherein the low basis weight nonwoven web exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, and wherein the low basis weight nonwoven web 14 comprises a plurality of fibrous elements, for example, filaments 28 and/or fibers 26, comprising a hydroxyl polymer, for example a non-naturally occurring hydroxyl polymer, such as a non-water soluble hydroxyl polymer, for example spun cellulose filaments, for example regenerated cellulose filaments, such as lyocell filaments and/or rayon filaments;
b. providing a second fibrous structure ply 20 comprising a fibrous structure 22 of the present invention; and
c. associating, for example adhesively bonding, such as with an adhesive 24 from an adhesive source 25, for example plybonding, the first fibrous structure ply 12 with the second fibrous structure ply 20, wherein this step of associating my comprise unwinding a roll 34 of the first fibrous structure ply 12 and unwinding a roll 34 of the second fibrous structure ply 20 prior to associating the first and second fibrous structure plies 12, 20 to form the multi-ply fibrous structure 10.

In embodiments, the multi-ply fibrous structure 10 of the present invention is made such that the multi-ply fibrous structure 10 exhibits a caliper of greater than 20.0 mils as measured according to the Caliper Test Method and a CRT Capacity of greater than 15 g/g as measured according to the CRT Test Method is formed.

In another example, a multi-ply fibrous structure 10 of the present invention is made such that the multi-ply fibrous structure 10 exhibits a caliper of greater than 20.0 mils as measured according to the Caliper Test Method and a Plate Stiffness of less than 8.00 N*mm as measured according to the Plate Stiffness Test Method is formed.

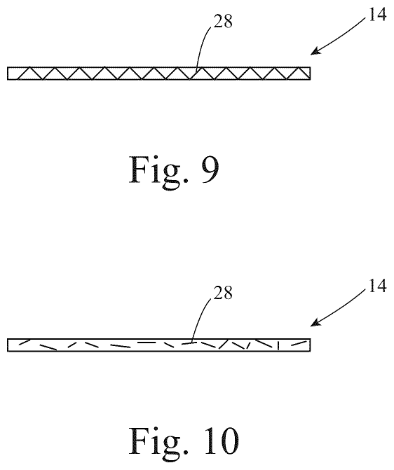

In another example of the present invention, a method for making a multi-ply fibrous structure fibrous structure 10 comprises the steps of:
a. providing a low basis weight nonwoven web 14, non-limiting examples of which are shown in FIGS. 9 and 10, for example a single-ply low basis weight nonwoven web, that exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, for example such a low basis weight nonwoven web 14 comprising a plurality of fibrous elements, for example filaments 28 (as shown in FIG. 9) and/or fibers 26 (as shown in FIG. 10) comprising a hydroxyl polymer, for example a non-naturally occurring hydroxyl polymer, for example a water-soluble hydroxyl polymer, such as a polyvinyl alcohol; and
b. associating (not shown), for example adhesively bonding, such as plybonding, the low basis weight nonwoven web 14 with a fibrous structure 22 (which forms a second fibrous structure ply 20 within the multi-ply fibrous structure 10) to form the multi-ply fibrous structure 10.

In even another example of the present invention, a method for making a multi-ply fibrous structure fibrous structure 10 comprises the steps of:
a. providing a low basis weight nonwoven web 14, non-limiting examples of which are shown in FIGS. 9 and 10, for example a single-ply low basis weight nonwoven web, that exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, for example such a low basis weight nonwoven web 14 comprising a plurality of fibrous elements, for example filaments 28 (as shown in FIG. 9) and/or fibers 26 (as shown in FIG. 10) comprising a hydroxyl polymer, for example a non-naturally occurring hydroxyl polymer, such as a non-water soluble hydroxyl polymer, for example spun cellulose filaments 28 and/or fibers 26, for example regenerated cellulose filaments 28 and/or fibers 26, such as lyocell filaments 28 and/or fibers 26 and/or rayon filaments 28 and/or fibers 26; and
b. associating (not shown), for example adhesively bonding, such as plybonding, the low basis weight nonwoven web 14 with a fibrous structure 22 (which forms a second fibrous structure ply 20 within the multi-ply fibrous structure 10) to form the multi-ply fibrous structure 10.

In yet another example of the present invention, a method for making a multi-ply fibrous structure fibrous structure 10 comprises the steps of:
a. providing a low basis weight nonwoven web 14, for example a single-ply low basis weight nonwoven web, that exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, for example such a low basis weight nonwoven web 14 comprising a plurality of fibrous elements, for example filaments and/or fibers, comprising a hydroxyl polymer, for example a non-naturally occurring hydroxyl polymer, for example a water-soluble hydroxyl polymer, such as a polyvinyl alcohol filaments and/or fibers; and
b. associating (not shown), for example adhesively bonding, such as plybonding, two or more plies of the low basis weight nonwoven web 14 to form the multi-ply fibrous structure 10.

In still another example of the present invention, a method for making a multi-ply fibrous structure 10 comprises the steps of:
a. providing a low basis weight nonwoven web 14, for example a single-ply low basis weight nonwoven web, that exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, for example such a low basis weight nonwoven web 14 comprising a plurality of fibrous elements comprising a hydroxyl polymer, for a non-naturally occurring hydroxyl polymer, such as a non-water soluble hydroxyl polymer, for example spun cellulose filaments 28 and/or fibers 26, for example regenerated cellulose filaments 28 and/or fibers 26, such as lyocell filaments 28 and/or fibers 26 and/or rayon filaments 28 and/or fibers 26; and
b. associating (not shown), for example adhesively bonding, such as plybonding, the low basis weight nonwoven web 14 with a fibrous structure 22 (which forms a second fibrous structure ply 20 within the multi-ply fibrous structure 10) to form the multi-ply fibrous structure 10.

In embodiments, the low basis weight nonwoven web 14 of the present invention, the laminate fibrous structure 18 (laminate fibrous structure ply) of the present invention and/or the fibrous structure 22 of the second fibrous structure ply 20 of the present invention and/or additional fibrous structures 22 of the present invention may individually be embossed, lotioned, surface softened, calendared, printed, microselfed, perforated, before, during and/or after association with one another.

In embodiments, the methods of the present invention may further comprise the step of winding the multi-ply fibrous structure 10 into a roll 34 of the multi-ply fibrous structure 10.

### Laminate Fibrous Structures

In embodiments, as shown in FIGS. 5A and 5B, the laminate fibrous structures 18 of the present invention, for example a single-ply laminate fibrous structures, comprise a base fibrous structure 16 (pre-formed base fibrous structure) associated with a low basis weight nonwoven web 14 (pre-formed low basis weight nonwoven web), for the example the low basis weight nonwoven web 14 may be associated with a surface of the base fibrous structure 16. In embodiments, the low basis weight nonwoven web 14 comprises a plurality of fibrous elements, for example filaments 28 and/or fibers 26, in this example filaments 28, such as hydroxyl polymer filaments, such as water-soluble hydroxyl filaments, for example polyvinyl alcohol filaments that exhibit an average fiber diameter of less than 4.5 μm as measured according to the Average Fiber Diameter Test Method described herein.

In embodiments, the base fibrous structure 16, for example a wet laid fibrous structure, for example a wet laid fibrous structure comprising fibers 26, for example pulp fibers, such as wood pulp fibers, comprises a plurality of fibrous elements, for example filaments 28 and/or fibers 26, in this example fibers 26. In embodiments, the base fibrous structure 16 comprises a wet laid fibrous structure, for example a wet laid fibrous structure comprising fibers 26, for example pulp fibers, such as wood pulp fibers.

Without wishing to be bound by theory, it is believed that the low basis weight nonwoven web 14 comprising a plurality of fibrous elements, for example filaments 28, such as polyvinyl alcohol filaments that exhibit an average fiber diameter of less than 2 μm as measured according to the Average Fiber Diameter Test Method described herein forms a low free fiber end exterior surface 35 as shown in FIGS. 5A and 5B because unlike in the past, the polyvinyl alcohol filaments exhibit a smaller fiber diameter for a given basis weight which means there is a higher number of contact or bond points between filaments 28 that form the low basis weight nonwoven web 14 which results in increased tensile strength and increased total energy absorbed of the nonwoven layer

In embodiments of the present invention, a laminate fibrous structure 18, for example a single-ply laminate fibrous structure, comprises a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14, for example a single-ply low basis weight nonwoven web comprising a plurality of fibrous elements, for example filaments 28, such as polyvinyl alcohol filaments exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein.

In another example of the present invention, a laminate fibrous structure 18, for example a single-ply laminate fibrous structure, comprises a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, wherein the low basis weight nonwoven web 14 comprises a plurality of hydroxyl polymer fibrous elements, for example filaments 28, for example a plurality of non-naturally occurring fibrous elements, for example a plurality of non-naturally occurring hydroxyl polymer filaments, for example a plurality of non-naturally occurring water-soluble hydroxyl polymer filaments, such as a plurality of polyvinyl alcohol filaments.

In another example of the present invention, a laminate fibrous structure 18, for example a single-ply laminate fibrous structure, comprises a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, wherein the low basis weight nonwoven web 14 comprises a plurality of hydroxyl polymer fibrous elements, for example fibers 26, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers.

In another example of the present invention, a laminate fibrous structure 18, for example a single-ply laminate fibrous structure, comprises a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, wherein the low basis weight nonwoven web 14 comprises a plurality of hydroxyl polymer fibrous elements, for example filaments 28, for example a plurality of non-naturally occurring fibrous elements, for example a plurality of non-naturally occurring hydroxyl polymer filaments, for example a plurality of non-naturally occurring water-soluble hydroxyl polymer filaments, such as a plurality of polyvinyl alcohol filaments that exhibit an average fiber diameter of less than 4.5 microns and/or less than 4.0 microns and/or less than 3.5 microns and/or less than 3.0 microns and/or to greater than 0.5 μm and/or to greater than 0.75 μm as measured according to the Average Fiber Diameter Test Method described herein.

In another example of the present invention, a laminate fibrous structure 18, for example a single-ply laminate fibrous structure, comprises a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, wherein the low basis weight nonwoven web 14 comprises a plurality of hydroxyl polymer fibrous elements, for example fibers 26, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers that exhibit an average fiber diameter of less than 4.5 microns and/or less than 4.0 microns and/or less than 3.5 microns and/or less than 3.0 microns and/or to greater than 0.5 μm and/or to greater than 0.75 μm as measured according to the Average Fiber Diameter Test Method described herein.

In another example of the present invention, a laminate fibrous structure 18, for example a single-ply laminate fibrous structure, comprises a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm as measured according to the Basis Weight Test Method described herein, for example wherein the low basis weight nonwoven web 14 comprises a plurality of hydroxyl polymer fibrous elements, for example fibers 26, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers, and wherein the laminate fibrous structure 18 exhibits a fail total energy absorption (TEA) of at least 12 g/in/gsm and/or at least 14 g/in/gsm and/or at least 16 g/in/gsm as measured according to the Tensile Test Method described herein.

In another example of the present invention, a laminate fibrous structure 18, for example a single-ply laminate fibrous structure, comprises a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm as measured according to the Basis Weight Test Method described herein and wherein the laminate fibrous structure 18 exhibits a fail total energy absorption (TEA) of at least 12 g/in/gsm and/or at least 14 g/in/gsm and/or at least 16 g/in/gsm as measured according to the Tensile Test Method described herein, wherein the low basis weight nonwoven web 14 comprises a plurality of hydroxyl polymer fibrous elements, for example filaments 28, for example a plurality of non-naturally occurring fibrous elements, for example a plurality of non-naturally occurring hydroxyl polymer filaments, for example a plurality of non-naturally occurring water-soluble hydroxyl polymer filaments, such as a plurality of polyvinyl alcohol filaments.

In another example of the present invention, a laminate fibrous structure 18, for example a single-ply laminate fibrous structure, comprises a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm as measured according to the Basis Weight Test Method described herein and wherein the laminate fibrous structure 18 exhibits a fail total energy absorption (TEA) of at least 12 g/in/gsm and/or at least 14 g/in/gsm and/or at least 16 g/in/gsm as measured according to the Tensile Test Method described herein, wherein the low basis weight nonwoven web 14 comprises a plurality of hydroxyl polymer fibrous elements, for example fibers 26, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers.

In another example of the present invention, a laminate fibrous structure 18, for example a single-ply laminate fibrous structure, comprises a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, for example wherein the low basis weight nonwoven web 14 comprises a plurality of hydroxyl polymer fibrous elements, for example fibers 26, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers, and wherein the laminate fibrous structure 18 exhibits a total dry tensile of greater than 75 g/in and/or greater than 100 g/in and/or greater than 150 g/in and/or greater than 200 g/in and/or greater than 300 g/in and/or greater than 400 g/in and/or greater than 500 g/in to less than 2000 g/in and/or to less than 1500 g/in and/or to less than 1000 g/in as measured according to the Tensile Test Method described herein.

In another example of the present invention, a laminate fibrous structure 18, for example a single-ply laminate fibrous structure, comprises a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the laminate fibrous structure 18 exhibits a total dry tensile of greater than 75 g/in and/or greater than 100 g/in and/or greater than 150 g/in and/or greater than 200 g/in and/or greater than 300 g/in and/or greater than 400 g/in and/or greater than 500 g/in to less than 2000 g/in and/or to less than 1500 g/in and/or to less than 1000 g/in as measured according to the Tensile Test Method described herein, wherein the low basis weight nonwoven web 14 comprises a plurality of hydroxyl polymer fibrous elements, for example filaments 28, for example a plurality of non-naturally occurring fibrous elements, for example a plurality of non-naturally occurring hydroxyl polymer filaments, for example a plurality of non-naturally occurring water-soluble hydroxyl polymer filaments, such as a plurality of polyvinyl alcohol filaments.

In another example of the present invention, a laminate fibrous structure 18, for example a single-ply laminate fibrous structure, comprises a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the laminate fibrous structure 18 exhibits a total dry tensile of greater than 75 g/in and/or greater than 100 g/in and/or greater than 150 g/in and/or greater than 200 g/in and/or greater than 300 g/in and/or greater than 400 g/in and/or greater than 500 g/in to less than 2000 g/in and/or to less than 1500 g/in and/or to less than 1000 g/in as measured according to the Tensile Test Method described herein, wherein the low basis weight nonwoven web 14 comprises a plurality of hydroxyl polymer fibrous elements, for example fibers 26, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers.

In another example of the present invention, a laminate fibrous structure 18, for example a single-ply laminate fibrous structure, comprises a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, for example wherein the low basis weight nonwoven web 14 comprises a plurality of hydroxyl polymer fibrous elements, for example fibers 26, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers, and wherein the laminate fibrous structure 18 exhibits a total dry tensile of less than 2000 g/in as measured according to the Tensile Test Method described herein.

In another example of the present invention, a laminate fibrous structure 18, for example a single-ply laminate fibrous structure, comprises a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the laminate fibrous structure 18 exhibits a total dry tensile of less than 2000 g/in as measured according to the Tensile Test Method described herein, wherein the low basis weight nonwoven web 14 comprises a plurality of hydroxyl polymer fibrous elements, for example filaments 28, for example a plurality non-naturally occurring fibrous elements, for example a plurality of non-naturally occurring hydroxyl polymer filaments, for example a plurality of non-naturally occurring water-soluble hydroxyl polymer filaments, such as a plurality of polyvinyl alcohol filaments.

In another example of the present invention, a laminate fibrous structure 18, for example a single-ply laminate fibrous structure, comprises a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the laminate fibrous structure 18 exhibits a total dry tensile of less than 2000 g/in as measured according to the Tensile Test Method described herein, wherein the low basis weight nonwoven web 14 comprises a plurality of hydroxyl polymer fibrous elements, for example fibers 26, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers.

In another example of the present invention, a laminate fibrous structure 18, for example a single-ply laminate fibrous structure, comprises a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, for example wherein the low basis weight nonwoven web 14 comprises a plurality of hydroxyl polymer fibrous elements, for example a plurality of non-naturally occurring fibrous elements, for example fibers 26, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers, and wherein the laminate fibrous structure 18 exhibits a TS7 of less than 20 dB V² rms and/or less than 15 dB V² rms and/or less than 12 dB V² rms and/or less than 10 dB V² rms and/or less than 8 dB V² rms and/or less than 6 dB V² rms and/or less than 4 dB V² rms as measured according to the Emtec Test Method described herein.

In another example of the present invention, a laminate fibrous structure 18, for example a single-ply laminate fibrous structure, comprises a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the laminate fibrous structure 18 exhibits a TS7 of less than 20 dB V² rms and/or less than 15 dB V² rms and/or less than 12 dB V² rms and/or less than 10 dB V² rms and/or less than 8 dB V² rms and/or less than 6 dB V² rms and/or less than 4 dB V² rms as measured according to the Emtec Test Method described herein, wherein the low basis weight nonwoven web 14 comprises a plurality of hydroxyl polymer fibrous elements, for example filaments 28, for example a plurality of non-naturally occurring fibrous elements, for example a plurality of non-naturally occurring hydroxyl polymer filaments, for example a plurality of non-naturally occurring water-soluble hydroxyl polymer filaments, such as a plurality of polyvinyl alcohol filaments.

In another example of the present invention, a laminate fibrous structure 18, for example a single-ply laminate fibrous structure, comprises a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the laminate fibrous structure 18 exhibits a TS7 of less than 20 dB V² rms and/or less than 15 dB V² rms and/or less than 12 dB V² rms and/or less than 10 dB V² rms and/or less than 8 dB V² rms and/or less than 6 dB V² rms and/or less than 4 dB V² rms as measured according to the Emtec Test Method described herein, wherein the low basis weight nonwoven web 14 comprises a plurality of hydroxyl polymer fibrous elements, for example fibers 26, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers.

In another example of the present invention, a laminate fibrous structure 18, for example a single-ply laminate fibrous structure, comprising a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the laminate fibrous structure 18 exhibits a Force Variability Value of less than 1.40 and/or less than 1.25 as measured according to the Glide on Skin Test Method described herein.

In another example of the present invention, a laminate fibrous structure 18, for example a single-ply laminate fibrous structure, comprising a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the laminate fibrous structure 18 exhibits a Force Variability Value of less than 1.40 and/or less than 1.25 as measured according to the Glide on Skin Test Method described herein, wherein the low basis weight nonwoven web 14 comprises a plurality of hydroxyl polymer fibrous elements, for example filaments 28, for example a plurality of non-naturally occurring fibrous elements, for example a plurality of non-naturally occurring hydroxyl polymer filaments, for example a plurality of non-naturally occurring water-soluble hydroxyl polymer filaments, such as a plurality of polyvinyl alcohol filaments is provided.

In another example of the present invention, a laminate fibrous structure 18, for example a single-ply laminate fibrous structure, comprising a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the laminate fibrous structure 18 exhibits a Force Variability Value of less than 1.40 and/or less than 1.25 as measured according to the Glide on Skin Test Method described herein, wherein the low basis weight nonwoven web 14 comprises a plurality of hydroxyl polymer fibrous elements, for example fibers 26, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers is provided.

In another example of the present invention, a laminate fibrous structure 18, for example a single-ply laminate fibrous structure, comprising a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the laminate fibrous structure 18 exhibits a Force to Drag Value of less than 100 and/or less than 90 as measured according to the Glide on Skin Test Method described herein.

In another example of the present invention, a laminate fibrous structure 18, for example a single-ply laminate fibrous structure, comprising a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the laminate fibrous structure 18 exhibits a Force to Drag Value of less than 100 and/or less than 90 as measured according to the Glide on Skin Test Method described herein, wherein the low basis weight nonwoven web 14 comprises a plurality of hydroxyl polymer fibrous elements, for example filaments 28, for example a plurality of non-naturally occurring fibrous elements, for example a plurality of non-naturally occurring hydroxyl polymer filaments, for example a plurality of non-naturally occurring water-soluble hydroxyl polymer filaments, such as a plurality of polyvinyl alcohol filaments.

In another example of the present invention, a laminate fibrous structure 18, for example a single-ply laminate fibrous structure, comprising a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure associated with a low basis weight nonwoven web 14 exhibiting a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and wherein the laminate fibrous structure 18 exhibits a Force to Drag Value of less than 100 and/or less than 90 as measured according to the Glide on Skin Test Method described herein, wherein the low basis weight nonwoven web 14 comprises a plurality of hydroxyl polymer fibrous elements, for example fibers 26, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers.

### Methods for Making Laminate Fibrous Structures

As shown in FIG. 4, in embodiments of the present invention, a method for making a laminate fibrous structure 18 (a laminate fibrous structure making process 36), for example a single-ply laminate fibrous structure, comprises the steps of:
a. providing a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure, for example a wet laid fibrous structure, such as a wet laid fibrous structure comprising fibers 26, for example pulp fibers, such as wood pulp fibers (the base fibrous structure 16 may be in roll 34 form and unwound during the method/process);
b. providing a low basis weight nonwoven web 14 that exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, for example such a low basis weight nonwoven web 14 comprising a plurality of fibrous elements comprising a hydroxyl polymer, for example filaments 28, for example a non-naturally occurring hydroxyl polymer, for example a water-soluble hydroxyl polymer, such as a polyvinyl alcohol (the low basis weight nonwoven web 14 may be in roll 34 form and unwound during the method/process); and
c. associating, for example thermally bonding using thermal bonding rolls 37, which may be patterned, the base fibrous structure 16 with the low basis weight nonwoven web 14 to form the laminate fibrous structure 18.

In another example of the present invention, a method for making a laminate fibrous structure 18 (a laminate fibrous structure making process 36), for example a single-ply laminate fibrous structure, comprises the steps of:
a. providing a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure, for example a wet laid fibrous structure, such as a wet laid fibrous structure comprising fibers 26, for example pulp fibers, such as wood pulp fibers (the base fibrous structure 16 may be in roll 34 form and unwound during the method/process);
b. providing a low basis weight nonwoven web 14 that exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, for example such a low basis weight nonwoven web comprising a plurality of fibrous elements comprising a hydroxyl polymer, for example fibers 26, for example a plurality of non-naturally occurring fibrous elements, for example a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers (the low basis weight nonwoven web 14 may be in roll 34 form and unwound during the method/process); and
c. associating, for example thermally bonding using thermal bonding rolls 37, which may be patterned, the base fibrous structure 16 with the low basis weight nonwoven web 14 to form the laminate fibrous structure 18.

In embodiments, the base fibrous structure 16 is associated with the low basis weight nonwoven web 14 by bonding the low basis weight nonwoven web 14 to the base fibrous structure 16, for example with bonds, such as thermal bonds, for example in a bond pattern having a bond area of greater than 1% to less than 30% and/or greater than 1.5% to less than 25% and/or greater than 2% to less than 20% and/or from about 2% to about 18% and/or from about 2.5% to about 15%.

In another example of the present invention, the methods for making a laminate fibrous structure 18 of the present invention may further comprise the step of winding the laminate fibrous structure 18 into a roll 34.

### Base Fibrous Structures

The base fibrous structures 16 of the present invention, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure, for example a wet laid fibrous structure, such as a wet laid fibrous structure may comprise a plurality of fibrous elements, for example a plurality of fibers 26, such as greater than 80% and/or greater than 90% and/or greater than 95% and/or greater than 98% and/or greater than 99% and/or 100% by weight of the base fibrous structure of the fibers 28.

The base fibrous structure 16 may comprise a plurality of naturally-occurring fibers, for example pulp fibers, such as wood pulp fibers (hardwood and/or softwood pulp fibers). In another example, the base fibrous structure 16 comprises a plurality of non-naturally occurring fibers (synthetic fibers), for example staple fibers, such as rayon, lyocell, nylon, polyester fibers, polycaprolactone fibers, polylactic acid fibers, polyhydroxyalkanoate fibers, and mixtures thereof. In another example, the base fibrous structure 16 comprises a mixture of naturally-occurring fibers, for example pulp fibers, such as wood pulp fibers (hardwood and/or softwood pulp fibers) and a plurality of non-naturally occurring fibers (synthetic fibers), for example staple fibers, such as rayon, lyocell, nylon, polyester fibers, polycaprolactone fibers, polylactic acid fibers, polyhydroxyalkanoate fibers, and mixtures thereof.

The base fibrous structure 16 may comprise a wet laid fibrous structure ply, such as a through-air-dried fibrous structure ply, for example an uncreped, through-air-dried fibrous structure ply and/or a creped, through-air-dried fibrous structure ply.

The base fibrous structure 16, for example a wet laid fibrous structure ply may exhibit substantially uniform density.

The base fibrous structure 16, for example a wet laid fibrous structure ply may exhibit differential density.

The base fibrous structure 16, for example a wet laid fibrous structure ply may comprise a surface pattern.

The base fibrous structure 16, for example a wet laid fibrous structure ply may comprise a conventional wet-pressed fibrous structure ply. The wet laid fibrous structure ply may comprise a fabric-creped fibrous structure ply. The wet laid fibrous structure ply may comprise a belt-creped fibrous structure ply.

The base fibrous structure 16 may comprise an air laid fibrous structure ply.

The base fibrous structure 16 of the present invention may comprise a surface softening agent or be void of a surface softening agent, such as silicones, quaternary ammonium compounds, lotions, and mixtures thereof. The base fibrous structure 16 may comprise a non-lotioned base fibrous structure.

The base fibrous structure 16 of the present invention may comprise trichome fibers or may be void of trichome fibers.

The base fibrous structure 16 of the present invention may comprise recycled fibers and/or virgin fibers.

### Patterned Molding Members

The base fibrous structure 16 of the present invention may be formed on a patterned molding member, for example a coarse through-air-drying fabric, such as an uncreped, through-air-drying (UCTAD) fabric, a patterned resin-containing molding member, a patterned roller, a patterned belt-creping molding member, a patterned fabric-creping molding member, another patterned papermaking clothing, that result in the base fibrous structure 16 of the present invention, for example the structured base fibrous structure of the present invention. The pattern molding member may comprise a non-random repeating pattern. The pattern molding member may comprise a resinous pattern.

The base fibrous structure 16 may comprise a textured surface, which results in a textured base fibrous structure of the present invention. The base fibrous structure 16 may comprise a surface comprising a three-dimensional (3D) pattern, for example a 3D pattern imparted to the base fibrous structure by a patterned molding member. The 3D pattern of the base fibrous structure may be water-resistant such that it remains even after exposure to water. Non-limiting examples of suitable patterned molding members include patterned felts, patterned forming wires, patterned rolls, patterned fabrics, and patterned belts utilized in conventional wet-pressed papermaking processes, air laid papermaking processes, and/or wet laid papermaking processes that produce 3D patterned base fibrous structure plies of the present invention. Other non-limiting examples of such patterned molding members include through-air-drying fabrics and through-air-drying belts utilized in through-air-drying papermaking processes that produce through-air-dried base fibrous structures, for example 3D patterned through-air dried base fibrous structures of the present invention.

The base fibrous structure 16 may comprise a 3D patterned base fibrous structure having a surface comprising a 3D pattern.

The base fibrous structure 16 may be made by any suitable method, such as wet laid, air laid, coform, hydroentangling, carding, meltblowing, spunbonding, and mixtures thereof. In embodiments, the method for making the base fibrous structure 16 of the present invention comprises the step of depositing a plurality of fibers 26 onto a collection device 42, such as a 3D patterned molding member such that a base fibrous structure 16 is formed.

A “reinforcing element” may be a desirable (but not necessary) element in some examples of the molding member, serving primarily to provide or facilitate integrity, stability, and durability of the molding member comprising, for example, a resinous material. The reinforcing element can be fluid-permeable or partially fluid-permeable, may have a variety of embodiments and weave patterns, and may comprise a variety of materials, such as, for example, a plurality of interwoven yarns (including Jacquard-type and the like woven patterns), a felt, a plastic, other suitable synthetic material, or any combination thereof.

A non-limiting example of a patterned molding member, in this case a through-air-drying belt, suitable for use in making a base fibrous structure 16 and/or fibrous structure 22 of the present invention comprises a continuous network knuckle formed by a resin arranged in a pattern, for example a non-random, repeating pattern supported on a support fabric comprising support fabric filaments. The continuous network knuckle of resin comprises deflection conduits into which portions of a base fibrous structure 16/fibrous structure 22 being made on the patterned molding member deflect thus imparting the pattern of the patterned molding member to the base fibrous structure 16/fibrous structure 22 resulting in a structured base fibrous structure/structured fibrous structure of the present invention. The deflected portions of the base fibrous structure 16/fibrous structure 22 result in pillows, for example lower density regions compared to other parts of the base fibrous structure 16/fibrous structure 22, within the structured base fibrous structure/structured fibrous structure. The continuous network knuckle, in this case, and other forms and/or shapes, discrete and/or continuous knuckles impart knuckles, for example higher density regions compared to other parts of the base fibrous structure 16/fibrous structure 22, such as pillows.

Alternatively, the patterned molding member, in this case a through-air-drying belt, suitable for use in making a base fibrous structure 16 and/or fibrous structure 22 of the present invention comprises discrete knuckles formed by a resin arranged in a pattern, for example a non-random, repeating pattern supported on a support fabric comprising support fabric filaments. The discrete knuckles of resin create a continuous network deflection conduit into which a portion of a base fibrous structure 16/fibrous structure 22 being made on the patterned molding member deflects thus imparting the pattern of the patterned molding member to the base fibrous structure 16/fibrous structure 22 resulting in a structured base fibrous structure/structured fibrous structure of the present invention. The deflected portion of the base fibrous structure 16/fibrous structure 22 result in a continuous network pillow, for example a lower density region compared to other parts (discrete knuckles) of the base fibrous structure 16/fibrous structure 22, within the structured base fibrous structure/structured fibrous structure. The discrete knuckles, in this case, and other forms and/or shapes impart knuckles, for example higher density regions compared to other parts of the base fibrous structure 16/fibrous structure 22, such as pillows.

In another example, the patterned molding member, in this case a through-air-drying belt, suitable for use in making a base fibrous structure 16 and/or fibrous structure 22 of the present invention comprises semi-continuous knuckles formed by a resin arranged in a pattern, for example a non-random, repeating pattern supported on a support fabric comprising support fabric filaments. The semi-continuous knuckles of resin create a semi-continuous deflection conduits into which a portion of a base fibrous structure 16/fibrous structure 22 being made on the patterned molding member deflects thus imparting the pattern of the patterned molding member to the base fibrous structure 16/fibrous structure 22 resulting in a structured base fibrous structure/structured fibrous structure of the present invention. The deflected portion of the base fibrous structure 16/fibrous structure 22 result in semi-continuous network pillows, for example a lower density regions compared to other parts (semi-continuous knuckles) of the base fibrous structure 16/fibrous structure 22, within the structured base fibrous structure/structured fibrous structure. The semi-continuous knuckles, in this case, and other forms and/or shapes impart knuckles, for example higher density regions compared to other parts of the base fibrous structure 16/fibrous structure 22, such as pillows.

In embodiments, the resin may be present on the support fabric 60 at a height of greater than 5.0 mils and/or greater than 7.0 mils and/or greater than 8.0 mils and/or greater than 10.0 mils and/or greater than 12.0 mils and/or greater than 13.0 mils and/or greater than 15.0 mils and/or greater than 17.0 mils and/or greater than 20.0 mils in order to define deflection conduits 60 that impart one or more pillows within a structured base fibrous structure that exhibit similar heights that result in the base fibrous structure 16 exhibiting thick, absorbent, and/or flexible properties of the present invention.

### Non-Limiting Examples of Making a Base Fibrous Structure/Fibrous Structure

The base fibrous structures 16/fibrous structures 22 of the present invention may individually and separately be made by any suitable fibrous structure making process, for example papermaking process, such as conventional wet press papermaking process, through-air-dried papermaking process, belt-creped papermaking process, fabric-creped papermaking process, creped papermaking process, uncreped papermaking process, coform process, and air laid process, so long as the base fibrous structure 16/fibrous structure 22 comprises a plurality of fibrous elements, for example a plurality of fibers. The process for making the base fibrous structure 16 and any fibrous structure 22 of the present invention may be the same or different. In embodiments, the base fibrous structure 16/fibrous structure 22 is made on a molding member of the present invention. The method may be a base fibrous structure 16/fibrous structure 22 making process that uses a cylindrical dryer such as a Yankee (a Yankee-process) or it may be a Yankeeless process as is used to make substantially uniform density and/or uncreped base fibrous structures. Alternatively, the base fibrous structures 16/fibrous structure 22 may be made by an air laid process and/or meltblown and/or spunbond processes and any combinations thereof so long as the base fibrous structures 16 of the present invention are made thereby.

In embodiments of a process and equipment for making a base fibrous structure 16/fibrous structure 22, for example a textured base fibrous structure/textured fibrous structure, for example a textured wet laid base fibrous structure/textured wet laid fibrous structure, such as a structured wet laid base fibrous structure/structured wet laid fibrous structure, for example a through-air-dried (TAD) wet laid fibrous structure, such as a three-dimensional (3D) patterned wet laid fibrous structure, for example a wet laid fibrous structure, such as a wet laid fibrous structure according to the present invention comprises supplying an aqueous dispersion of fibers (a fibrous furnish or fiber slurry) to a headbox which can be of any convenient design. From headbox 68 the aqueous dispersion of fibers is delivered to a first foraminous member which is typically a Fourdrinier wire, to produce an embryonic fibrous structure.

The first foraminous member may be supported by a breast roll and a plurality of return rolls of which only two are shown. Optional auxiliary units and/or devices commonly associated fibrous structure making machines and with the first foraminous member, but not shown, include forming boards, hydrofoils, vacuum boxes, tension rolls, support rolls, wire cleaning showers, and the like.

After the aqueous dispersion of fibers is deposited onto the first foraminous member, embryonic fibrous structure (embryonic web material) is formed, typically by the removal of a portion of the aqueous dispersing medium by techniques well known to those skilled in the art. Vacuum boxes, forming boards, hydrofoils, and the like are useful in effecting water removal. The embryonic fibrous structure may travel with the first foraminous member about return roll and is brought into contact with a patterned molding member, such as a 3D patterned through-air-drying belt. While in contact with the patterned molding member, the embryonic fibrous structure will be deflected, rearranged, and/or further dewatered.

The patterned molding member may be in the form of an endless belt. In this simplified representation, the patterned molding member passes around and about patterned molding member return rolls and impression nip roll and may travel in the direction indicated by directional arrow. Associated with patterned molding member, but not shown, may be various support rolls, other return rolls, cleaning means, drive means, and the like well-known to those skilled in the art that may be commonly used in base fibrous structure 16 making machines.

After the embryonic fibrous structure has been associated with the patterned molding member, fibers within the embryonic fibrous structure are deflected into pillows and/or pillow network present in the patterned molding member. In embodiments of this process step, there is essentially no water removal from the embryonic fibrous structure through the deflection conduits after the embryonic fibrous structure has been associated with the patterned molding member but prior to the deflecting of the fibers (portions of the base fibrous structure 16) into the deflection conduits. Further water removal from the embryonic fibrous structure can occur during and/or after the time the fibers are being deflected into the deflection conduits. Water removal from the embryonic fibrous structure may continue until the consistency of the embryonic fibrous structure associated with patterned molding member is increased to from about 25% to about 35%. Once this consistency of the embryonic fibrous structure is achieved, then the embryonic fibrous structure can be referred to as an intermediate fibrous structure. During the process of forming the embryonic fibrous structure, sufficient water may be removed, such as by a noncompressive process, from the embryonic fibrous structure before it becomes associated with the patterned molding member so that the consistency of the embryonic fibrous structure may be from about 10% to about 30%.

While applicants decline to be bound by any particular theory of operation, it appears that the deflection of the fibers in the embryonic fibrous structure and water removal from the embryonic fibrous structure begin essentially simultaneously. Embodiments can, however, be envisioned wherein deflection and water removal are sequential operations. Under the influence of the applied differential fluid pressure, for example, the fibers may be deflected into the deflection conduit with an attendant rearrangement of the fibers. Water removal may occur with a continued rearrangement of fibers. Deflection of the fibers, and of the embryonic fibrous structure, may cause an apparent increase in surface area of the embryonic fibrous structure. Further, the rearrangement of fibers may appear to cause a rearrangement in the spaces or capillaries existing between and/or among fibers.

It is believed that the rearrangement of the fibers can take one of two modes dependent on a number of factors such as, for example, fiber length. The free ends of longer fibers can be merely bent in the space defined by the deflection conduit while the opposite ends are restrained in the region of the ridges. Shorter fibers, on the other hand, can actually be transported from the region of the ridges into the deflection conduit (The fibers in the deflection conduits will also be rearranged relative to one another). Naturally, it is possible for both modes of rearrangement to occur simultaneously.

As noted, water removal occurs both during and after deflection; this water removal may result in a decrease in fiber mobility in the embryonic fibrous structure. This decrease in fiber mobility may tend to fix and/or freeze the fibers in place after they have been deflected and rearranged. Of course, the drying of the fibrous structure in a later step in the process of this invention serves to more firmly fix and/or freeze the fibers in position.

In addition to or an alternative to the above-described water removal and deflection method to create texture in a base fibrous structure 16, creping, microcreping, printing, rush transfer, wet transfer, fabric creping, belt creping or other similar processes that may also impart a texture and/or decorative pattern to a base fibrous structure 16, for example a textured base fibrous structure may be used.

Any convenient means conventionally known in the papermaking art can be used to dry the intermediate fibrous structure. Examples of such suitable drying process include subjecting the intermediate fibrous structure to conventional and/or flow-through dryers and/or Yankee dryers. In addition, other drying processes such as ultrasonics, capillary dewatering, IR drying, impingement air, and heated surfaces may be utilized.

In embodiments of a drying process, the intermediate fibrous structure in association with the patterned molding member passes around the patterned molding member return roll and travels in the direction indicated by directional arrow. The intermediate fibrous structure may first pass through an optional predryer. This predryer can be a conventional flow-through dryer (hot air dryer) well known to those skilled in the art. Optionally, the predryer can be a so-called capillary dewatering apparatus. In such an apparatus, the intermediate fibrous structure passes over a sector of a cylinder having preferential-capillary-size pores through its cylindrical-shaped porous cover. Optionally, the predryer can be a combination capillary dewatering apparatus and flow-through dryer. The quantity of water removed in the predryer may be controlled so that a predried fibrous structure exiting the predryer has a consistency of from about 30% to about 98%. The predried fibrous structure, which may still be associated with patterned molding member, may pass around another patterned molding member return roll as it travels to an impression nip roll. As the predried fibrous structure passes through the nip formed between impression nip roll and a surface of a Yankee dryer, the pattern formed by the top surface of the patterned molding member is impressed into the predried fibrous structure to form a base fibrous structure 16, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure, for example a wet laid fibrous structure, such as a wet laid fibrous structure. The base fibrous structure 16 can then be adhered to the surface of the Yankee dryer where it can be dried to a consistency of at least about 95%.

The base fibrous structure 16 can then be foreshortened by creping the base fibrous structure 16 with a creping blade to remove the base fibrous structure 16 from the surface of the Yankee dryer resulting in the production of a creped base fibrous structure in accordance with the present invention. As used herein, foreshortening refers to the reduction in length of a dry (having a consistency of at least about 90% and/or at least about 95%) fibrous structure which occurs when energy is applied to the dry fibrous structure in such a way that the length of the fibrous structure is reduced and the fibers in the fibrous structure are rearranged with an accompanying disruption of fiber-fiber bonds. Foreshortening can be accomplished in any of several well-known ways. One common method of foreshortening is creping. The creped base fibrous structure 100 may be used as is or it may be subjected to post processing steps such as calendaring, tuft generating operations, and/or embossing and/or converting to form a base fibrous structure 16.

### Low Basis Weight Nonwoven Webs

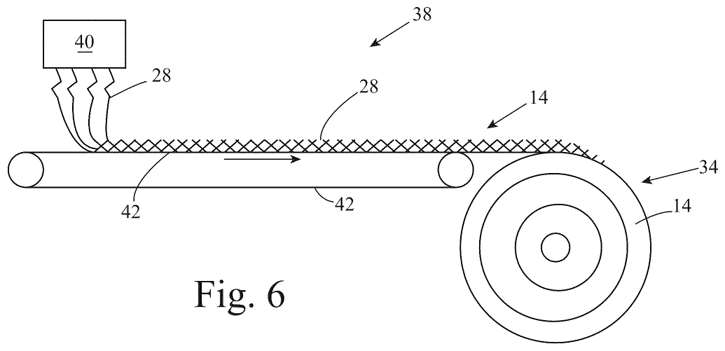

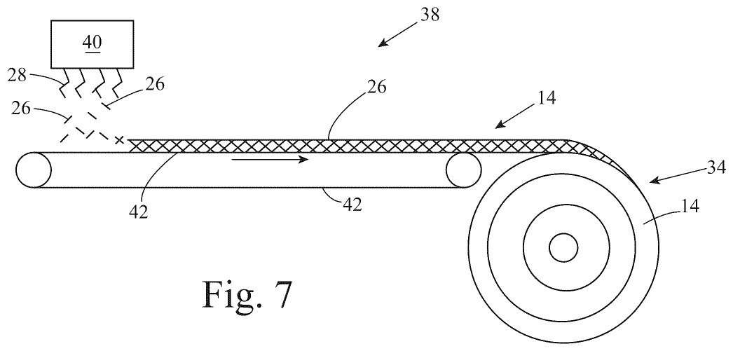

As shown in FIGS. 6 to 10, in embodiments of the present invention, the low basis weight nonwoven web 14 comprises a plurality of fibrous elements, for example filaments 28 as shown in FIGS. 6 and 9 and/or fibers 26 as shown in FIGS. 7, 8 and 9.

As shown in FIG. 9, in embodiments of the present invention, the low basis weight nonwoven web 14 comprises a plurality of filaments 28. The filaments 28 may comprise hydroxyl polymer filaments, such as water-soluble hydroxyl polymer filaments, for example polyvinyl alcohol filaments. In embodiments, the plurality of filaments 28 are inter-entangled. In another example, the plurality of filaments 28 are monocomponent filaments. In still another example, the plurality of filaments 28 comprises polyvinyl alcohol filaments.

In another example of the present invention, the low basis weight nonwoven web 14 comprises a plurality of filaments 28, for example hydroxyl polymer filaments, such as water-soluble hydroxyl polymer filaments, for example polyvinyl alcohol filaments, such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein.

In another example of the present invention, the low basis weight nonwoven web 14 comprises a plurality of filaments 28, for example hydroxyl polymer filaments, such as water-soluble hydroxyl polymer filaments, for example polyvinyl alcohol filaments, such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, and wherein the plurality of filaments 28 exhibit an average fiber diameter of less than 2 μm and/or less than 1.75 μm and/or less than 1.5 μm to greater than 0.5 μm and/or to greater than 0.75 μm as measured according to the Average Fiber Diameter Test Method described herein.

In another example of the present invention, the low basis weight nonwoven web 14 comprises a plurality of filaments 28, for example hydroxyl polymer filaments, such as water-soluble hydroxyl polymer filaments, for example polyvinyl alcohol filaments, such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and a fail total energy absorption (TEA) of at least 12 g/in/gsm and/or at least 14 g/in/gsm and/or at least 16 g/in/gsm as measured according to the Tensile Test Method described herein.

In another example of the present invention, the low basis weight nonwoven web 14 comprises a plurality of filaments 28, for example hydroxyl polymer filaments, such as water-soluble hydroxyl polymer filaments, for example polyvinyl alcohol filaments, such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and a total dry tensile of greater than 75 g/in and/or greater than 100 g/in and/or greater than 150 g/in and/or greater than 200 g/in and/or greater than 300 g/in and/or greater than 400 g/in and/or greater than 500 g/in to less than 2000 g/in and/or to less than 1500 g/in and/or to less than 1000 g/in as measured according to the Tensile Test Method described herein.

In yet another example of the present invention, the low basis weight nonwoven web 14 comprises a plurality of filaments 28, for example hydroxyl polymer filaments, such as water-soluble hydroxyl polymer filaments, for example polyvinyl alcohol filaments, such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and a total dry tensile of less than 2000 g/in as measured according to the Tensile Test Method described herein.

In another example of the present invention, the low basis weight nonwoven web 14 comprises a plurality of filaments 28, for example hydroxyl polymer filaments, such as water-soluble hydroxyl polymer filaments, for example polyvinyl alcohol filaments, such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and a TS7 of less than 20 dB V² rms and/or less than 15 dB V² rms and/or less than 12 dB V² rms and/or less than 10 dB V² rms and/or less than 8 dB V² rms and/or less than 6 dB V² rms and/or less than 4 dB V² rms as measured according to the Emtec Test Method described herein.

In still another example of the present invention, the low basis weight nonwoven web 14 comprises a plurality of filaments 28, for example hydroxyl polymer filaments, such as water-soluble hydroxyl polymer filaments, for example polyvinyl alcohol filaments, such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and a Force Variability Value of less than 1.40 and/or less than 1.25 as measured according to the Glide on Skin Test Method described herein.

In another example of the present invention, the low basis weight nonwoven web 14 comprises a plurality of filaments 28, for example hydroxyl polymer filaments, such as water-soluble hydroxyl polymer filaments, for example polyvinyl alcohol filaments, such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and a Force to Drag Value of less than 100 and/or less than 90 as measured according to the Glide on Skin Test Method described herein.

As shown in FIG. 10, in embodiments of the present invention, the low basis weight nonwoven web 14 comprises a plurality of fibers 26. The fibers 26 may comprise a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers hydroxyl polymer fibers. In embodiments, the fibers 26 may comprise polyvinyl alcohol fibers.

In another example of the present invention, the low basis weight nonwoven web comprises a plurality of fibers 26. The fibers 26 may comprise a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers hydroxyl polymer fibers, such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein.

In another example of the present invention, the low basis weight nonwoven web 14 comprises a plurality of fibers 26. The fibers 26 may comprise a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers hydroxyl polymer fibers, such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein, and wherein the plurality of fibers 26 exhibit an average fiber diameter of less than 2 μm and/or less than 1.75 μm and/or less than 1.5 μm to greater than 0.5 μm and/or to greater than 0.75 μm as measured according to the Average Fiber Diameter Test Method described herein.

In another example of the present invention, the low basis weight nonwoven web 14 comprises a plurality of fibers 26. The fibers 26 may comprise a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers hydroxyl polymer fibers, such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and a fail total energy absorption (TEA) of at least 12 g/in/gsm and/or at least 14 g/in/gsm and/or at least 16 g/in/gsm as measured according to the Tensile Test Method described herein.

In another example of the present invention, the low basis weight nonwoven web 14 comprises a plurality of fibers. The fibers 26 may comprise a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers hydroxyl polymer fibers, such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and a total dry tensile of greater than 75 g/in and/or greater than 100 g/in and/or greater than 150 g/in and/or greater than 200 g/in and/or greater than 300 g/in and/or greater than 400 g/in and/or greater than 500 g/in to less than 2000 g/in and/or to less than 1500 g/in and/or to less than 1000 g/in as measured according to the Tensile Test Method described herein.

In yet another example of the present invention, the low basis weight nonwoven web 14 comprises a plurality of fibers 26. The fibers 26 may comprise a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers hydroxyl polymer fibers, such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and a total dry tensile of less than 2000 g/in as measured according to the Tensile Test Method described herein.

In another example of the present invention, the low basis weight nonwoven web 14 comprises a plurality of fibers 26. The fibers 26 may comprise a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers hydroxyl polymer fibers, such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and a TS7 of less than 20 dB V² rms and/or less than 15 dB V² rms and/or less than 12 dB V² rms and/or less than 10 dB V² rms and/or less than 8 dB V² rms and/or less than 6 dB V² rms and/or less than 4 dB V² rms as measured according to the Emtec Test Method described herein.

In still another example of the present invention, the low basis weight nonwoven web 14 comprises a plurality of fibers 26. The fibers 26 may comprise a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers hydroxyl polymer fibers, such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and a Force Variability Value of less than 1.40 and/or less than 1.25 as measured according to the Glide on Skin Test Method described herein.

In another example of the present invention, the low basis weight nonwoven web 14 comprises a plurality of fibers 26. The fibers 26 may comprise a plurality of non-naturally occurring hydroxyl polymer fibers, for example a plurality of non-naturally occurring non-water soluble hydroxyl polymer fibers, such as a plurality of regenerated cellulose fibers, for example a plurality of rayon fibers and/or lyocell fibers hydroxyl polymer fibers, such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein and a Force to Drag Value of less than 100 and/or less than 90 as measured according to the Glide on Skin Test Method described herein.

In embodiments, the fibrous elements of the low basis weight nonwoven web 14 of the present invention may comprise a hydroxyl polymer, which may be a polysaccharide, such as a polysaccharide selected from the group consisting of: starch, starch derivatives, cellulose, cellulose derivatives, hemicellulose, hemicellulose derivatives, and mixtures thereof, more specifically cellulose, for example regenerated cellulose fibers such as lyocell and/or rayon.

In another example, the fibrous elements of the low basis weight nonwoven web 14 of the present invention may comprise a hydroxyl polymer comprising polyvinyl alcohol, for example polyvinyl alcohol filaments.

In still another example, the fibrous elements of the low basis weight nonwoven web 14 of the present invention may comprise two or more hydroxyl polymers selected from the group consisting of: polyvinyl alcohol, polysaccharides, such as polysaccharides selected from the group consisting of: starch, starch derivatives, cellulose derivatives, hemicellulose, and hemicellulose derivatives, and mixtures thereof, for example filaments comprising both polyvinyl alcohol and a polysaccharide selected from the group consisting of: starch, starch derivatives, cellulose derivatives, hemicellulose, and hemicellulose derivatives, and mixtures thereof, and/or both polyvinyl alcohol filaments and polysaccharide filaments, for example starch filaments.

In even another example, the fibrous elements of the low basis weight nonwoven web 14 of the present invention may comprise two or more different types of fibrous elements, for example filaments 28 and fibers 26.

In yet another example, the fibrous elements of the low basis weight nonwoven web 14 of the present invention may comprise one or more fibers 26, for example cellulose fibers, such as regenerated cellulose fibers, for example lyocell fibers and/or rayon fibers.

In embodiments, the low basis weight nonwoven web 14 of the present invention comprises polyvinyl alcohol filaments, for example greater than 50% and/or greater than 60% and/or greater than 70% and/or greater than 80% and/or greater than 90% and/or greater than 95% and/or greater than 99% to 100% by weight of polyvinyl alcohol filaments.

In embodiments, the low basis weight nonwoven web 14 of the present invention comprises cellulose fibers, for example regenerated cellulose fibers, such as lyocell fibers and/or rayon fibers, for example greater than 50% and/or greater than 60% and/or greater than 70% and/or greater than 80% and/or greater than 90% and/or greater than 95% and/or greater than 99% to 100% by weight of the cellulose fibers.

In embodiments, the low basis weight nonwoven web 14 of the present invention comprises water-soluble fibrous elements, for example water-soluble filaments such as polyvinyl alcohol filaments and/or non-cellulose containing filaments, such as starch and/or starch derivative filaments, for example greater than 50% and/or greater than 60% and/or greater than 70% and/or greater than 80% and/or greater than 90% and/or greater than 95% and/or greater than 99% to 100% by weight of water-soluble filaments.

In embodiments, the low basis weight nonwoven web 14 of the present invention comprises water-insoluble fibrous elements, for example water-insoluble fibers such as cellulose fibers, for example greater than 50% and/or greater than 60% and/or greater than 70% and/or greater than 80% and/or greater than 90% and/or greater than 95% and/or greater than 99% to 100% by weight of water-insoluble fibers.

In embodiments, the low basis weight nonwoven web 14 of the present invention comprises non-thermoplastic polymer fibrous elements, for example non-thermoplastic polyvinyl alcohol filaments and/or non-thermoplastic polysaccharide filaments and/or non-thermoplastic polyvinyl alcohol fibers and/or non-thermoplastic polysaccharide fibers, such as lyocell fibers and/or rayon fibers.

In embodiments, the fibrous elements of the low basis weight nonwoven web 14 may be produced from a polymer composition, for example a hydroxyl polymer composition such as an aqueous hydroxyl polymer composition, comprising a hydroxyl polymer, such as an uncrosslinked starch for example a dent corn starch, an acid-thinned starch, a waxy starch, and/or a starch derivative such as an ethoxylated starch, and/or polyvinyl alcohol, and optionally a crosslinking system comprising a crosslinking agent, such as an imidazolidinone, and water. The hydroxyl polymer may exhibit a weight average molecular weight in the range of 50,000 g/mol to 40,000,000 g/mol as measured according to the Weight Average Molecular Weight Test Method described herein. In embodiments, the crosslinking agent comprises less than 2% and/or less than 1.8% and/or less than 1.5% and/or less than 1.25% and/or 0% and/or about 0.25% and/or about 0.50% by weight of a base, for example triethanolamine.

The fibrous elements, for example filaments 28 and/or fibers 26 of the low basis weight nonwoven web 14 may exhibit an average fiber diameter of less than 50 μm and/or less than 25 μm and/or less than 20 μm and/or less than 15 μm and/or less than 10 μm and/or greater than 1 μm and/or greater than 3 μm and/or from about 3-10 μm and/or from about 3-8 μm and/or from about 5-7 μm as measured according to the Average Fiber Diameter Test Method described herein.

When present, the fibrous elements, for example polyvinyl alcohol filaments may exhibit smaller average fiber diameters, for example from about 1 to about 3 μm, than the polysaccharide filaments.

As mentioned previously, the fibrous elements, for example filaments 28 of the present invention may be produced from spinning a polymer composition. The polymer composition may have a temperature of from about 50 °C to about 100 °C and/or from about 65 °C to about 95 °C and/or from about 70 °C to about 90 °C when spinning fibrous elements, for example filaments 28 from the polymer composition that produce the fibrous elements, for example filaments 28 of the present invention.

The fibrous elements, for example filaments 28, such as polyvinyl alcohol filaments of the present invention may be attenuated during the spinning process to average fiber diameters of less than 2 μm and/or less than 1.5 and/or less than 1 and/or less than 0.5 μm average fiber diameter fibrous elements (filaments and/or fibers), with high humidity air streams (air jets), for example saturated air stream(s) of a flowrate of less than 1.5″ and/or less than 1.25″ and/or less than 1.0″ water column, that result in the fibrous elements bonding more upon forming of the low basis weight nonwoven web 14.

In embodiments, the polymer composition of the present invention may comprise from about 30% and/or from about 40% and/or from about 45% and/or from about 50% to about 75% and/or to about 80% and/or to about 85% and/or to about 90% and/or to about 95% and/or to about 99.5% by weight of the polymer composition of a fibrous element-forming polymer, such as a hydroxyl polymer. The fibrous element-forming polymer, such as a hydroxyl polymer, may have a weight average molecular weight greater than 100,000 g/mol.

### Hydroxyl Polymer

Non-limiting examples of suitable hydroxyl polymers include polyvinyl alcohol, polysaccharides, and mixtures thereof.

a. Polyvinyl Alcohol

Non-limiting examples of suitable polyvinyl alcohols, also referred to herein as vinyl acetate-vinyl alcohol copolymers, include vinyl acetate-vinyl alcohol copolymers that exhibit various degrees of hydrolysis, for example extremely high hydrolysis vinyl acetate-vinyl alcohol copolymers (average degree of at least 95 mol % and/or at least 97 mol % and/or at least 98 mol % and/or at least 99 mol % alcohol units (commonly referred to as “% hydrolyzed”), an example of which is Poval10-98 (98% hydrolyzed, Mw 50,000 g/mol) commercially available from Kuraray, high hydrolysis vinyl acetate-vinyl alcohol copolymers (average degree of at least 87 mol % and/or at least 89 mol % and/or at least 90 mol % to less than 95 mol % alcohol units, example of which is Selvol™ 523 (87-89% hydrolyzed, Mw 100,000 g/mol) commercially available from Sekisui Specialty Chemicals, and low hydrolysis vinyl acetate-vinyl alcohol copolymers (average degree of not more than 84 mol % and/or less than 84 mol % and/or less than 82 mol % and/or at least 99 mol % alcohol units.

As used herein, “vinyl acetate-vinyl alcohol copolymer” refers to a polymer of the following structure (I):

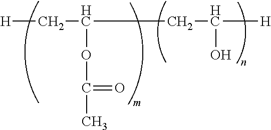

In structure (I), m and n are integers such that the copolymer has the degree of polymerization and percent alcohol characteristics described herein. For purposes of clarity, this use of the term “copolymer” is intended to convey that the partially hydrolyzed polyvinyl acetate of the present invention comprises vinyl alcohol and vinyl acetate units. As discussed below, the copolymer is routinely prepared by polymerizing vinyl acetate monomer followed by hydrolysis of some of the acetate groups to alcohol groups, as opposed to polymerization of vinyl acetate and vinyl alcohol monomer units (due in-part to the instability of vinyl alcohol).

The degree of polymerization (weight average molecular weight) of the fibrous element-forming polymer, for example the vinyl acetate-vinyl alcohol copolymer, is measured using gel permeation chromatography (GPC). This form of chromatography utilizes size exclusion. Separation occurs through a column packed with porous beads. Smaller analytes spend more time in the pores and thus pass through the column more slowly. A detector measures the amount of polymer in the elution solvent as it is eluted. Reference herein to the molecular weight of the copolymer is weighted average molecular weight (“Mw”). The Mw of the fibrous element-forming polymer, for example the vinyl acetate-vinyl alcohol copolymer, can vary widely, but in embodiments the fibrous element-forming polymer, for example vinyl acetate-vinyl alcohol copolymer, exhibits a Mw of greater than 10,000 g/mol and/or from about 20,000 g/mol to about 500,000 g/mol, in another example from about 40,000 g/mol to about 400,000 g/mol, in yet another example from about 60,000 g/mol to about 300,000 g/mol, and in still another example from about 70,000 g/mol to about 200,000 g/mol.

In embodiments, the fibrous elements of the present invention can be prepared by combining two or more vinyl acetate-vinyl alcohol copolymers described herein, wherein the vinyl acetate-vinyl alcohol copolymers differ with respect to either or both of their degree of polymerization and/or their degree of hydrolysis.

The benefits identified can be achieved by using one vinyl acetate-vinyl alcohol copolymer described herein, or it is possible to use two distinct vinyl acetate-vinyl alcohol copolymers.

The vinyl acetate-vinyl alcohol copolymers useful in the present invention are readily prepared using well known chemistry. One such method is the hydrolysis of a starting polyvinyl ester (polyvinyl acetate; formed via polymerization of vinyl acetate monomer units) of the desired degree of polymerization with absolute alcohols (e.g., methanol) in the presence of catalytic amounts of alkali (e.g., sodium methoxide). In the hydrolysis of polyvinyl acetate to vinyl acetate-vinyl alcohol copolymer, products with different alcohol group contents can be obtained depending on production conditions. Hydrolysis conditions influence the structure of the vinyl acetate-vinyl alcohol copolymer formed. By varying catalyst concentration, reaction temperature, and the reaction time, the content of residual acetyl groups (i.e., unhydrolyzed acetyl groups) can be adjusted routinely. See, for example, Polyvinyl Compounds, Others, Ullmann's Encyclopedia of Industrial Chemistry, Vol. 29, p. 605-609 (2000). Vinyl acetate-vinyl alcohol copolymers are also available commercially, e.g. from Kuraray Europe GmbH.

b. Cellulose

Non-limiting examples of cellulose polymers suitable for use in the fibrous elements of the present invention include regenerated cellulose, for example lyocell and/or rayon.

In embodiments, lyocell is made by dissolving wood pulp in an amine oxide solution. The viscous cellulose solution that results is then extruded into a dilute solution of amine oxide, which precipitates the regenerated cellulose, in this case lyocell, as a fibrous element, for example filament, which may then be cut into fibers, for example staple fibers.

In embodiments, lyocell is a regenerated cellulose material made by dissolving cellulose, for example cellulose in the form of wood pulp fibers, in a mixture of N-methylmorpholine-Noxide (NMMO) and water and extruding the resulting solution into a regenerating bath, usually water. Other solvents that may be used are other amine oxides, ionic liquids, mixtures of ionic liquids and water, and mixtures of ionic liquids and organic solvents. Lyocell is a generic term for a fiber composed of cellulose precipitated from an organic solution in which no substitution of hydroxyl groups takes place and no chemical intermediates are formed. Several manufacturers presently produce lyocell fibers. For example, Lenzing, Ltd, presently manufacturers and sells Tencel® fibers. Lyocell fibers are particularly suitable for use in nonwoven applications because of their characteristic soft feel, water absorption, microdiameter size, and biodegradability and/or compostability. Most lyocell fibers are produced from high quality wood pulps that have been extensively processed to remove non-cellulose components, especially hemicelluloses. These highly processed pulps are referred to as dissolving grade or high a (high alpha) pulps, in which the term a refers to the percentage of cellulose remaining after extraction with 17.5% caustic. Alpha cellulose can be determined by TAPPI 203. Thus a high a pulp contains a high percentage of cellulose, and a correspondingly low percentage of other components such as hemicelluloses. Typically, the cellulose for these high a pulps comes from both hardwoods and softwoods; softwoods generally having longer fibers than hardwoods. A lower cost alternative to high a dissolving grade pulps is a low a pulp having a higher percentage of hemicelluloses. These low a pulps have a low copper number, a low lignin content and a low transition metal content and a broad molecular weight distribution. Pulps which meet these requirements for low a pulps have been made and are described in U.S. Pat. Nos. 6,979,113, 6,686,093 and 6,706,876, assigned to the assignee of the present application.

In embodiments, the lyocell fibers suitable for use in the present invention are made from a pulp with greater than about 3% by weight hemicelluloses. In embodiments, the lyocell fibers contain from about 4 to about 18% by weight hemicelluloses as defined by the sum of the xylan and mannan content of the fibers.

In embodiments, the lyocell fibrous elements may comprise filaments, for example they may be continuous in length and/or may comprise fibers, for example they may be discontinuous in length, for example staple fibers that are cut from lyocell filaments.

In embodiments, the lyocell fibrous elements, for example lyocell fibers in the low basis weight nonwoven web of the present invention may exhibit an average fiber diameter of from 1 to 30 and/or 2 to 20 and/or 3 to 15 and/or 6 to 9 μm as measured according to the Average Fiber Diameter Test Method described herein.

In embodiments, rayon is made by reacting wood pulp fibers and/or wood pulp chips and/or cotton linters with sodium hydroxide to produce alkali cellulose. The alkali cellulose is then combined and churned with carbon disulfide to produce sodium cellulose xanthate. The sodium cellulose xanthate is then bathed in sodium hydroxide which produces a viscous solution. The viscous solution is then spun and/or extruded into an acid bath that coagulates and solidifies the viscous solution into fibrous elements, for example filaments.

Rayon and lyocell filaments may be cut to staple fiber lengths, for example from about 6 mm to about 150 mm and/or from about 10 mm to about 60 mm and/or from about 15 mm to about 45 mm.

### Methods for Making Low Basis Weight Nonwoven Web

Non-limiting examples of methods for making the low basis weight nonwoven web 14 of the present invention are shown in FIGS. 6-10.

In embodiments, as shown in FIG. 6, the low basis weight nonwoven web 14 of the present invention may be made by a low basis weight nonwoven web making process 38 shown in FIG. 6 by spinning a plurality of fibrous elements, for example filaments 28, for example hydroxyl polymer filaments, such as polyvinyl alcohol filaments and/or such as cellulose filaments, such as rayon and/or lyocell filaments, from one or more and/or two or more filament sources 40, such as a die, for example a meltblow die, such as a multi-row capillary meltblow die, and/or a spunbond die, to form a low basis weight nonwoven web 14 comprising a plurality of inter-entangled filaments 28.

In another example, as shown in FIG. 7, the low basis weight nonwoven web 14 of the present invention may be made by a low basis weight nonwoven web making process 38 shown in FIG. 7 by spinning a plurality of fibrous elements, for example filaments 28, for example hydroxyl polymer filaments, such as polyvinyl alcohol filaments and/or such as cellulose filaments, such as rayon and/or lyocell filaments, from one or more and/or two or more filament sources 40, such as a die, for example a meltblow die, such as a multi-row capillary meltblow die, and/or a spunbond die, and cutting the filaments 28 into a plurality of fibers 26, which are collected on a collection device 42 to form a low basis weight nonwoven web 14 comprising a plurality of fibers 26.

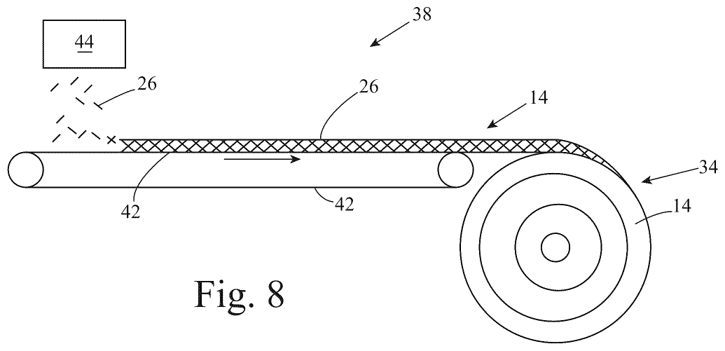

In yet another example, as shown in FIG. 8, the low basis weight nonwoven web 14 of the present invention may be made by a low basis weight nonwoven web making process 38 shown in FIG. 8 by depositing a plurality of fibrous elements, for example fibers 26, for example hydroxyl polymer fibers, such as polyvinyl alcohol fibers and/or such as cellulose fibers, such as rayon and/or lyocell fibers, from one or more and/or two or more fiber sources 44, such as air laid former, to form a low basis weight nonwoven web 14 comprising a plurality of fibers 26.

In even yet another example (not shown), the low basis weight nonwoven web 14 of the present invention may be made by a low basis weight nonwoven web making process 38 similar to that shown in FIG. 8, but where both filaments and fibers are commingled together, for example in a coforming process, and collecting the commingled filaments and fibers, for example hydroxyl polymer filaments and fibers, such as polyvinyl alcohol filaments and/or fibers and/or such as cellulose filaments and/or fibers, such as rayon and/or lyocell filaments and/or fibers, on a collection device 42 to form a low basis weight nonwoven web comprising a plurality of filaments and fibers.

The low basis weight nonwoven web making process 38 may further comprise the step of associating the filaments 28 and/or fibers 26, for example by bonds, such as thermal bonds to provide the low basis weight nonwoven web 14 with strength and integrity. The step of associating may comprise the step of passing the low basis weight nonwoven web 14 through a nip (not shown) formed by at least one thermal bond roll, for example a patterned thermal bond roll and a flat roll.

Further, the low basis weight nonwoven web making process 38 may optionally comprise the step of winding the low basis weight nonwoven web 14 into a roll 34, such as a parent roll. The roll 34 of the low basis weight nonwoven web 14 may be unwound in a converting operation for further processing and/or unwound in a laminate fibrous structure making process 36 as shown in FIG. 4.

Non-limiting examples of filaments 28 according to the present invention are produced by spinning a filament-forming composition, for example a filament-forming composition that is suitable for making filaments 28.

The filaments 28 may be collected on a collection device 42, such as a belt or fabric, in embodiments a belt or fabric capable of imparting a pattern, for example a non-random repeating pattern to a low basis weight nonwoven web 14 formed as a result of collecting the filaments 28 on the collection device 42, such as a belt or fabric.

In embodiments of the present invention as shown in FIG. 6, a method 38 for making a low basis weight nonwoven web 14, for example a single-ply low basis weight nonwoven web, comprises the steps of:
a. providing a polymer composition, for example a hydroxyl polymer composition comprising a hydroxyl polymer, for example a non-naturally occurring hydroxyl polymer, for example a water-soluble hydroxyl polymer, such as a polyvinyl alcohol;
b. spinning the polymer composition, for example from a filament source 40, such as a die, for example a meltblow die and/or a spunbond die, to form a plurality of filaments 28; and
c. collecting the plurality of filaments 28 on a collection device 42 to form a low basis weight nonwoven web 14 of the present invention as shown in FIG. 9, for example a single-ply low basis weight nonwoven web, for example such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein; and
d. optionally, winding the low basis weight nonwoven web 14, for example a single-ply low basis weight nonwoven web, convolutely about itself to form a roll 34 of the low basis weight nonwoven web 14.

In another example of the present invention as shown in FIG. 6, a method 38 for making a low basis weight nonwoven web 14, for example a single-ply low basis weight nonwoven web, comprises the steps of:
a. providing a polymer composition, for example a hydroxyl polymer composition comprising a hydroxyl polymer, for example a non-naturally occurring hydroxyl polymer, for example a non-water soluble hydroxyl polymer, such as cellulose, for example rayon and/or lyocell;
b. spinning the polymer composition, for example from a filament source 40, such as a die, for example a meltblow die and/or a spunbond die, to form a plurality of filaments 28; and
c. collecting the plurality of filaments 28 on a collection device 42 to form a low basis weight nonwoven web 14 of the present invention as shown in FIG. 9, for example a single-ply low basis weight nonwoven web, for example such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein; and
d. optionally, winding the low basis weight nonwoven web 14, for example a single-ply low basis weight nonwoven web, convolutely about itself to form a roll 34 of the low basis weight nonwoven web 14.

In another example of the present invention as shown in FIG. 7, a method for making a low basis weight nonwoven web 14, for example a single-ply low basis weight nonwoven web, comprises the steps of:
a. providing a polymer composition, for example a hydroxyl polymer composition comprising a hydroxyl polymer, for example a non-naturally occurring hydroxyl polymer, for example a water-soluble hydroxyl polymer, such as a polyvinyl alcohol;
b. spinning the polymer composition to form a one or more filaments 28;
c. cutting the one or more filaments 28 to form a plurality of fibers 26; and
d. collecting the plurality of fibers 26 on a collection device 42 as shown in FIG. 7 to form a low basis weight nonwoven web 14 of the present invention as shown in FIG. 10, for example a single-ply low basis weight nonwoven web, for example such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein; and
e. optionally, winding the low basis weight nonwoven web 14, for example a single-ply low basis weight nonwoven web, convolutely about itself to form a roll 34 of the low basis weight nonwoven web 14.

In yet another example of the present invention as shown in FIG. 7, a method for making a low basis weight nonwoven web 14, for example a single-ply low basis weight nonwoven web, comprises the steps of:
a. providing a polymer composition, for example a hydroxyl polymer composition comprising a hydroxyl polymer, for example a non-naturally occurring hydroxyl polymer, for example a non-water soluble hydroxyl polymer, such as cellulose, for example rayon and/or lyocell;
b. spinning the polymer composition to form one or more filaments 28;
c. cutting the one or more filaments 28 to form a plurality of fibers 26; and
d. collecting the plurality of fibers 26 on a collection device 42 as shown in FIG. 7 to form a low basis weight nonwoven web 14 of the present invention as shown in FIG. 10, for example a single-ply low basis weight nonwoven web, for example such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein; and
e. optionally, winding the low basis weight nonwoven web 14, for example a single-ply low basis weight nonwoven web, convolutely about itself to form a roll 34 of the low basis weight nonwoven web 14.

In even another example of the present invention as shown in FIG. 8, a method for making a low basis weight nonwoven web 14, for example a single-ply low basis weight nonwoven web, comprises the steps of:
a. providing a plurality of fibers 26, for example hydroxyl polymer fibers, for example non-naturally occurring hydroxyl polymer fibers, for example water-soluble hydroxyl polymer fibers, such as polyvinyl alcohol fibers; and
b. depositing the plurality of fibers 26, for example from one or more fiber sources 44, such as an air laid former, onto a collection device 42 as shown in FIG. 8 to form a low basis weight nonwoven web 14 of the present invention as shown in FIG. 10, for example a single-ply low basis weight nonwoven web, for example such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein; and
c. optionally, winding the low basis weight nonwoven web 14, for example a single-ply low basis weight nonwoven web, convolutely about itself to form a roll 34 of the low basis weight nonwoven web 14.

In even yet another example of the present invention as shown in FIG. 8, a method for making a low basis weight nonwoven web 14, for example a single-ply low basis weight nonwoven web, comprises the steps of:
a. providing a plurality of fibers 26, for example hydroxyl polymer fibers, for example non-naturally occurring hydroxyl polymer fibers, for example non-water-soluble hydroxyl polymer fibers, for example cellulose fibers, such as rayon and/or lyocell fibers; and
b. depositing the plurality of fibers 26, for example from one or more fiber sources 44, such as an air laid former, onto a collection device 42 as shown in FIG. 8 to form a low basis weight nonwoven web 14 of the present invention as shown in FIG. 10, for example a single-ply low basis weight nonwoven web, for example such that the low basis weight nonwoven web 14 exhibits a basis weight of less than 5 gsm and/or less than 4 gsm and/or less than 3 gsm and/or less than 2 gsm to greater than 0.25 gsm and/or to greater than 0.5 gsm and/or to greater than 0.75 gsm and/or to at least 1 gsm as measured according to the Basis Weight Test Method described herein; and
c. optionally, winding the low basis weight nonwoven web 14, for example a single-ply low basis weight nonwoven web, convolutely about itself to form a roll 34 of the low basis weight nonwoven web 14.

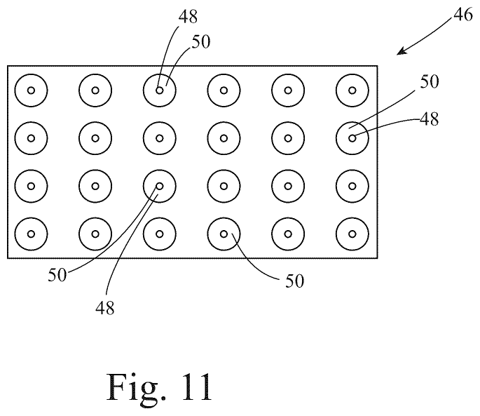

In embodiments, the spinning steps of the methods of the present invention may comprise spinning the polymer composition with a die, such as a multi-row capillary meltblow die and/or a knife edge meltblow die. In embodiments the spinning steps comprise spinning the polymer composition with an example of a multi-row capillary meltblow die 46 as shown in FIG. 11, which comprises a plurality of filament-forming holes 48 associated with one or more fluid releasing holes 50 that permit an attenuation fluid to exit the multi-row capillary meltblow die 46 substantially parallel to a polymer composition exiting a corresponding filament-forming hole 48 such that the polymer composition forms a filament 28. In another example, the spinning steps may comprise spinning the polymer composition with a spunbond die. The fibrous elements spun from the dies may be continuous, for example filaments, and/or discontinuous, for example fibers.

In embodiments, the methods of the present invention may further comprise the step of convolutely winding the low basis weight nonwoven web into a roll to form a roll of the low basis weight nonwoven web, for example a parent roll of the low basis weight nonwoven web.

In still another example, the methods of the present invention may be close coupled and/or direct coupled, such that after forming the low basis weight nonwoven web, the web is transferred to a subsequent operation such as combining with another fibrous structure, for example a wet laid fibrous structure.

In embodiments, the low basis weight nonwoven web of the present invention is formed from a plurality of hydroxyl polymer fibrous elements, for example filaments, which can be made unexpectedly by forming the low basis weight nonwoven web at a speed of less than 500 feet/minute (fpm) and/or less than 400 fpm and/or less than 300 fpm and/or less than 200 fpm to greater than 25 fpm and/or to greater than 50 fpm and/or to greater than 100 fpm and/or to greater than 125 fpm. To aid in the release of the low basis weight nonwoven web from a collection device, for example a belt, if one is present, upon which the low basis weight nonwoven web may be formed, any vacuum that functions to assist in drawing the fibrous elements, for example filaments, of the low basis weight nonwoven web onto a surface of the collection device is operated at conditions, for example vacuum air at less than 400 SCFM that do not inhibit the release of the low basis weight nonwoven web from the collection device and that do not damage the low basis weight nonwoven web by creating holes and/or other defects in the low basis weight nonwoven web during formation and optionally winding of the low basis weight nonwoven web into the form of a convolutely wound roll.

### COMPARATIVE EXAMPLE

A typical nonwoven web of melt blown polyvinyl alcohol filaments has a basis weight of 30 gsm and is composed of individual filaments that have an average fiber diameter of roughly 20 microns. Normalized to basis weight, the resulting web has a MD fail total energy absorbed (TEA) of 5 g/in per gsm. The relatively low TEA per gsm is because there are few fibers and fiber-to-fiber contacts. A basis weight of 30 gsm is required to make a product with sufficient mechanical properties to compensate for the low density of fiber-to-fiber contacts between the 20 micron diameter filaments. Consequently, without sufficient basis weight, the MD fail TEA is not high enough to withstand the forces of the winding and unwinding steps during web processing and handling which results in web loss.

### Non-Limiting Examples of Making a Low Basis Weight Nonwoven Web

### Example 1A—Polyvinyl Alcohol Low Basis Weight Nonwoven Web

A 1.5 gsm polyvinyl alcohol low basis weight nonwoven web according to the present invention is formed as follows.

6 kg of Poval10-98 polyvinyl alcohol (98% hydrolysis Kuraray), which has a weight average molecular weight of 50,000 g/mol, and 12 kg of water are added into a scraped, wall pressure vessel equipped with an overhead agitator in order to target a 33 wt % polyvinyl alcohol aqueous polymer composition. The 33 wt % polyvinyl alcohol aqueous polymer composition is then cooked under pressure at 240 °F for 4 hours until the resulting polyvinyl alcohol aqueous polymer composition is homogenous and transparent. The polyvinyl alcohol aqueous polymer composition is then pumped via a gear pump to a die, such as a meltblow die, for example a Biax-Fiberfilm Corporation multi-row capillary meltblow die.

Next, a method according to the present invention, for example as shown in FIG. 6, is used to form a plurality of polyvinyl alcohol filaments by spinning and optionally attenuating with a saturated air stream (about 150 °F and 1.8 psi), drying with high temperature air flow (about 450° F.) the polyvinyl alcohol filaments, and depositing the filaments onto a collection device, for example a belt, with vacuum air (about 350 SCFM) assisting with collecting the filaments onto the collection device. The collection device (belt) speed is about 175 feet per minute (fpm). The vacuum air is controlled to less than 400 SCFM by varying the fan speed in order to form the polyvinyl alcohol low basis weight nonwoven web of the present invention, for example as shown in FIG. 9, and to ensure satisfactory release of the polyvinyl alcohol low basis weight nonwoven web from the collection device and enable satisfactory winding into a roll, for example a parent roll, of the polyvinyl alcohol low basis weight nonwoven web. To facilitate satisfactory winding of and unwinding from the polyvinyl alcohol low basis weight nonwoven web parent roll, both the collection device (belt) and the polyvinyl alcohol low basis weight nonwoven web should be free from defects such as holes, spitters, or loose fiber edges. The resulting low basis weight polyvinyl alcohol web has a basis weight of 1.5 gsm and consists of filaments with an average fiber diameter of less than 4.5 microns. The small diameter filaments result in a relatively higher density of fiber-to-fiber contacts for a given basis weights compared to the Comparative Example which increases the MD total energy absorbed (TEA) properties of the web. Particularly, the normalized MD total energy absorbed (TEA) of the web is 13/g/in per gsm. Next, the polyvinyl alcohol low basis weight nonwoven web may then be wound into a roll, for example a parent roll, to form a polyvinyl alcohol low basis weight nonwoven web parent roll without web breaks and web losses due to the higher MD fail TEA per gsm.

### Example 1B—Polyvinyl Alcohol Low Basis Weight Nonwoven Web

A 1.5 gsm polyvinyl alcohol low basis weight nonwoven web according to the present invention is formed as follows.

6 kg of Poval10-98 polyvinyl alcohol (98% hydrolysis Kuraray), which has a weight average molecular weight of 50,000 g/mol, and 12 kg of water are added into a scraped, wall pressure vessel equipped with an overhead agitator in order to target a 33 wt % polyvinyl alcohol aqueous polymer composition. The 33 wt % polyvinyl alcohol aqueous polymer composition is then cooked under pressure at 240 °F for 4 hours until the resulting polyvinyl alcohol aqueous polymer composition is homogenous and transparent. The polyvinyl alcohol aqueous polymer composition is then pumped via a gear pump to a die, such as a meltblow die, for example a Biax-Fiberfilm Corporation multi-row capillary meltblow die.

Next, a method according to the present invention, for example as shown in FIG. 7, is used to form a plurality of polyvinyl alcohol filaments by spinning and optionally attenuating with a saturated air stream (about 150 °F and 1.8 psi), and drying with high temperature air flow (about 450 °F) the polyvinyl alcohol filaments. The resulting low basis weight polyvinyl alcohol web has a basis weight between 1.5 gsm and 2 gsm and consists of filaments with an average fiber diameter of less than 4.5 microns. The MD total energy absorbed (TEA) of the web is 13/g/in/gsm. The filaments are then cut into a plurality of fibers and then the fibers are deposited onto a collection device, for example a belt, with vacuum air (about 350 SCFM) assisting with collecting the fibers onto the collection device. The collection device (belt) speed is about 175 feet per minute (fpm). The vacuum air is controlled to less than 400 SCFM by varying the fan speed in order to form the polyvinyl alcohol low basis weight nonwoven web of the present invention, for example as shown in FIG. 10, and to ensure satisfactory release of the polyvinyl alcohol low basis weight nonwoven web from the collection device and enable satisfactory winding into a roll, for example a parent roll, of the polyvinyl alcohol low basis weight nonwoven web. To facilitate satisfactory winding of and unwinding from the polyvinyl alcohol low basis weight nonwoven web parent roll, both the collection device (belt) and the polyvinyl alcohol low basis weight nonwoven web should be free from defects such as holes, spitters, or loose fiber edges. Next, the polyvinyl alcohol low basis weight nonwoven web may then be wound into a roll, for example a parent roll, to form a polyvinyl alcohol low basis weight nonwoven web parent roll without web breaks and web losses due to the higher MD fail TEA per gsm.

### Example 1C—Polyvinyl Alcohol Low Basis Weight Nonwoven Web

A 1.5 gsm polyvinyl alcohol low basis weight nonwoven web according to the present invention is formed as follows.

A plurality of polyvinyl alcohol fibers are deposited, for example by a process as shown in FIG. 8, onto a collection device, for example a belt, with vacuum air (about 350 SCFM) assisting with collecting the fibers onto the collection device. The collection device (belt) speed is about 175 feet per minute (fpm). The vacuum air is controlled to less than 400 SCFM by varying the fan speed in order to form the polyvinyl alcohol low basis weight nonwoven web of the present invention, for example as shown in FIG. 10, and to ensure satisfactory release of the polyvinyl alcohol low basis weight nonwoven web from the collection device and enable satisfactory winding into a roll, for example a parent roll, of the polyvinyl alcohol low basis weight nonwoven web. To facilitate satisfactory winding of and unwinding from the polyvinyl alcohol low basis weight nonwoven web parent roll, both the collection device (belt) and the polyvinyl alcohol low basis weight nonwoven web should be free from defects such as loose fiber edges. Next, the polyvinyl alcohol low basis weight nonwoven web may then be wound into a roll, for example a parent roll, to form a polyvinyl alcohol low basis weight nonwoven web parent roll.

### Example 2A—Lyocell Low Basis Weight Nonwoven Web

A 2.0 gsm lyocell low basis weight nonwoven web according to the present invention is formed as follows.

Peach® pulp, available from Weyerhaeuser Company, is dissolved in NMMO to prepare a solution of from about 8 to about 15% by weight level of cellulose in NMMO. Next, a method according to the present invention, for example as shown in FIG. 6, the solution is then spun via a die, for example a meltblow die, such as a Biax-Fiberfilm Corporation 12.7 cm multi-row capillary die (20 holes/cm), at a temperature of about 220 °F to produce a plurality of lyocell filaments (average fiber diameters of about 5 μm as measured according to the Average Fiber Diameter Test Method described herein). While the lyocell filaments are attenuated with an air stream at 450 m/hour and 280 °F, water is sprayed on the lyocell filaments between the die, for example the meltblow die, and a collection device, for example belt, (collection device (belt) speed of from about 5 to about 20 fpm) upon which the filaments are collected and form a precursor lyocell nonwoven web. The precursor lyocell low basis weight nonwoven web is then washed by spraying water using several beams of spray nozzles. After this last washing, the washed lyocell low basis weight nonwoven web is then passed through a squeeze roll to remove water to a solid content of about 9% resulting in a lyocell low basis weight nonwoven web according to the present invention, for example as shown in FIG. 9. Next, the lyocell low basis weight nonwoven web may then be wound into a roll, for example a parent roll, to form a lyocell low basis weight nonwoven web parent roll.

### Example 2B—Lyocell Low Basis Weight Nonwoven Web

A 2.0 gsm lyocell low basis weight nonwoven web according to the present invention is formed as follows.

Peach® pulp, available from Weyerhaeuser Company, is dissolved in NMMO to prepare a solution of from about 8 to about 15% by weight level of cellulose in NMMO. Next, a method according to the present invention, for example as shown in FIG. 7, is used to spin the solution via a die, for example a meltblow die, such as a Biax-Fiberfilm Corporation 12.7 cm multi-row capillary die (20 holes/cm), at a temperature of about 220 °F to produce a plurality of lyocell filaments (average fiber diameters of about 5 μm as measured according to the Average Fiber Diameter Test Method described herein). While the lyocell filaments are attenuated with an air stream at 450 m/hour and 280 °F, water is sprayed on the lyocell filaments between the die, for example the meltblow die, and a collection device, for example belt, (collection device (belt) speed of from about 5 to about 20 fpm). The filaments are then cut into a plurality of fibers. The fibers are then deposited onto the collection device to form a precursor lyocell low basis weight nonwoven web. The precursor lyocell low basis weight nonwoven web is then washed by spraying water using several beams of spray nozzles. After this last washing, the washed lyocell low basis weight nonwoven web is then passed through a squeeze roll to remove water to a solid content of about 9% resulting in a lyocell low basis weight nonwoven web according to the present invention, for example as shown in FIG. 10. Next, the lyocell low basis weight nonwoven web may then be wound into a roll, for example a parent roll, to form a lyocell low basis weight nonwoven web parent roll.

### Example 2C—Lyocell Low Basis Weight Nonwoven Web

A 2.0 gsm lyocell low basis weight nonwoven web according to the present invention is formed as follows.

A plurality of lyocell fibers are deposited, for example by a process as shown in FIG. 8, onto a collection device, for example a belt, with vacuum air (about 350 SCFM) assisting with collecting the fibers onto the collection device. The collection device (belt) speed is about 175 feet per minute (fpm). The vacuum air is controlled to less than 400 SCFM by varying the fan speed in order to form the lyocell low basis weight nonwoven web of the present invention, for example as shown in FIG. 10, and to ensure satisfactory release of the lyocell low basis weight nonwoven web from the collection device and enable satisfactory winding into a roll, for example a parent roll, of the lyocell low basis weight nonwoven web. To facilitate satisfactory winding of and unwinding from the lyocell low basis weight nonwoven web parent roll, both the collection device (belt) and the lyocell low basis weight nonwoven web should be free from defects such as loose fiber edges. Next, the lyocell low basis weight nonwoven web may then be wound into a roll, for example a parent roll, to form a lyocell low basis weight nonwoven web parent roll.

### Example 3—Laminate Fibrous Structure

A laminate fibrous structure according to the present invention is formed as follows.

A base fibrous structure, for example a textured base fibrous structure, for example a textured wet laid base fibrous structure, such as a structured wet laid base fibrous structure, for example a through-air-dried (TAD) wet laid fibrous structure, such as a three-dimensional (3D) patterned wet laid fibrous structure comprising a plurality of pulp fibers, is associated, for example adhesively associated, with a low basis weight nonwoven web, for example a polyvinyl alcohol low basis weight nonwoven web from one of Examples 1A-1C, or a lyocell low basis weight nonwoven web from one of Examples 2A-2C, by a process, for example by a process as shown in FIG. 4, to form a laminate fibrous structure according to the present invention, for example a laminate fibrous structure as shown in FIG. 5A or 5B. Next, the laminate fibrous structure may then be wound into a roll, for example a parent roll, to form a laminate fibrous structure parent roll.

### Example 4A—Multi-Ply Fibrous Structure

A first ply comprising a laminate fibrous structure, for example the laminate fibrous structure of Example 3, is associated, for example adhesively bonded, with a second ply, for example a wet-laid fibrous structure, such as a structured wet-laid fibrous structure comprising a plurality of pulp fibers to form a multi-ply fibrous structure according to the present invention, for example a multi-ply fibrous structure as shown in FIGS. 1 and 2, using a process, for example the process/method shown in FIG. 3. Next, the multi-ply fibrous structure may then be wound into a roll to form a multi-ply fibrous structure roll and/or may be converted into finished sanitary tissue products.

### Example 4B—Multi-Ply Fibrous Structure

A first ply comprising a polyvinyl alcohol low basis weight nonwoven web, for example a polyvinyl alcohol low basis weight nonwoven web from Examples 1A-1C, and/or a lyocell low basis weight nonwoven web, for example a lyocell low basis weight nonwoven web from Examples 2A-2C, is associated, for example adhesively bonded, with a second ply, for example a wet-laid fibrous structure, such as a structured wet-laid fibrous structure comprising a plurality of pulp fibers to form a multi-ply fibrous structure according to the present invention. Next, the multi-ply fibrous structure may then be wound into a roll to form a multi-ply fibrous structure roll and/or may be converted into finished sanitary tissue products.

### Test Methods

Unless otherwise specified, all tests described herein including those described under the Definitions section and the following test methods are conducted on samples that have been conditioned in a conditioned room at a temperature of 23 °C±1.0 °C and a relative humidity of 50%±2% for a minimum of 24 hours prior to the test. All plastic and paper board packaging articles of manufacture, if any, must be carefully removed from the samples prior to testing. The samples tested are “usable units.”. “Usable units” as used herein means sheets, flats from roll stock, pre-converted flats, fibrous structure, and/or single or multi-ply products. Except where noted all tests are conducted in such conditioned room, all tests are conducted under the same environmental conditions and in such conditioned room. Discard any damaged product. Do not test samples that have defects such as wrinkles, tears, holes, and like. All instruments are calibrated according to manufacturer's specifications.

### Basis Weight Test Method

Basis weight of a fibrous structure is measured on stacks of twelve usable units using a top loading analytical balance with a resolution of ±0.001 g. The balance is protected from air drafts and other disturbances using a draft shield. A precision cutting die, measuring 8.890 cm±0.00889 cm by 8.890 cm±0.00889 cm is used to prepare all samples.

With a precision cutting die, cut the samples into squares. Combine the cut squares to form a stack twelve samples thick. Measure the mass of the sample stack and record the result to the nearest 0.001 g.

The Basis Weight is calculated in g/m² as follows:

Basis Weight=(Mass of stack)/[(Area of 1 square in stack)×(No. of squares in stack)]

Basis Weight (g/m²)=Mass of stack (g)/[79.032 (cm²)/10,000 (cm²/m²)×12]

Report result to the nearest 0.1 g/m². Sample dimensions can be changed or varied using a similar precision cutter as mentioned above, so as at least 645 square centimeters of sample area is in the stack.

### Surface Average Fiber Diameter Test Method

The Surface Average Fiber Diameter Test Method measures the average fiber diameter of filaments of a surface material and/or present on a surface of a fibrous structure.

Apparatus:

| | |
|---|---|
| SEM | Quanta 450 FEG Scanning Electron Microscope |
| | or similar |
| Commercial Software | MIPAR Image Analysis Software version 3.3.4 |

### Sample Preparation:

### Sample Preparation for Generating SEM Image:

A 2 inch×1.5 inch sample of a fibrous structure to be tested is cut, if necessary, from a fibrous structure. The sample is placed with the surface to be measured (the surface comprising the surface material, for example hydroxyl polymer filaments, to be measured) facing up on an SEM planchet with carbon double sided tape. The planchet is placed in a Denton sputter coater (or equivalent) for Au or Au/Pd coating, approximately 2 minutes using rotation to obtain an Au or Au/Pd coated sample.

Another sample preparation can be used to obtain the data, especially with fibrous structure that comprise a high basis weight of hydroxyl polymer filaments. This sample preparation utilizes tape stripping of the surface of the fibrous structure to be measured from a 2 inch×1.5 inch sample of the fibrous structure. The tape stripped sample with the surface to be measured (the surface comprising the surface material, for example hydroxyl polymer filaments, to be measured) facing up on an SEM planchet with carbon double sided tape. The planchet is placed in a Denton sputter coater (or equivalent) for Au or Au/Pd coating, approximately 2 minutes using rotation to obtain an Au or Au/Pd coated sample. The use of this sample preparation for this Surface Average Fiber Diameter Test Method can be referred to as the Tape Stripping Surface Average Fiber Diameter Test Method.

### Operation

### Generation of SEM Image:

The coated sample is placed in the chamber of the SEM under high vacuum for imaging. Imaging is done at 3-5 kV accelerating voltage using the SE detector. Multiple images are obtained at 500× magnification and saved as .tif files for further analysis. If desired, the SEM measurement tool can be used to validate the scale bar at the bottom of the image. Image details in the data bar can include horizontal field width, magnification and scale bar along with additional parameters of the microscope.

A total number of ten sample images were collected and processed for each fibrous structure tested. In this case the average fiber diameter data generated represent an average of the ten images.

Method Procedure for Determining Fiber Diameter Distribution Using MIPAR from Multiple SEM Images (n=10)
1. Launch MIPAR
   Launch ‘Batch Processor’
2. Load Recipe
   Drag and drop provided recipe into the recipe panel
   Open recipe by selecting ‘Load Recipe’
3. Load Image
   Drag and drop images into the image panel
   Open image by selecting ‘Add’
4. Set Session
   Select ‘Set Save Location’ to select a directory to save results to
   Edit the ‘Session Name’ field with a meaningful name, such as sample name and date
5. Process
   Select ‘Process’
   Wait for processing to complete
6. View Results
   Select ‘View Results’ this will launch the Post Processor with your session automatically loaded
7. Generate Measurements
   Select ‘Measure Features’ in the measurements panel
   Check ‘Caliper Diameter’
   Select ‘View Measurement’
   Only check ‘Fiber Thickness’
8. Export Measurement
   MIPAR will generate a table of all images, and all fiber diameters.
   Select ‘Export’ to save date as CSV to open in Excel

Manual adjustments in sensitivity and corrections are performed after image processing, if necessary, for example if the image exhibits lower fiber contrast to the background and/or if there is background noise during segmentation.

The processed images are used to generate fiber diameter distribution of these samples by calculating the average fiber diameter of filaments of less than 4.0 μm from the images.

In addition, from the data generated, the amount (frequency) of fibers having fiber diameters with “buckets” of fiber diameter ranges (0.5-1.0 μm, 1.0-1.5 μm, and 1.5-2.0 μm) can be determined, which can also be shown in a histogram produced from the data.

For the present invention, in embodiments of the present invention, the fibrous structure may comprise a surface and/or surface material comprising filaments, for example hydroxyl polymer filaments, such as polyvinyl alcohol filaments, at a frequency of greater than 8000 and/or greater than 9000 and/or greater than 10000 and/or greater than 11000 and/or greater than 12000 and/or greater than 13000 and/or greater than 14000 and/or greater than 15000 in the 0.5-1.0 μm “bucket”.

In another example of the present invention, the fibrous structure may comprise a surface and/or surface material comprising filaments, for example hydroxyl polymer filaments, such as polyvinyl alcohol filaments, at a frequency of greater than 5500 and/or greater than 6000 and/or greater than 7000 and/or greater than 8000 and/or greater than 9000 and/or greater than 10000 in the 1.0-1.5 μm “bucket”.

In yet another example of the present invention, the fibrous structure may comprise a surface and/or surface material comprising filaments, for example hydroxyl polymer filaments, such as polyvinyl alcohol filaments, at a frequency of greater than 5000 and/or greater than 6000 and/or greater than 7000 and/or greater than 8000 in the 1.5-2.0 μm “bucket”.

In even another example of the present invention, the fibrous structure may comprise a surface and/or surface material comprising filaments, for example hydroxyl polymer filaments, such as polyvinyl alcohol filaments, at a total frequency of greater than 18000 and/or greater than 20000 and/or greater than 25000 and/or greater than 30000 and/or greater than 32000 in the 0.5-1.0 μm+1.0-1.5 μm+1.5-2.0 μm “buckets”, in other words, the sum of the frequencies from each of the 0.5-1.0 μm, 1.0-1.5 μm, and 1.5-2.0 μm “buckets”.

### Average Diameter Test Method

This Average Diameter Test Method is used to determine the average diameters of fibrous elements, such as filaments and/or fibers, where their known average diameters are not already known. For example, average diameters of commercially available fibers, such as rayon fibers, have known lengths whereas average diameters of spun filaments, such as spun hydroxyl polymer filaments, would be determined as set forth immediately below. Further, pulp fibers, such as wood pulp fibers, especially commercially available wood pulp fibers would have known diameter (width) from the supplier of the wood pulp or are generally known in the industry and/or can ultimately be measured according to the Kajaani FiberLab Fiber Analyzer SubTest Method described below.

A fibrous structure comprising filaments of appropriate basis weight (approximately 5 to 20 grams/square meter) is cut into a rectangular shape sample, approximately 20 mm by 35 mm. The sample is then coated using a SEM sputter coater (EMS Inc, PA, USA) with gold so as to make the filaments relatively opaque. Typical coating thickness is between 50 and 250 nm. The sample is then mounted between two standard microscope slides and compressed together using small binder clips. The sample is imaged using a 10× objective on an Olympus BHS microscope with the microscope light-collimating lens moved as far from the objective lens as possible. Images are captured using a Nikon D1 digital camera. A Glass microscope micrometer is used to calibrate the spatial distances of the images. The approximate resolution of the images is 1 μm/pixel. Images will typically show a distinct bimodal distribution in the intensity histogram corresponding to the filaments and the background. Camera adjustments or different basis weights are used to achieve an acceptable bimodal distribution. Typically, 10 images per sample are taken and the image analysis results averaged.

The images are analyzed in a similar manner to that described by B. Pourdeyhimi, R. and R. Dent in “Measuring fiber diameter distribution in nonwovens” (Textile Res. J. 69(4) 233-236, 1999). Digital images are analyzed by computer using the MATLAB (Version. 6.1) and the MATLAB Image Processing Tool Box (Version 3.) The image is first converted into a grayscale. The image is then binarized into black and white pixels using a threshold value that minimizes the intraclass variance of the thresholded black and white pixels. Once the image has been binarized, the image is skeletonized to locate the center of each fiber in the image. The distance transform of the binarized image is also computed. The scalar product of the skeletonized image and the distance map provides an image whose pixel intensity is either zero or the radius of the fiber at that location. Pixels within one radius of the junction between two overlapping fibers are not counted if the distance they represent is smaller than the radius of the junction. The remaining pixels are then used to compute a length-weighted histogram of filament diameters contained in the image.

### Kajaani FiberLab Fiber Analyzer SubTest Method

### Instrument Start-Up:

1. Turn on Kajaani FiberLab Fiber Analyzer unit first, then computer and monitor.
2. Start FiberLab program on computer.

### Instrument Operation:

1. File→New (or click on New File icon)
2. “New Fiber Analysis” screen pops up.
   a. Sample Point: select the folder you would like data stored in (to add a new folder see “Adding a New Folder”
   b. Name: add condition or sample name/identifier here
   c. Date
   d. Time
   e. Sample Weight: mg of dry fiber in the 50 ml sample (can leave blank if NOT measuring for coarseness). This is the number calculated in #10 of Sample Prep below.
3. Make sure 50 ml of sample is placed in a “Kajaani beaker” and click “Start”
4. Optional: Distribution→Measured Values
   a. Fibers: the final count of measured fibers should be at least 10,000
   b. Fibers/sec: this number must stay below 70 fibers/sec or the sample will automatically be diluted. If the sample is diluted during an analysis, the coarseness value will be invalid and will need to be discarded.
5. A bar indicating the measurement status of a sample appears on the computer monitor. Do not start an analysis until the indicated status is “Wait State”. When the analysis is completed, wait for “Wait State” to appear, then close the “New Fiber Analysis” window. You can now repeat #1-3/4
6. When finished with all samples, close the FiberLab program before turning off the Kajaani FiberLab analyzer unit.
7. Shutdown computer.

### Sample Preparation:

### Target Sample Size:

Softwood: 4 mg/50 ml→160 mg BD in 2000 ml (~170-175 mg from sheet)
Hardwood: 1 mg/50 ml→40 mg BD in 2000 ml (~40-45 mg from sheet)
1. For n=3 analysis, weigh and record weight of sample torn (avoiding cut edges) from 3 different pulp sheets of same sample using guidelines above for sample size. Place weighed samples into a suitable container for soaking of pulp.
2. Using the 3 sheets that samples were torn from, perform moisture content analysis. Note: This step can be skipped if coarseness measurement is not required.
3. Calculate the actual bone dry weight of the samples weighed in #1, by using the average moisture determined in #2.
4. Allow pulp samples to soak in water for 10-15 minutes.
5. Place 1^{st} sample and soaking water into the Kajaani manual disintegrator. Fill disintegrator up to 250 ml mark with more water.
6. Using the “hand dasher”, plunge up and down until sample is separated into individual fibers.
7. Transfer sample to a 2000 ml volumetric flask. Make sure to wash off and collect any fibers that may have adhered to the dasher.
8. Dilute up to 2000 ml mark. It is important to be as precise as possible for repeatable coarseness results.
9. Take a 50 ml aliquot and place into a Kajaani beaker. Place beaker on the sampler unit.
10. Calculate the mg of BD pulp in 50 ml aliquot
   a. (BD mg of sample/2000 ml)×50 ml
11. Begin Step #1 above in Instrument Operation

The water used in this method is City of Cincinnati Water or equivalent having the following properties: Total Hardness=155 mg/L as CaCO₃; Calcium content=33.2 mg/L; Magnesium content=17.5 mg/L; Phosphate content=0.0462

### Adding a New Folder to Sample Point Menu:

1. Settings→Common Settings→Sample Folders
   a. Type in name of new folder→Add→OK
Note: You must close the FiberLab program and re-open program to see the new folder appear in the menu.

### Collecting Data in Excel File:

1. Start FiberLab's Collect 1.12 program.
2. Open Windows Explorer (not to full screen—you must be able to see both the Explorer and the Collect windows.
3. In Windows Explorer . . . Select folder that data was stored in
4. Highlight data to be put in Excel→right click on Copy→drag highlighted samples to the Collect window→Save text
5. Click “Save In” menu bar and select “My briefcase”. Open the 2007 folder, type in file name and click Save. A message will appear saying the selected samples have been saved. Click OK (the sample names will disappear from the Collect window.
6. Open Excel. Then . . . Open+Look In “My Briefcase”→2007→at bottom, select “All Files (*.*)” in the “Files of Type” bar→find text file just saved and open→click thru the Text Import Wizard screens (next, next, finish)

### Caliper Test Method

Caliper of a toilet tissue and/or fibrous structure ply is measured using a ProGage Thickness Tester (Thwing-Albert Instrument Company, West Berlin, NJ) with a pressure foot diameter of 5.08 cm (area of 6.45 cm²) at a pressure of 14.73 g/cm². Four (4) samples are prepared by cutting of a usable unit such that each cut sample is at least 16.13 cm per side, avoiding creases, folds, and obvious defects. An individual specimen is placed on the anvil with the specimen centered underneath the pressure foot. The foot is lowered at 0.076 cm/sec to an applied pressure of 14.73 g/cm². The reading is taken after 3 sec dwell time, and the foot is raised. The measure is repeated in like fashion for the remaining 3 specimens. The caliper is calculated as the average caliper of the four specimens and is reported in mils (0.001 in) to the nearest 0.1 mils.

Dry Tensile Test Method: Elongation, Tensile Strength, TEA and Modulus Elongation, Tensile Strength, TEA and Tangent Modulus are measured on a constant rate of extension tensile tester with computer interface (a suitable instrument is the EJA Vantage from the Thwing-Albert Instrument Co. Wet Berlin, NJ) using a load cell for which the forces measured are within 10% to 90% of the limit of the load cell. Both the movable (upper) and stationary (lower) pneumatic jaws are fitted with smooth stainless steel faced grips, with a design suitable for testing 1 inch wide sheet material (Thwing-Albert item #733GC). An air pressure of about 60 psi is supplied to the jaws.

Twenty usable units of fibrous structures are divided into four stacks of five usable units each. The usable units in each stack are consistently oriented with respect to machine direction (MD) and cross direction (CD). Two of the stacks are designated for testing in the MD and two for CD. Using a one inch precision cutter (Thwing Albert) take a CD stack and cut two, 1.00 in ±0.01 in wide by at least 3.0 in long strips from each CD stack (long dimension in CD). Each strip is five usable unit layers thick and will be treated as a unitary specimen for testing. In like fashion cut the remaining CD stack and the two MD stacks (long dimension in MD) to give a total of 8 specimens (five layers each), four CD and four MD.

Program the tensile tester to perform an extension test, collecting force and extension data at an acquisition rate of 20 Hz as the crosshead raises at a rate of 4.00 in/min (10.16 cm/min) until the specimen breaks. The break sensitivity is set to 50%, i.e., the test is terminated when the measured force drops to 50% of the maximum peak force, after which the crosshead is returned to its original position.

Set the gage length to 2.00 inches. Zero the crosshead and load cell. Insert the specimen into the upper and lower open grips such that at least 0.5 inches of specimen length is contained each grip. Align specimen vertically within the upper and lower jaws, then close the upper grip.

Verify specimen is aligned, then close lower grip. The specimen should be under enough tension to eliminate any slack, but less than 0.05 N of force measured on the load cell. Start the tensile tester and data collection. Repeat testing in like fashion for all four CD and four MD specimens.

Program the software to calculate the following from the constructed force (g) verses extension (in) curve:

Tensile Strength is the maximum peak force (g) divided by the product of the specimen width (1 in) and the number of usable units in the specimen (5), and then reported as g/in to the nearest 1 g/in.

Adjusted Gage Length is calculated to as the extension measured at 11.12 g of force (in) added to the original gage length (in).

Elongation is calculated as the extension at maximum peak force (in) divided by the Adjusted Gage Length (in) multiplied by 100 and reported as % to the nearest 0.1%.

Tensile Energy Absorption (TEA) is calculated as the area under the force curve integrated from zero extension to the extension at the maximum peak force (g*in), divided by the product of the adjusted Gage Length (in), specimen width (in), and number of usable units in the specimen (5). This is reported as g*in/in² to the nearest 1 g*in/in².

Replot the force (g) verses extension (in) curve as a force (g) verses strain curve. Strain is herein defined as the extension (in) divided by the Adjusted Gage Length (in).

Program the software to calculate the following from the constructed force (g) verses strain curve:

Tangent Modulus is calculated as the least squares linear regression using the first data point from the force (g) verses strain curve recorded after 190.5 g (38.1 g×5 layers) force and the 5 data points immediately preceding and the 5 data points immediately following it. This slope is then divided by the product of the specimen width (2.54 cm) and the number of usable units in the specimen (5), and then reported to the nearest 1 g/cm.

The Tensile Strength (g/in), Elongation (%), TEA (g*in/in²) and Tangent Modulus (g/cm) are calculated for the four CD specimens and the four MD specimens. Calculate an average for each parameter separately for the CD and MD specimens.

### Calculations:

Geometric Mean Tensile=Square Root of [MD Tensile Strength (g/in)×CD Tensile Strength (g/in)]

Geometric Mean Peak Elongation=Square Root of [MD Elongation (%)×CD Elongation (%)]

Geometric Mean TEA=Square Root of [MD TEA (g*in/in²)×CD TEA (g*in/in²)]

Geometric Mean Modulus=Square Root of [MD Modulus (g/cm)×CD Modulus (g/cm)]

Total Dry Tensile Strength (TDT)=MD Tensile Strength (g/in)+CD Tensile Strength (g/in)

Total TEA=MD TEA (g*in/in²)+CD TEA (g*in/in²)

Total Modulus=MD Modulus (g/cm)+CD Modulus (g/cm)

Tensile Ratio=MD Tensile Strength (g/in)/CD Tensile Strength (g/in)

### Wet Tensile Test Method

Wet tensile for a toilet tissue and/or fibrous structure ply is measured according to ASTM D829-97 for “Wet Tensile Breaking Strength of Paper and Paper Products, specifically by method 11.2 “Test Method B—Finch Procedure.” Wet tensile is reported in units of “g/in”. Initial Total Wet Tensile is measured immediately after saturation

### Wet Decay Test Method

Wet decay (loss of wet tensile) for a toilet tissue and/or fibrous structure ply is measured according to the Wet Tensile Test Method and is the wet tensile of the toilet tissue and/or fibrous structure ply after it has been standing in the soaked condition in the Finch Cup for 30 minutes. Wet decay is reported in units of “%”. Wet decay is the % loss of Initial Total Wet Tensile after the 30 minute soaking.

### Flexural Rigidity Test Method

The Flexural Rigidity Test Method determines the overhang length of the present invention based on the cantilever beam principal. The distance a strip of sample can be extended beyond a flat platform before it bends through a specific angle is measured. The inter-action between sheet weight and sheet stiffness measured as the sheet bends or drapes under its own weight through the given angle under specified test conditions is used to calculate the sample Bend Length, Flexural Rigidity, and Bending Modulus.

The method is performed by cutting rectangular strips of samples of the fibrous structure to be tested, in both the cross direction and the machine direction. The Basis Weight of the sample is determined and the Dry Caliper of the samples is measured (as detailed previously). The sample is placed on a test apparatus that is leveled so as to be perfectly horizontal (ex: with a bubble level) and the short edge of the sample is aligned with the test edge of the apparatus. The sample is gently moved over the edge of the apparatus until it falls under its own weight to a specified angle. At that point, the length of sample overhanging the edge of the instrument is measured.

The apparatus for determining the Flexural Rigidity of fibrous structures is comprised of a rectangular sample support with a micrometer and fixed angle monitor. The sample support is comprised of a horizontal plane upon which the sample rectangle can comfortably be supported without any interference at the start of the test. As it is slowly pushed over the edge of the apparatus, it will bend until it breaks the plane of the fixed angle monitor, at which point the micrometer measures the length of overhang.

Eight samples of 25.4 mm×101.5 mm-152.0 mm are cut in the machine direction (MD); eight more samples of the same size are cut in the cross direction (CD). It is important that adjacent cuts are made exactly perpendicular to each other so that each angle is exactly 90 degrees. Samples are arranged such that the same surface is facing up. Four of the MD samples are overturned and four of the CD samples are overturned and marks are made at the extreme end of each, such that four MD samples will be tested with one side facing up and the other four MD samples will be tested with the other side facing up. The same is true for the CD samples with four being tested with one side up and four with the other side facing up.

A sample is then centered in a channel on the horizontal plane of the apparatus with one short edge exactly aligned with the edge of the apparatus. The channel is slightly oversized for the sample that was cut and aligns with the orientation of the rectangular support, such that the sample does not contact the sides of the channel. A lightweight slide bar is lowered over the sample resting in the groove such that the bar can make good contact with the sample and push it forward over the edge of the apparatus. The leading edge of the slide bar is also aligned with the edge of the apparatus and completely covers the sample. The micrometer is aligned with the slide bar and measures the distance the slide bar, thus the sample, advances.

From the back edge of the slide bar, the bar and sample are pushed forward at a rate of approximately 8-13 cm per second until the leading edge of the sample strip bends down and breaks the plane of the fixed angle measurement, set to 45°. At this point, the measurement for overhang is made by reading the micrometer to the nearest 0.5 mm and is reported in units of cm.

The procedure is repeated for each of the 15 remaining samples of the fibrous structure.

### Calculations:

Flexural Rigidity is calculated from the overhang length as follows:

Bend Length=Overhang length/2
Where overhang length is the average of the 16 results collected.
The calculation for Flexural Rigidity (G) is:

G=0.1629*W*C³ (mg·cm)
Where W is the sample basis weight in pounds/3000 ft² and C is the bend length in cm. The constant 0.1629 converts units to yield Flexural Rigidity (G) in units of milligram-cm.

Bending Modulus (Q)=Flexural Rigidity (G)/Moment of Inertia (I) per unit area.

Q=G/I

$$Q = \frac{732 * G}{Caliper {( mils )}^{3}}$$

### Roll Compressibility Test Method

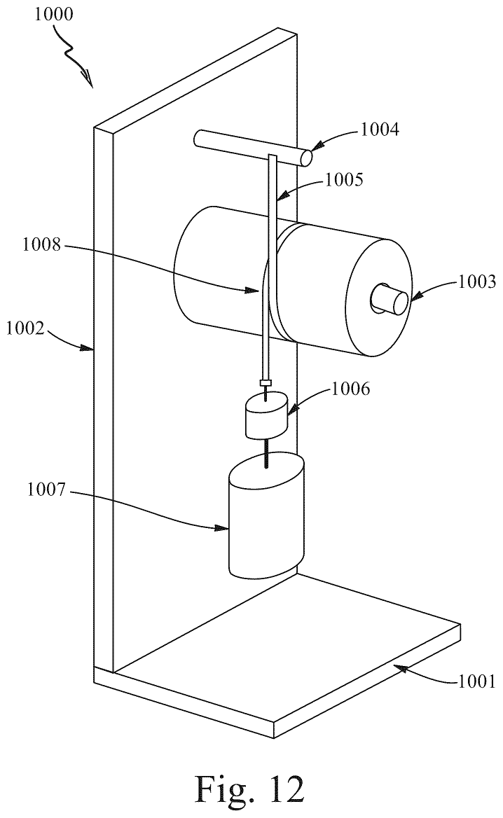

Roll Compressibility (Percent Compressibility) is determined using the Roll Diameter Tester 1000 as shown in FIG. 12. It is comprised of a support stand made of two aluminum plates, a base plate 1001 and a vertical plate 1002 mounted perpendicular to the base, a sample shaft 1003 to mount the test roll, and a bar 1004 used to suspend a precision diameter tape 1005 that wraps around the circumference of the test roll. Two different weights 1006 and 1007 are suspended from the diameter tape to apply a confining force during the uncompressed and compressed measurement. All testing is performed in a conditioned room maintained at about 23 °C±2 C.° and about 50%±2% relative humidity.

The diameter of the test roll is measured directly using a Pi® tape or equivalent precision diameter tape (e.g. an Executive Diameter tape available from Apex Tool Group, LLC, Apex, NC, Model No. W606PD) which converts the circumferential distance into a diameter measurement so the roll diameter is directly read from the scale. The diameter tape is graduated to 0.01 inch increments with accuracy certified to 0.001 inch and traceable to NIST. The tape is 0.25 in wide and is made of flexible metal that conforms to the curvature of the test roll but is not elongated under the 1100 g loading used for this test. If necessary the diameter tape is shortened from its original length to a length that allows both of the attached weights to hang freely during the test, yet is still long enough to wrap completely around the test roll being measured. The cut end of the tape is modified to allow for hanging of a weight (e.g. a loop). All weights used are calibrated, Class F hooked weights, traceable to NIST.

The aluminum support stand is approximately 600 mm tall and stable enough to support the test roll horizontally throughout the test. The sample shaft 1003 is a smooth aluminum cylinder that is mounted perpendicularly to the vertical plate 1002 approximately 485 mm from the base. The shaft has a diameter that is at least 90% of the inner diameter of the roll and longer than the width of the roll. A small steel bar 1004 approximately 6.3 mm diameter is mounted perpendicular to the vertical plate 1002 approximately 570 mm from the base and vertically aligned with the sample shaft. The diameter tape is suspended from a point along the length of the bar corresponding to the midpoint of a mounted test roll. The height of the tape is adjusted such that the zero mark is vertically aligned with the horizontal midline of the sample shaft when a test roll is not present.

Condition the samples at about 23 °C±2 C.° and about 50%±2% relative humidity for 2 hours prior to testing. Rolls with cores that are crushed, bent or damaged should not be tested. Place the test roll on the sample shaft 1003 such that the direction the paper was rolled onto its core is the same direction the diameter tape will be wrapped around the test roll. Align the midpoint of the roll's width with the suspended diameter tape. Loosely loop the diameter tape 1004 around the circumference of the roll, placing the tape edges directly adjacent to each other with the surface of the tape lying flat against the test sample. Carefully, without applying any additional force, hang the 100 g weight 1006 from the free end of the tape, letting the weighted end hang freely without swinging. Wait 3 seconds. At the intersection of the diameter tape 1008, read the diameter aligned with the zero mark of the diameter tape and record as the Original Roll Diameter to the nearest 0.01 inches. With the diameter tape still in place, and without any undue delay, carefully hang the 1000 g weight 1007 from the bottom of the 100 g weight, for a total weight of 1100 g. Wait 3 seconds. Again read the roll diameter from the tape and record as the Compressed Roll Diameter to the nearest 0.01 inch. Calculate percent compressibility to the according to the following equation and record to the nearest 0.1%:

$$\% Compressibility = \frac{( Orginal Roll Diameter ) - ( Compressed Roll Diameter )}{Original Roll Diameter} \times 100$$

Repeat the testing on 10 replicate rolls and record the separate results to the nearest 0.1%. Average the 10 results and report as the Percent Compressibility to the nearest 0.1%.

### Glide on Skin Test Method

The Glide Test Method measures the Force to Drag and Force Variability of a custom probe having a textured surface, designed to mimic skin, as it dragged across the surface of a fibrous structure sample by a Friction/Peel tester.

Testing is performed on a Friction/Peel tester fitted with a custom probe. A suitable Friction/Peel tester is a Thwing-Albert Model 2260 Friction/Peel Tester (Thwing-Albert Instrument Company, 14 W. Collings Ave. West Berlin, NJ 08091), or equivalent. A 2000 gram capacity load cell 102 is used, accurate to ±0.25% of the measuring value, along with a cross-head arm 104 accurate to ±0.01% per inch of travel distance.

The instrument must be located in and all testing performed in a conditioned room maintained at 23 °C±2 C.° and 50%±2% relative humidity.

The sample platform is horizontally level, 20 inches (50.8 cm) long, by 6 inches (15.24 cm) wide and has a sample clamp on one end to secure the fibrous structure sample to be tested. The probe is manufactured from a cylindrical aluminum rod 13.2±0.2 mm in length, 15.0±0.2 mm in diameter. A round side of the aluminum rod is milled flat to facilitate attachment to an aluminum arm. The rounded testing surface of the probe has a custom textured surface applied to it, which is designed to mimic skin. The appropriate surface texture is a coating by the name “Plasma 11000 Series® PC-11015 (coating thickness 0.003/0.005 inches)”, which is applied by American Roller Company Plasma Coatings from Arlington, TN. The probe is attached near the end of the aluminum arm, approximately 13 cm in length, with the probe's long axis attached perpendicular to the long axis of the arm. A probe pin is attached to the end of the arm opposite the probe.

The instrument is turned on at least 30 minutes prior to initiating testing, and is calibrated and operated according to the manufacturer's instructions. The instrument is interfaced with a computer running the appropriate software to operate the instrument. Program the instrument to move the cross-head arm at a constant speed of 1.0 mm/sec for 40 cm, while collecting force and position data at an acquisition rate of 250 Hz.

The probe with the skin mimic surface is attached to the load cell and cross-head arm assembly by inserting the probe pin into an attachment hole in the load cell. A small level is placed on the probe arm, and the load cell and cross-head arm assembly is raised or lowered so that the probe arm is level and parallel to the sample platform. The load cell and cross-head arm assembly is positioned so that the trailing edge of the probe is located approximately 5 mm away from the sample clamp and zeroed at this position. A weighted vial, which will be placed on the probe during testing, is prepared by adding lead shot to the small plastic vial such that the total weight of the probe, arm, and weighted vial is 100±0.1 grams.

A fibrous structure sample is prepared by cutting a 15 cm by 10 cm rectangular sample from a finished product. Test samples are selected to avoid perforations, creases or folds within the testing region. Prepare ten (10) substantially similar replicate samples for testing. All fibrous structure samples being tested are equilibrated in a controlled environment (23 °C±2 C.° and 50%±2% RH) for at least 2 hours before testing.

The fibrous structure sample is laid directly on the sample platform so that a short end of the fibrous structure test sample is under the sample clamp and the fibrous structure sample 110 lies flat on the sample platform. The fibrous structure sample is positioned so that the region to be tested does not include a perforation. All testing is to be performed in the machine direction of the fibrous structure sample. The clamp is lowered to prevent the fibrous structure sample from moving during testing.

To prepare the probe for testing, an alcohol wipe is used to wipe down the surface of the skin mimic to remove any dust/oils/or debris. Set the probe aside in a manner that ensures the skin mimic surface does not touch anything prior to testing. If the skin mimic surface is worn or damaged replace it prior to testing. The skin mimic surface is allowed to fully dry before being used for testing. The probe is carefully placed on the fibrous structure sample, and the probe pin is inserted through the attachment hole in the load cell, such that the probe and arm are properly aligned to be parallel with the testing path. The weighted vial containing lead shot is carefully placed on the arm, positioned such that it is centered directly over the probe. The load cell is zeroed.

The testing procedure is initiated so that the probe is dragged by the cross-head arm at a speed of 1.0 mm/sec over the surface of the fibrous structure sample in the machine direction for a distance of 40 mm, while force and displaced distance readings are collected at a rate of 250 data points/sec.

This measurement procedure is repeated on the ten substantially similar replicate fibrous structure samples, such that ten individual force versus distance profiles are generated.

A test is considered invalid, and the data discarded if one or more of the following occurs during testing: The probe detaches from the load cell. The weighted vial falls off of the probe. The probe passes over a perforation in the fibrous structure sample. The fibrous structure sample rips, buckles, delaminates, or detaches from the clamp.

The Force to Drag value is calculated as the mean of the individual force data points collected between a distance of 5 mm and 35 mm, excluding data from the first 5 mm and the last 5 mm of the total 40 mm distance. The Force to Drag value is the average of the ten individual replicate values and is reported to the nearest 0.1 grams force.

The Force Variability value is calculated as the mean of the absolute value difference of each individual force data point from its local mean (mean absolute deviation from the local mean) between a distance of 5 mm and 35 mm, again excluding the first 5 mm and the last 5 mm of the total 40 mm distance. The local mean is calculated using a moving average of the force data within ±2.5% of the total data field from each individual data point. For example, using the data rate of 250 points/sec and cross-head arm speed of 1 mm/sec over a 30 mm distance (40 mm-2×5 mm), 7500 data points are collected during a test, so 2.5% of 7500 yields 188 pts. The moving average of the force data within a range of ±188 data points of each individual data point is then used as the local mean for that point. The average of the absolute value difference of each individual data point from its local mean yields the Force Variability value for that test. The Force Variability value is the average of the ten individual replicate values and is reported to the nearest 0.1 grams force.

### Weight Average Molecular Weight Test Method

The weight average molecular weight and the molecular weight distribution (MWD) are determined by Gel Permeation Chromatography (GPC) using a mixed bed column. The column (Waters linear ultrahydrogel, length/ID: 300×7.8 mm) is calibrated with a narrow molecular weight distribution polysaccharide, 107,000 g/mol from Polymer Laboratories). The calibration standards are prepared by dissolving 0.024 g of polysaccharide and 6.55 g of the mobile phase in a scintillation vial at a concentration of 4 mg/ml. The solution sits undisturbed overnight. Then it is gently swirled and filtered with a 5 micron nylon syringe filter into an auto-sampler vial.

The filtered sample solution is taken up by the auto-sampler to flush out previous test materials in a 100 μL injection loop and inject the present test material into the column. The column is held at 50 °C using a Waters TCM column heater. The sample eluded from the column is measured against the mobile phase background by a differential refractive index detector (Wyatt Optilab REX interferometric refractometer) and a multi-angle later light scattering detector (Wyatt DAWN Heleos 18 angle laser light detector) held at 50 °C. The mobile phase is water with 0.03M potassium phosphate, 0.2M sodium nitrate, and 0.02% sodium azide. The flowrate is set at 0.8 mL/min with a run time of 35 minutes.

### Plate Stiffness Test Method

As used herein, the “Plate Stiffness” test is a measure of stiffness of a flat sample of a toilet tissue and/or fibrous structure ply as it is deformed downward into a hole beneath the sample. For the test, the sample is modeled as an infinite plate with thickness “t” that resides on a flat surface where it is centered over a hole with radius “R”. A central force “F” applied to the tissue directly over the center of the hole deflects the tissue down into the hole by a distance “w”. For a linear elastic material, the deflection can be predicted by:

$$w = \frac{3 F}{4 π {Et}^{3}} ( 1 - v ) ( 3 + v ) {R}^{2}$$

where “E” is the effective linear elastic modulus, “v” is the Poisson's ratio, “R” is the radius of the hole, and “t” is the thickness of the tissue, taken as the caliper in millimeters measured on a stack of 4 or 5 tissues under a load of about 0.29 psi. Taking Poisson's ratio as 0.1 (the solution is not highly sensitive to this parameter, so the inaccuracy due to the assumed value is likely to be minor), the previous equation can be rewritten for “w” to estimate the effective modulus as a function of the flexibility test results:

$$E \approx \frac{3 {R}^{2}}{4 {t}^{3}} \frac{F}{w}$$

The test results are carried out using an MTS Alliance RT/1, Insight Renew, or similar model testing machine (MTS Systems Corp., Eden Prairie, Minn.), with a 50 newton load cell, and data acquisition rate of at least 25 force points per second. As a stack of four tissue sheets (created without any bending, pressing, or straining) at least 2.5-inches by 2.5 inches, but no more than 5.0 inches by 5.0 inches, oriented in the same direction, sits centered over a hole of radius 15.75 mm on a support plate, a blunt probe of 3.15 mm radius descends at a speed of 20 mm/min. When the probe tip descends to 1 mm below the plane of the support plate, the test is terminated. The maximum slope (using least squares regression) in grams of force/mm over any 0.5 mm span during the test is recorded (this maximum slope generally occurs at the end of the stroke). The load cell monitors the applied force and the position of the probe tip relative to the plane of the support plate is also monitored. The peak load is recorded, and “E” is estimated using the above equation.

### Calculations:

The Plate Stiffness “S” per unit width can then be calculated as:

$$S = \frac{{Et}^{3}}{12}$$

and is expressed in units of Newtons*millimeters. The Testworks program uses the following formula to calculate stiffness (or can be calculated manually from the raw data output):

$$S = ( \frac{F}{w} ) [ \frac{( 3 + v ) {R}^{2}}{16 π} ]$$

wherein “F/w” is max slope (force divided by deflection), “v” is Poisson's ratio taken as 0.1, and “R” is the ring radius.

The same sample stack (as used above) is then flipped upside down and retested in the same manner as previously described. This test is run three more times (with the different sample stacks). Thus, eight S values are calculated from four 4-sheet stacks of the same sample. The numerical average of these eight S values is reported as Plate Stiffness for the sample.

Plate Stiffness, Basis Weight Normalized is the quotient of the Average Plate Stiffness, S, in N-mm and the Basis Weight, in grams per square meter (gsm), per the Basis Weight Test Method.

$$Plate Stiffness , BW Normalized = \frac{Avg Plate Stiffness , ‘ S ’ ( N * mm )}{BW ( gsm )}$$

### CRT Test Method

The absorption (wicking) of water by an absorbent fibrous structure (sample) is measured over time. A sample is placed horizontally in the instrument and is supported by an open weave net structure that rests on a balance. The test is initiated when a tube connected to a water reservoir is raised and the meniscus makes contact with the center of the sample from beneath, at a small negative pressure. Absorption is allowed to occur for 2 seconds after which the contact is broken and the cumulative rate for the first 2 seconds is calculated.

### Apparatus

Conditioned Room—Temperature is controlled from 73 °F±2 °F (23 °C±1 °C). Relative Humidity is controlled from 50%±2%
Sample Preparation—Product samples are cut using hydraulic/pneumatic precision cutter into 7.62 cm diameter circles, at least 2.54 cm from any edge, cutting 2 replicates for each test.
Capacity Rate Tester (CRT)—The CRT is an absorbency tester capable of measuring capacity and rate. The CRT consists of a balance (0.001 g), on which rests on a woven grid (using nylon monofilament line having a 0.014″ diameter) placed over a small reservoir with a delivery tube in the center. This reservoir is filled by the action of solenoid valves, which help to connect the sample supply reservoir to an intermediate reservoir, the water level of which is monitored by an optical sensor. The CRT is run with a −2 mm water column, controlled by adjusting the height of water in the supply reservoir.
Software—LabView based custom software specific to CRT Version 4.2 or later.
Water—Distilled water with conductivity <10 S/cm (target <5 μS/cm) @ 25 °C

For this method, a usable unit is described as one finished product unit regardless of the number of plies. Condition all samples with packaging materials removed for a minimum of 2 hours prior to testing. Discard at least the first ten usable units from the roll. Remove two usable units and cut one 7.62 cm circular sample from the center of each usable unit for a total of 2 replicates for each test result. Do not test samples with defects such as wrinkles, tears, holes, etc. Replace with another usable unit which is free of such defects

### Pre-Test Set-Up

1. The water height in the reservoir tank is set −2.0 mm below the top of the support rack (where the sample will be placed).
2. The supply tube (8 mm I.D.) is centered with respect to the support net.
3. Test samples are cut into circles of 7.62 cm diameter and equilibrated at Tappi environment conditions for a minimum of 2 hours.

### Test Description

1. After pressing the start button on the software application, the supply tube moves to 0.33 mm below the water height in the reserve tank. This creates a small meniscus of water above the supply tube to ensure test initiation. A valve between the tank and the supply tube closes, and the scale is zeroed.
2. The software prompts you to “load a sample”. A sample is placed on the support net, centering it over the supply tube, and with the side facing the outside of the roll placed downward.
3. Close the balance windows, and press the “OK” button—the software records the dry weight of the circle.
4. The software prompts you to “place cover on sample”. The plastic cover is placed on top of the sample, on top of the support net. The plastic cover has a center pin (which is flush with the outside rim) to ensure that the sample is in the proper position to establish hydraulic connection. Four other pins, 1 mm shorter in depth, are positioned 1.25-1.5 inches radially away from the center pin to ensure the sample is flat during the test. The sample cover rim should not contact the sheet. Close the top balance window and click “OK”.
5. The software re-zeroes the scale and then moves the supply tube towards the sample. When the supply tube reaches its destination, which is 0.33 mm below the support net, the valve opens (i.e., the valve between the reserve tank and the supply tube), and hydraulic connection is established between the supply tube and the sample. Data acquisition occurs at a rate of 5 Hz, and is started about 0.4 seconds before water contacts the sample.
6. The test runs for 2 seconds. After this, the supply tube pulls away from the sample to break the hydraulic connection.
7. The wet sample is removed from the support net. Residual water on the support net and cover are dried with a paper towel.
8. Repeat until all samples are tested.
9. After each test is run, a *.txt file is created (typically stored in the CRT/data/rate directory) with a file name as typed at the start of the test. The file contains all the test set-up parameters, dry sample weight, and cumulative water absorbed (g) vs. time (sec) data collected from the test.
10. The software records the weight of water acquisition and the time and from this calculates the CRT Rate (g/sec) and the CRT Capacity (g/g, which is grams water/gram fibrous structure).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A multi-ply fibrous structure comprising:
a. a first ply comprising a laminate fibrous structure comprising a base fibrous structure associated with a nonwoven web exhibiting a basis weight of less than 5 gsm, wherein the nonwoven web comprises a plurality of hydroxyl polymer fibrous elements, wherein the hydroxyl polymer fibrous elements have an average fiber diameter of less than 4.5 microns as measured by the average fiber diameter method; and
b. a second ply comprising a fibrous structure;
wherein the first ply is bonded to the second ply to form the multi-ply fibrous structure.

2. The multi-ply fibrous structure according to claim 1 wherein the low basis weight nonwoven web has a MD fail TEA greater than 13 g/in/per gsm.

3. The multi-ply fibrous structure according to claim 2 wherein the nonwoven web exhibits a basis weight of less than 3 gsm.

4. The multi-ply fibrous structure according to claim 3 wherein the nonwoven web exhibits a basis weight of less than 2 gsm.

5. The multi-ply fibrous structure according to claim 1 wherein the nonwoven web exhibits a basis weight of greater than 0.25 gsm.

6. The multi-ply fibrous structure according to claim 5 wherein the nonwoven web exhibits a basis weight of greater than 0.50 gsm.

7. The multi-ply fibrous structure according to claim 6 wherein the nonwoven web exhibits a basis weight of greater than 0.75 gsm.

8. The multi-ply fibrous structure according to claim 7 wherein the nonwoven web exhibits a basis weight of greater than 1 gsm.

9. The multi-ply fibrous structure according to claim 1 wherein the nonwoven web exhibits a basis weight of greater than 0.25 gsm to less than 5 gsm.

10. The multi-ply fibrous structure according to claim 9 wherein the nonwoven web exhibits a basis weight of greater than 0.50 gsm to less than 4 gsm.

11. The multi-ply fibrous structure according to claim 10 wherein the nonwoven web exhibits a basis weight of greater than 0.75 gsm to less than 3 gsm.

12. The multi-ply fibrous structure according to claim 11 wherein the nonwoven web exhibits a basis weight of from about 1 gsm to about 2 gsm.

13. The multi-ply fibrous structure according to claim 1 wherein the nonwoven web exhibits a total dry tensile of greater than 75 g/in as measured according to the Tensile Test Method.

14. The multi-ply fibrous structure according to claim 13 wherein the nonwoven web exhibits a total dry tensile of greater than 100 g/in as measured according to the Tensile Test Method.

15. The multi-ply fibrous structure according to claim 14 wherein the nonwoven web exhibits a total dry tensile of greater than 150 g/in as measured according to the Tensile Test Method.

16. The multi-ply fibrous structure according to claim 15 wherein the nonwoven web exhibits a total dry tensile strength of greater than 200 g/in as measured according to the Tensile Test Method.

17. The multi-ply fibrous structure according to claim 16 wherein the nonwoven web exhibits a total dry tensile of greater than 300 g/in as measured according to the Tensile Test Method.

18. The multi-ply fibrous structure according to claim 17 wherein the nonwoven web exhibits a total dry tensile of greater than 400 g/in as measured according to the Tensile Test Method.

19. The multi-ply fibrous structure according to claim 1 wherein the nonwoven web exhibits a total dry tensile of less than 2000 g/in as measured according to the Tensile Test Method.

20. The multi-ply fibrous structure according to claim 19 wherein the nonwoven web exhibits a total dry tensile of less than 1500 g/in as measured according to the Tensile Test Method.

21. A method for making a multi-ply fibrous structure, the method comprising the steps of:
a. providing a first ply comprising a laminate fibrous structure comprising a base fibrous structure associated with a nonwoven web exhibiting a basis weight of less than 5 gsm, wherein the nonwoven web comprises a plurality of hydroxyl polymer filaments; and
b. providing a second ply; and
c. bonding the first ply to the second ply to form a multi-ply fibrous structure.

22. The method according to claim 21 wherein the nonwoven web exhibits a basis weight of less than 4 gsm.
